(19) United States
(12) Patent Application Publication
(10) Pub. No.: US 2025/0180823 A1
(43) Pub. Date: Jun. 5, 2025

(54) FIBER OPTIC CABLE ASSEMBLY AND FABRICATION METHOD INCORPORATING TWO-DIMENSIONAL ARRAYS OF OPTICAL FIBERS

(71) Applicant: CORNING RESEARCH & DEVELOPMENT CORPORATION, Corning, NY (US)

(72) Inventors: Douglas Llewellyn Butler, Painted Post, NY (US); James Scott Sutherland, Painted Post, NY (US)

(21) Appl. No.: 18/819,320

(22) Filed: Aug. 29, 2024

Related U.S. Application Data
(60) Provisional application No. 63/604,524, filed on Nov. 30, 2023.

(51) Int. Cl. G02B 6/38; G02B 6/36

(52) U.S. Cl. CPC G02B 6/3842; G02B 6/3672; G02B 6/3676; G02B 6/3839; G02B 6/3878; G02B 6/3861; G02B 6/3863

(57) ABSTRACT

Perimeter external surfaces of a 2D arrays of stripped optical fibers are used as datum surfaces for alignment structures for mating connectors in fiber optic cable assemblies. 2D fiber arrays may include involutions and/or protrusions to serve as mating locations for alignment structures and/or to serve as keying structures. A removable sleeve may be positioned around at least a portion of a 2D fiber array to align mating connectors and/or bias alignment structures toward one another. Fiber-free areas may be provided in an interior of a 2D fiber array to receive alignment structures. One or more compliant members may be configured to press first and second alignment structures toward one another proximate to a 2D fiber array. A cable assembly fabrication method includes forming window stripping and adhering optic fiber groups while preventing adhesive material from protruding beyond outermost surfaces of optical fibers at a perimeter of a fiber array. Multiple 2D fiber arrays with peripheral protective structures may be received in a connector sleeve and biased toward one another.

### PRIORITY APPLICATION

This application claims the benefit of priority of U.S. Provisional Application No. 63/604,524, filed on Nov. 30, 2023, the content of which is relied upon and incorporated herein by reference in its entirety.

### BACKGROUND

This disclosure relates generally to optical fibers, and more particularly to fiber optic cable assemblies incorporating two-dimensional arrays of optical fibers, and methods for fabricating fiber optic cable assemblies.

Optical fibers are useful in a wide variety of applications, including the telecommunications industry for voice, video, and data transmission. FIG. 1 is a cross-sectional view of an exemplary coated optical fiber 1 that includes a glass core 2, glass cladding 4 surrounding the glass core 2, and a polymer coating 9 (which may include multiple coating layers, such as an inner primary coating layer 6 and an outer secondary coating layer 8) surrounding the glass cladding 4. The inner primary coating layer 6 may be configured to act as a shock absorber to minimize attenuation caused by any micro-bending of the coated optical fiber 1. The outer secondary coating layer 8 may be configured to protect the inner primary coating layer 6 against mechanical damage, and to act as a barrier to lateral forces. The outer diameter of the coated optical fiber 1 may be about 200 μm, about 250 μm, or any other suitable value. For single-mode optical fibers, the glass core 2 may have a core diameter (e.g., on the order of 10 microns) that is smaller than a core diameter for multi-mode optical fibers.

In a telecommunications system that uses optical fibers, there are typically many locations where fiber optic cables that carry the optical fibers connect to equipment or other fiber optic cables. To conveniently provide these connections, fiber optic connectors (“connectors”) are often provided on the ends of fiber optic cables. Given the relatively small core diameter single mode optical fibers (e.g., in a range of 8 μm to 10 μm), fiber-to-fiber connectors need to establish alignment with their optical counterparts to sub-micron accuracy. The process of terminating individual optical fibers from a fiber optic cable is referred to as “connectorization.” Connectorization can be performed in a factory (resulting in a “pre-connectorized” or “pre-terminated” fiber optic cable) or in the field (e.g., using a “field-installable” connector).

Many different types of fiber optic connectors exist. In environments that require high density interconnects and/or high bandwidth, such as data centers, multi-fiber optical connectors are the most widely used. Multi-fiber optical connectors are suitable for use with multi-fiber cables and frequently utilize multi-fiber ferrules with precise dimensions. One example of a multi-fiber optical connector is the multi-fiber push on (MPO) connector, which incorporates a mechanical transfer (MT) ferrule and is standardized according to TIA-604-5 and IEC 61754-7. The most commonly used type of MPO connectors include 12 optical fibers arranged in a one-dimensional (i.e., 1×12) array, although recent versions of single mode MPO connectors include 24 optical fibers arranged in a two-dimensional (i.e., 2×12) array. As compared to single fiber connectors, MPO connectors achieve a higher density of optical fibers, which reduces the amount of hardware, space, and effort required to establish a large number of interconnects. Other examples of multi-fiber optical connectors are MMC connectors commercially available from US Conec Ltd. and SN-MT connectors commercially available from Senko Advanced Components, Inc. MMC connectors use a ferrule referred to as a “TMT ferrule,” which has the same fiber pitch as a MT ferrule but in a smaller form factor (i.e., half the height and half the width compared to a MT ferrule). SN-MT connectors use a multi-fiber ferrule (“SN-MT ferrule”) with a reduced guide pin bore diameter and guide pin bore pitch compared to a traditional MT ferrule, and also has a smaller form factor. Multi-fiber ferrules typically comprise glass-reinforced polymeric materials and are fabricated by molding. For MT, TMT, and SN-MT ferrules, fiber alignment depends on pitch and eccentricity of fiber micro-holes and alignment pin holes, with alignment being dictated by the alignment pins during mating. The foregoing connectors, as well as various connector portions of cable assemblies disclosed herein, embody fiber-to-fiber connectors (e.g., as distinguished from fiber-to-chip connectors intended to optically connect an array of optical fibers to an array of optical waveguides of a planar light circuit (PLC) or an integrated photonic device such as a photonic integrated circuit (PIC)).

Although the foregoing ferrule-based connectors achieve a density higher than single-fiber connectors, demand exists for even higher density fiber connectors. Hyperscale data center designers are packing ever-greater numbers of connections from server to server within limited space inside data center facilities. The pace of this change may actually accelerate with the advent of artificial intelligence (AI) computing. More connections require more fibers and connectors, and this is driving the demand for greater bandwidth density throughout data centers, including higher density fibers, cabling, connectors, and transceivers.

Need exists in the art for multi-fiber connectors suitable for connecting larger numbers of fibers at a higher spatial density than conventional connectors, and methods for fabricating and using higher density multi-fiber connectors.

### SUMMARY

The present disclosure includes fiber optic cable assemblies having two-dimensional arrays of stripped optical fibers (2D fiber arrays) comprising glass, and methods for their fabrication, in which perimeter external surfaces of a 2D fiber array are used as datum surfaces for alignment structures for 2D fiber array connector mating. Exemplary alignment structures include one or more of alignment pins, precision glass tubes, precision thickness fusion glass sheets, precision glass rods, fiber array rafts, V-blocks, and the like, wherein such structures may optionally be adhered to a 2D fiber array. In certain embodiments, a plurality of precision thickness fusion glass sheets or rods may be arranged around at least half of a perimeter of a 2D fiber array including at least two adjacent perimeter sides thereof, and bonded to at least some optical fibers of the array. In certain embodiments, 2D fiber arrays may include non-uniform peripheral boundaries (e.g., peripheral involutions and/or peripheral protrusions) to serve as mating locations for alignment structures and/or to serve as keying structures for connector orientation. In certain embodiments, a removable sleeve may be positioned around at least a portion a 2D fiber array, as well as around at least a portion of one or more alignment structures (if provided), wherein such a sleeve may be used to bias one or more alignment structures to a desired position relative to a 2D fiber array. In certain embodiments, fiber-free areas may be provided in an interior of a 2D fiber array to receive alignment structures, optionally wherein the 2D fiber array is continuous and each fiber-free area is surrounded by optical fibers. In certain embodiments, one or more compliant members may be configured to press first and second alignment structures toward one another, with at least a portion of a 2D fiber array being arranged between the alignment structures. A method for fabricating at least one fiber optic cable assembly includes separately forming an adhered first window stripped optical fiber group and a second window stripped optical fiber group, and adhering the groups to one another with adhesive material in interstitial areas, without causing adhesive material to protrude beyond outermost surfaces of optical fibers at a perimeter of a resulting 2D fiber array. A method for coupling first and second fiber array cable assemblies each including a plurality of glass sheets or rods arranged around at least half of a perimeter of a 2D fiber array includes receiving end faces of the fiber optic cable assemblies in abutting relationship with a connector sleeve, and biasing the glass sheets or rods of the respective fiber optic cable assemblies toward one another.

One aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array in which the end portion of each optical fiber is in lateral contact with end portions of multiple other optical fibers of the plurality of optical fibers. The fiber optic cable assembly further comprises first alignment structure in lateral contact with end portions of a first subgroup of optical fibers of the plurality of optical fibers, and comprises a second alignment structure in lateral contact with end portions of a second subgroup of optical fibers of the plurality of optical fibers. The first alignment structure and the second alignment structure are configured to permit alignment of end faces of the plurality of optical fibers with end faces of a second plurality of optical fibers of another fiber optic cable assembly.

Another aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array, wherein the two-dimensional array is devoid of optical fibers in an interior of the two-dimensional array to provide first and second fiber-free areas in the interior of the two-dimensional array. The fiber optic cable assembly further comprises a first alignment structure at least partially received within the first fiber-free area, and comprises a second alignment structure at least partially received within the second fiber-free area. The first alignment structure and the second alignment structure are configured to permit alignment of end faces of the plurality of optical fibers with end faces of a plurality of optical fibers of another fiber optic cable assembly.

Another aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array in which the end portion of each optical fiber is in lateral contact with end portions of multiple other optical fibers of the plurality of optical fibers. The fiber optic cable assembly further comprises a sleeve configured to fit around at least a portion of a perimeter of the two-dimensional array, wherein the sleeve is arranged in contact with at least one of the following items (1) and (2): (1) an end portion of at least one optical fiber of the plurality of optical fibers; (2) at least one alignment structure that contacts at least one optical fiber of the plurality of optical fibers.

Another aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array in which the end portion of each optical fiber is in lateral contact with end portions of multiple other optical fibers of the plurality of optical fibers. The fiber optic cable assembly further comprises a plurality of glass sheets or glass rods arranged around at least half of a perimeter including at least two adjacent perimeter sides of the two-dimensional array, wherein the plurality of glass sheets or rods are bonded to end portions of at least some optical fibers of the plurality of optical fibers.

Another aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array. A perimeter of the two-dimensional array comprises non-uniform boundaries including at least one of the following items (i) and (ii): (i) one or more involutions in the perimeter of the two-dimensional array configured to receive portions of one or more alignment structures, (ii) one or more protrusions extending outward from the perimeter of the two-dimensional array configured to contact portions of one or more alignment structures. The one or more alignment structures are configured to permit alignment of end faces of the plurality of optical fibers with end faces of a plurality of optical fibers of another fiber optic cable assembly.

Another aspect of the disclosure relates to a fiber optic cable assembly comprising a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array. The fiber optic cable assembly a further comprises a first alignment structure in lateral contact with end portions of a first subgroup of optical fibers of the plurality of optical fibers, and comprises a second alignment structure in lateral contact with end portions of a second subgroup of optical fibers of the plurality of optical fibers. The fiber optic cable assembly a further comprises at least one compliant member configured to press the first alignment structure toward the second alignment structure, with at least a portion of the two-dimensional array arranged between the first alignment structure and the second alignment structure.

Still another aspect of the disclosure relates to a method for fabricating at least one fiber optic cable assembly, the method comprising window stripping portions of first optical fibers of a plurality of first optical fibers of at least one first fiber ribbon to provide, for each first optical fiber, a stripped region arranged between unstripped regions, wherein each fiber optical fiber comprises glass and is configured to carry optical signals; arranging stripped regions of the plurality of first optical fibers in contact with one another to form a first fiber group; and adhering optical fibers of the first fiber group to one another. The method further comprises window stripping portions of second optical fibers of a plurality of second optical fibers of at least one second fiber ribbon to provide, for each second optical fiber, a stripped region arranged between unstripped regions, wherein each second optical fiber comprises glass and is configured to carry optical signals; arranging stripped regions of the plurality of second optical fibers in contact with one another to form a first second group; and adhering optical fibers of the second fiber group to one another. The method further comprises pressing the first fiber group and the second fiber group toward one another; and adhering the first fiber group to the second fiber group to form a two-dimensional fiber array, wherein the adhering of the first fiber group to the second fiber group comprises applying adhesive material to interstitial areas between optical fibers of the first fiber group and the second fiber group, without causing adhesive material to protrude beyond outermost surfaces of optical fibers at a perimeter of the two-dimensional fiber array. According to this method, at least some peripheral optical fibers of the two-dimensional fiber array serve as datum surfaces for receiving one or more alignment structures.

Another aspect of the disclosure relates to a method for coupling first and second fiber optic cable assemblies, with each fiber optic cable assembly comprising a plurality of optical fibers configured to carry optical signals, wherein each optical fiber of the plurality of optical fibers comprises a stripped region and an unstripped region, each stripped region is terminated at the end face, each stripped region includes an end portion proximate to the end face, at least the end portion of each optical fiber of the plurality of optical fibers is arranged in a two-dimensional array, and each fiber optic cable assembly comprises a plurality of glass sheets or glass rods arranged around at least half of a perimeter of the two-dimensional array. The method comprises receiving the end faces of first and second fiber optic cable assemblies in abutting relationship within a connector sleeve, and biasing the plurality of glass sheets or rods of the first fiber optic cable assembly toward the plurality of glass sheets or rods of the second fiber optic cable assembly.

In another aspect, any two or more features described in connection with the foregoing aspects and/or other embodiments disclosed herein may be combined for additional advantage.

Additional features and advantages will be set out in the detailed description that follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional view of an exemplary coated optical fiber that includes a glass core, glass cladding surrounding the glass core, and a multi-layer polymer coating surrounding the glass cladding.

FIG. 2 is a perspective view of a conventional fiber optic connector assembly and an associated fiber optic cable forming a fiber optic cable assembly, with the fiber optic connector assembly including a MT-type multi-fiber ferrule having micro-passages suitable for receiving thermoplastic adhesive material for securing optical fibers therein according to one embodiment.

FIG. 3 is an exploded perspective view of the fiber optic cable assembly of FIG. 2.

FIG. 4 is a front elevational view of the conventional MT-type multi-fiber ferrule of FIGS. 2 and 3, showing a one-dimensional array of micro-passages extending to a front end face of the ferrule.

FIG. 5 is a front perspective view of a conventional TMT-type multi-fiber ferrule including a one-dimensional array of micro-passages suitable for receiving optical fibers therein.

FIGS. 6A and 6B are top plan and side elevational views, respectively, of a window stripped portion of an optical fiber ribbon including optical fibers arranged in a one-dimensional array.

FIGS. 6C and 6D are top plan and side elevational views, respectively, of a pair of stacked and laterally offset (first and second) window stripped ribbons each having optical fibers in a 1×4 array, in preparation for forming an interdigitated 1×8 array.

FIGS. 7A and 7B provide top plan and side elevational views, respectively, of the pair of window stripped ribbons of FIGS. 6C and 6D, with stripped (i.e., bare) portions of optical fibers thereof being pressed between a lower plate, upper pad, and lateral pushers to form an interdigitated 1×8 array.

FIG. 8A is a cross-sectional view of stripped optical fibers of the pair of window stripped ribbons of FIGS. 6C and 6D arranged in an interdigitated 1×8 array and in combination with adhesive material, arranged between plate-backed upper and lower pads as well as side pushers, prior to compression of the upper and lower pads around the adhesive material and the interdigitated array.

FIG. 8B is a cross-sectional view of the items shown in FIG. 8A, following vertical compression of the top and bottom pads and lateral compression of the side pushers to cause the upper and lower pads to contact stripped fibers of the array and displace part of the adhesive material.

FIGS. 9A and 9B are top plan and side elevational views, respectively, of the stacked pair of window stripped ribbons of FIGS. 6C to 7B including an adhered group of interdigitated stripped optical fibers configured in a 1×8 array.

FIG. 10 is a cross-sectional view of an adhered group of interdigitated stripped optical fibers configured in a 1×8 array, with adhesive material between fibers being flush with a bottom datum plane of the optical fibers, and being recessed relative to a top datum plane of the optical fibers.

FIG. 11A is a side elevational view of three stacked pairs of window stripped optical fibers each having an adhered group of interdigitated stripped optical fibers configured in a 1×8 array, with the three adhered groups of optical fibers being stacked and supported by a lower plate of a joining fixture, with a pad supported by an upper plate being superimposed over the stacked adhered group of optical fibers.

FIG. 11B shows the items of FIG. 11A following contact of the pad with an uppermost adhered group of optical fibers as part of a step of adhering the three stacked groups of interdigitated stripped optical fibers to one another with interstitially arranged adhesive to form a two-dimensional fiber array, without adhesive material protruding beyond outermost surface of optical fibers at a perimeter of the two-dimensional fiber array.

FIG. 12 is a side elevational view of the three stacked groups of optical fibers of FIGS. 11A-11B following adhesion of the three stacked groups of bare fibers into a two-dimensional fiber array, and following sawing or laser cutting of the two-dimensional fiber array to provide two cut two-dimensional fiber array portions.

FIG. 13 is a side elevational view of one cut fiber array portion of FIG. 12 with an end portion thereof positioned in a polishing apparatus to enable polishing of cut ends of optical fibers of the two-dimensional array.

FIG. 14 is a side elevational view of the cut fiber array portion of FIG. 12 after polishing of cut ends of optical fibers thereof.

FIG. 15 is a side elevational view of a stacked pair of window stripped ribbons including an adhered group of interdigitated stripped optical fibers configured in a 1×8 array, following cleaving of optical fibers of the 1×8 array to form two cut one-dimensional fiber array portions.

FIG. 16A is a side elevational view of three stacked pairs of stripped ribbons each including a one-dimensional fiber array portion as produced in FIG. 15, with the three one-dimensional fiber array portions being stacked together and arranged proximate to a joining fixture including an end face plate as well as upper and lower plates.

FIG. 16B shows the items of FIG. 16A, following positioning of cleaved ends of the one-dimensional fiber array portions against the end face plate and compression of the upper and lower plates around the one-dimensional fiber array portions, to permit the one-dimensional fiber array portions to be adhered to one another with interstitially arranged adhesive to form a two-dimensional fiber array.

FIG. 17 is a cross-sectional view of eight stacked groups of adhered optical fibers, with each group having stripped optical fibers configured in a 1×8 array, arranged within a joining fixture having one side alignment block, a lower alignment block, a side pad having an associated side pusher, and a top pad having an associated top pusher, prior to the top pad contacting an uppermost group of adhered optical fibers of the eight stacked groups thereof, to permit the stacked groups of stripped optical fibers to be adhered to one another with interstitially arranged adhesive to form an adhered two-dimensional optical fiber array.

FIG. 18 is a cross-sectional view of eight stacked groups of adhered optical fibers, with each group having stripped optical fibers configured in a 1×8 array, arranged within a joining fixture having a lower alignment block configured to receive two sides of the 8×8 optical fiber array with rectangular packing, and having an upper pad and associated pusher configured to press against two other sides of the 8×8 optical fiber array, to permit the stacked groups of stripped optical fibers to be adhered to one another with interstitially arranged adhesive to form an adhered two-dimensional optical fiber array.

FIG. 19 is a cross-sectional view of an adhered 8×8 optical fiber array with rectangular packing, with peripheral adhesive material between fibers being flush with left and bottom datum planes of the optical fibers, and being recessed relative to top and right datum planes of the optical fibers.

FIG. 20 is a cross-sectional view of an adhered 8×8 optical fiber array with rectangular packing, with adhesive material confined to areas between fibers, with peripheral adhesive material being recessed relative to left, right, top, and bottom datum planes of the optical fibers.

FIG. 21 is a cross-sectional view of an adhered 8×8 optical fiber array with rectangular packing, with each optical fiber of the array having a durable, enhanced hardness material (optionally embodying a deposited material) along an outer surface thereof.

FIG. 22 is a cross-sectional view of an adhered 2D optical fiber array, in which perimeter fibers 139 have a durable, enhanced hardness material along outer surfaces thereof, while interior fibers of the array lack enhanced hardness outer surfaces.

FIG. 23 is a cross-sectional view of a nine stacked groups of adhered optical fibers, with each group having stripped optical fibers configured in a 1×8 array, arranged within a joining fixture configured to produce an adhered 9×8 optical fiber array with hexagonal packing, the joining fixture having left and right guides with alternating grooves and protrusions, and having a left side alignment block and a right side pad having an associated side pusher, with the optical fiber array further positioned between a bottom alignment block and a top pad having an associated top pusher, to permit the stacked groups of stripped optical fibers to be adhered to one another with interstitially arranged adhesive to form an adhered two-dimensional optical fiber array.

FIG. 24 is a cross-sectional view of nine stacked groups of adhered optical fibers, including alternating groups of stripped optical fibers configured in 1×9 and 1×8 arrays, respectively, arranged within a joining fixture configured to produce an adhered two-dimensional optical fiber array with hexagonal packing, the joining fixture having a left side alignment block, a right side pad having an associated side pusher, a bottom alignment block, and a top pad having an associated top pusher, to permit the stacked groups of stripped optical fibers to be adhered to one another with interstitially arranged adhesive to form an adhered two-dimensional optical fiber array.

FIG. 25A is a cross-sectional view of an L-shaped alignment block having V-grooves defined in a left wall and defined in a bottom wall thereof, with a superimposed first group of stripped optical fibers configured in a 1×8 array arranged to be received by the alignment block.

FIG. 25B is a cross-sectional view of the alignment block of FIG. 25A, following receipt of the first group of stripped optical fibers (in a 1×8 array) in V-grooves of the bottom wall, with a superimposed second group of stripped optical fibers configured in a 1×8 array arranged to be placed atop the first group of stripped optical fibers.

FIG. 25C is a cross-sectional view of the alignment block of FIGS. 25A-25B with eight stacked groups of stripped optical fibers, each in a 1×8 array and stacked in a rectangular configuration, received by the alignment block.

FIG. 25D is a cross-sectional view of the alignment block and eight stacked groups of stripped optical fibers of FIG. 25C, together with a right side pad having an associated side pusher and a top pad having an associated top pusher being configured to press the stacked groups of stripped optical fibers toward one another, to permit the stacked groups of stripped optical fibers to be adhered to one another with interstitially arranged adhesive to form an adhered 8×8 (two-dimensional) optical fiber array.

FIG. 26 is a front (or end) elevational view of an adhered 8×8 optical fiber array with rectangular packing, with peripheral adhesive material between fibers being recessed relative to left, right, top, and bottom datum planes of the optical fibers, and being producible with the apparatus of FIG. 25D.

FIG. 27A is a front elevational view of an adhered non-linear (2D) sub-array of twelve stripped optical fibers in a hexagonal packed configuration, with a first row of three optical fibers, a second row of four optical fiber, and a third row of five optical fibers, and with adhesive material not extending beyond outermost datum planes of the optical fibers.

FIG. 27B is a front elevational view of an adhered triangular (2D) optical fiber array in a hexagonal packed configuration with eight stripped optical fibers per side, formed from three non-linear (2D) sub-arrays according to FIG. 27A, with adhesive material between sub-arrays, and peripheral adhesive material not extending beyond datum planes of the optical fibers.

FIG. 28 is a cross-sectional view of a four stacked groups of adhered optical fibers, with each group having stripped optical fibers configured in a 1×8 array, and with transversely arranged optical fiber array rafts positioned between adjacent optical fiber groups, within a joining fixture having one side alignment block, a lower alignment block, a side pad having an associated side pusher, and a top pad having an associated top pusher, to permit the stacked groups of stripped optical fibers and fiber array rafts to be adhered to one another with interstitially arranged adhesive to form an adhered two-dimensional optical fiber array.

FIG. 29A is a perspective view of an adhered two-dimensional array of stripped optical fibers including eight rows of optical fibers (with two rows of six optical fibers sandwiched between three upper rows and three lower rows each having eight optical fibers) having non-uniform peripheral boundaries including first and second involutions defined a perimeter of the array and being configured to receive first and second alignment pins.

FIG. 29B is a perspective view of the adhered two-dimensional array of stripped optical fibers of FIG. 29A, with first and second alignment pins received in the first and second involutions defined in the perimeter of the array.

FIG. 29C is a perspective view of a first adhered two-dimensional array of stripped optical fibers with alignment pins according to FIG. 29B, arranged proximate to a second adhered two-dimensional array of stripped optical fibers (without alignment pins) according to FIG. 29A.

FIG. 29D is a perspective view of the first and second arrays of stripped optical fibers of FIG. 29C in a mated configuration, with end faces of optical fibers of the first array being aligned with end faces of optical fibers of the second array.

FIG. 30 is a front elevational view of the adhered two-dimensional array of stripped optical fibers with alignment pins according to FIG. 29B, with a removable sleeve fitting around a portion (e.g., 75%) of a perimeter of the array arranged in contact with the alignment pins, the sleeve having a modified semi-rectangular shape including outwardly flared regions receiving the alignment pins to bias the alignment pins into contact with optical fibers bounding involutions of the 2D array.

FIG. 31 is a front elevational view of an adhered quasi-rectangular two-dimensional array of stripped optical fibers (including six rows of eight optical fibers sandwiched between an upper row and lower row each having six optical fibers) having involutions arranged at corner areas thereof, with first to fourth alignment pins received partially within the involutions and in contact with optical fibers therein.

FIG. 32 is a front elevational view of an adhered 8×8 array of stripped optical fibers having glass sheets or fiber array rafts arranged along discontinuous portions of opposing first and second sides of the array, with first and second alignment pins arranged along the first and second sides in the discontinuous portions between the glass sheets of fiber array rafts.

FIG. 33 is a front elevational view of an adhered 8×8 array of stripped optical fibers having glass sheets or fiber array rafts arranged along first to fourth sides of the array, with first and second alignment pins arranged at two non-adjacent corners of the array.

FIG. 34 is a front elevational view of an adhered 8×8 array of stripped optical fibers having first and second alignment pins and pairs of glass rods arranged proximate to opposing first and second sides of the array, respectively, with one pair of glass rods arranged between each alignment pin and the peripheral optical fibers of the array.

FIG. 35 is a front elevational view of an adhered 8×8 array of stripped optical fibers having first and second alignment pins and fiber array rafts arranged proximate to opposing first and second sides of the array, respectively, with one fiber array raft arranged between each alignment pin and the peripheral optical fibers of the array.

FIG. 36 is a front elevational view of an adhered two-dimensional array of stripped optical fibers including eight rows of optical fibers (with four rows of six optical fibers sandwiched between two upper rows and two lower rows each having eight optical fibers) having non-uniform peripheral boundaries including first and second involutions defined in a perimeter of the array, and having first and second alignment pins and pairs of glass rods arranged proximate to opposing first and second sides of the array, respectively, with one pair of glass rods received in each involution and arranged between each alignment pin and peripheral optical fibers of the array.

FIG. 37A is a perspective view of a first adhered two-dimensional array of stripped optical fibers with pairs of glass rods received in peripheral involutions and with alignment pins according to FIG. 36, arranged proximate to a second adhered two-dimensional array of stripped optical fibers with pairs of glass rods received in peripheral involutions according to FIG. 36, but without alignment pins.

FIG. 37B is a perspective view of the first and second two-dimensional arrays of stripped optical fibers of FIG. 37A in a mated configuration, with end faces of optical fibers of the first array being aligned with end faces of optical fibers of the second array, and with alignment pins arranged against adjacent pairs of glass rods received by peripheral involutions in the first and second arrays.

FIG. 38A is a front elevational view of an adhered two-dimensional array of stripped optical fibers including eight rows of optical fibers (with four rows of six optical fibers sandwiched between two upper rows and two lower rows each having eight optical fibers) having non-uniform peripheral boundaries including first and second involutions defined in a perimeter of the array, and having first and second glass tubes partially received in the respective first and second involutions.

FIG. 38B is a front elevational view of the adhered two-dimensional array of stripped optical fibers as well as the first and second glass tubes of FIG. 38A, with first and second alignment pins received within the first and second glass tubes.

FIG. 39 is a front elevational view of an adhered 8×8 array of stripped optical fibers having first and second V-blocks serving as alignment features positioned around non-adjacent corners of the array in contact with peripheral optical fibers of the array.

FIG. 40 is a front elevational view of an adhered 8×8 array of stripped optical fibers surrounded on four peripheral sides thereof with four 1×8 arrays of perimeter glass fibers each having an enhanced hardness outer surface to form a protected array, with first and second V-blocks serving as alignment features positioned around non-adjacent corners of the protected array in contact with selected perimeter glass fibers of the four 1×8 arrays.

FIG. 41 is a front elevational view of an adhered 8×8 array of stripped optical fibers surrounded on four peripheral sides thereof with four glass sheets or fiber array rafts, with first and second V-blocks serving as alignment features positioned around non-adjacent corners of the protected array in contact with portions of the four glass sheets or fiber array rafts.

FIG. 42 is a front elevational view of an adhered two-dimensional array of stripped optical fibers including eight rows of optical fibers (with two rows of six optical fibers sandwiched between three upper rows and three lower rows each having eight optical fibers) having non-uniform peripheral boundaries including first and second involutions defined in opposing sides at a perimeter of the array, and having first and second alignment pins received in the respective first and second involutions, with first and second V-groove blocks arranged to bias the alignment pins into contact with optical fibers bounding the involutions.

FIG. 43 is a cross-sectional view of an adhered two-dimensional array of stripped optical fibers including eight rows of optical fibers (with three rows of six optical fibers sandwiched between two upper rows and three lower rows each having eight optical fibers) having non-uniform peripheral boundaries including first and second involutions defined in opposing sides at a perimeter of the array, with first and second alignment pins received in the respective first and second involutions, and with an oval-shaped sleeve surrounding a majority (e.g., more than 90 percent) of a total perimeter of the array and arranged in contact with the alignment pins to bias the alignment pins into contact with optical fibers bounding the involutions.

FIG. 44 is a cross-sectional view of an adhered two-dimensional array of stripped optical fibers including eight rows of optical fibers (with two rows of six optical fibers sandwiched between three upper rows and three lower rows each having eight optical fibers) having non-uniform peripheral boundaries including first and second involutions defined in opposing sides at a perimeter of the array, with a modified semi-rectangular shaped sleeve surrounding a majority (e.g., more than 65 percent) of an aggregate perimeter of the array, with inwardly flared regions of the sleeve protruding into the first and second involutions and arranged in contact with peripheral optical fibers bounding the involutions.

FIG. 45 is a cross-sectional view of an adhered 8×8 array of stripped optical fibers including eight rows of optical fibers, with a glass sheet or fiber array raft arranged along one side of the array, and with a modified semi-rectangular shaped sleeve surrounding a majority (e.g., more than 75 percent) of an aggregate perimeter of the array and the glass sheet or fiber array raft, with inwardly flared regions of the sleeve arranged in contact with peripheral optical fibers of the array at two corners thereof.

FIG. 46 is a cross-sectional view of an adhered 8×8 array of stripped optical fibers, received within a sleeve surrounding a majority (e.g., approximately 75 percent) of an aggregate perimeter of the array, with three inwardly flared regions of the sleeve arranged in contact selected with peripheral optical fibers along two sides of the array, and with one outwardly flared region of the sleeve arranged in contact with an optical fiber at one corner of the array.

FIG. 47 is a cross-sectional view of an adhered two-dimensional array of stripped optical fibers including eight rows of eight optical fibers arranged in a rectangular packed configuration, with groups of three additional optical fibers arranged in a hexagonal packed configuration along three sides of the array to form protrusions, with the array being received within a modified semi-rectangular shaped sleeve surrounding a majority (e.g., about 75 percent) of an aggregate perimeter of the array, and with outwardly flared regions of the sleeve receiving protrusions formed by three-fiber groups along two opposing sides of the fiber array.

FIG. 48 is a cross-sectional view of an adhered 8×8 array of stripped optical fibers, with a V-block arranged along two sides of the array, with a modified semi-rectangular shaped sleeve surrounding a majority (e.g., more than 75 percent) of an aggregate perimeter of the array and the V-block, and with an outwardly flared region of the sleeve arranged in contact with an optical fiber at one corner of the array.

FIG. 49 is a front elevational view of an adhered two-dimensional array of stripped optical fibers, the array being devoid of optical fibers at two locations in an interior of the array to provide first and second fiber-free areas, with first and second glass tubes received within the first and second fiber-free areas, respectively.

FIG. 50 is a front elevational view of an adhered two-dimensional array of stripped optical fibers, the array being devoid of optical fibers at two locations in an interior of the array to provide first and second fiber-free areas, with first and second alignment pins received within the first and second fiber-free areas, respectively.

FIG. 51A is a perspective view of an adhered 8×8 array of stripped optical fibers, with fiber array rafts arranged on four peripheral sides of the array, and with fibers of the fiber array rafts being transversely oriented relative to optical fibers of the array.

FIG. 51B is a cross-sectional view of the adhered 8×8 array and fiber array rafts of FIG. 51A.

FIG. 52A is a perspective view of an adhered 8×8 array of stripped optical fibers, with fiber array rafts arranged on four peripheral sides of the array, and with fibers of the fiber array being oriented parallel to optical fibers of the array.

FIG. 52B is a cross-sectional view of the adhered 8×8 array and fiber array rafts of FIG. 52A.

FIG. 53 is a side elevational view of an adhered 8×8 array of stripped optical fibers, with fiber array rafts (having fibers thereof oriented parallel to optical fibers of the array) arranged on four peripheral sides of the array, and with fibers of the fiber array rafts having beveled ends at a front boundary perimeter of the array.

FIG. 54 is a side cross-sectional view of an adhered 8×8 array of stripped optical fibers, with fiber array rafts (having fibers thereof oriented parallel to optical fibers of the array) arranged on four peripheral sides of the array, and with fibers of the fiber array rafts having rounded ends at a front boundary perimeter of the array.

FIG. 55 is a side cross-sectional view of an adhered 8×8 array of stripped optical fibers, with glass sheets arranged on peripheral sides of the array.

FIG. 56 is a side cross-sectional view of an adhered 8×8 array of stripped optical fibers, with glass sheets arranged on peripheral sides of the array, and the glass sheets having beveled ends at a front boundary perimeter of the array.

FIG. 57 is a side cross-sectional view of first and second adhered 8×8 arrays of stripped optical fibers each having glass sheets (with beveled ends a front boundary perimeter of the array) arranged on peripheral sides of the array, with the first 8×8 array and associated peripheral glass sheets received in a first portion of a connector sleeve, and with the second 8×8 array and associated peripheral glass sheets arranged proximate to a second portion of the connector sleeve without being received therein.

FIG. 58 is a side cross-sectional view of the first and second adhered 8×8 arrays of stripped optical fibers and associated peripheral glass sheets received in respective first and second portions of the connector sleeve of FIG. 57, with addition of removable clips configured to engage perpendicular rear surfaces of the peripheral glass sheets to apply a biasing force pressing the glass sleeves into the connector sleeve, and pressing end faces of the 8×8 arrays in contact with one another.

FIG. 59 is a side cross-sectional view of first and second adhered 8×8 arrays of stripped optical fibers and associated peripheral glass sheets received in respective first and second portions of a connector sleeve, with addition of removable clips configured to engage beveled rear surfaces of the peripheral glass sheets to apply a biasing force pressing the glass sleeves into the connector sleeve, and pressing end faces of the 8×8 arrays in contact with one another, with the beveled rear surfaces being configured to promote retention of the removable clips.

FIG. 60 is a side cross-sectional view of first and second adhered 8×8 arrays of stripped optical fibers and associated peripheral glass sheets received in respective first and second portions of a connector sleeve, with addition of coil springs configured to engage beveled rear surfaces of the peripheral glass sheets to apply a biasing force pressing the glass sleeves into the connector sleeve, and pressing end faces of the 8×8 arrays in contact with one another.

FIG. 61 is a cross-sectional view of an adhered 8×8 array of stripped optical fibers, with first and second glass sheets adhered to, and extending beyond, opposing first and second peripheral sides of the array, and with first and second alignment pins arranged between portions of the first and second glass sheets and arranged in contact with peripheral optical fibers of the 8×8 array.

FIG. 62 is a cross-sectional view of the items of FIG. 61, with a modified semi-rectangular shaped sleeve surrounding a majority (e.g., about 75 percent) of an aggregate perimeter of the array, and with outwardly flared regions of the sleeve receiving the alignment pins to bias the alignment pins into contact with peripheral optical fibers at lateral sides of the 8×8 array.

FIG. 63 is a cross-sectional view of an adhered 8×8 array of stripped optical fibers, with first and second fiber array rafts adhered to, and extending beyond, opposing first and second peripheral sides of the array, with first and second rectangular glass spacer blocks offset from the array and adhered between the fiber array rafts, and with first and second alignment pins contacting peripheral optical fibers of the 8×8 array, and arranged between the fiber array rafts as well as the spacer blocks.

FIG. 64 is a cross-sectional view of an adhered 8×8 array of stripped optical fibers, with first and second fiber array rafts adhered to, and extending beyond, opposing first and second peripheral sides of the array, with vertically discontinuous glass spacer blocks having curved recesses being offset from the array and separately adhered between the fiber array rafts, and with first and second alignment pins contacting peripheral optical fibers of the 8×8 array, and arranged between the fiber array rafts as well as the spacer blocks.

FIG. 65 is a cross-sectional view of first and second fiber array rafts adhered to, and extending beyond, a two-dimensional composite array of stripped optical fibers formed from five 8×8 array subunits, including two 8×8 outer array subunits being separated (and discontinuous) from three centrally arranged, contacting 8×8 array subunits, with first and second alignment pins arranged in fiber-free areas between the outer array subunits and the three centrally arranged array subunits.

FIG. 66 is a cross-sectional view of first and second fiber array rafts adhered to, and extending beyond, a two-dimensional array of stripped optical fibers formed from thirteen 8×8 contacting array subunits, with first and second alignment pins arranged in fiber-free areas between the outer array subunits and the three centrally arranged array subunits.

FIG. 67 is a cross-sectional view of one array portion including fourteen contacting 8×8 array subunits of stripped optical fibers with a first alignment pin arranged in a fiber-free area in an interior of the first array portion, with the first array portion being arranged between surrounded by contacting array subunits, with the first array subunit received between top and bottom plates as well as a left alignment block and a right side pad having an associated side pusher, to permit the array subunits to be adhered to one another with interstitially arranged adhesive to form an adhered two-dimensional optical fiber array portion.

FIG. 68A is a cross-sectional view of laterally abutting first and second adhered two-dimensional optical fiber array portions each having an alignment pin and each according to the array portion of FIG. 67, being arranged between opposing upper and lower glass plates as well as a left side pad having an associated left side pusher and a right side pad having an associated right side pusher, to permit the first and second array portions to be adhered to one another with a layer of adhesive material to form an adhered two-dimensional optical fiber array.

FIG. 68B is a front elevational view of the adhered two-dimensional optical fiber array with first and second alignment pins each surrounded by optical fibers, produced in accordance with FIG. 68A.

FIG. 69 is a cross-sectional view of an adhered 12×24 array of stripped optical fibers arranged between opposing upper and lower glass plates, with first and second alignment pins and pairs of glass rods arranged proximate to opposing first and second sides of the array, respectively, with one pair of glass rods arranged between each alignment pin and peripheral optical fibers of the array, with first and second compliant members arranged to bias the alignment pins toward the glass rods, and with a housing surrounding the foregoing items and being in contact with the glass plates and compliant members.

FIG. 70 is a cross-sectional view of an adhered 12×24 array of stripped optical fibers arranged between opposing upper and lower glass plates, with first and second alignment pins and pairs of glass rods arranged proximate to opposing first and second sides of the array, respectively, with one pair of glass rods arranged between each alignment pin and peripheral optical fibers of the array, with a housing including integrally formed first and second compliant members arranged to bias the alignment pins toward the glass rods, the housing surrounding the foregoing items and being in contact with the glass plates.

FIG. 71 is a cross-sectional view of an adhered 6×24 array of stripped optical fibers arranged between opposing upper and lower glass plates, with first and second alignment pins arranged proximate to opposing first and second sides of the array, respectively, with first and second compliant members arranged to bias the alignment pins toward peripheral fibers of the array, and with a housing surrounding the foregoing items and being in contact with the glass plates and compliant members.

FIG. 72 is a cross-sectional view of an adhered 12×24 array of stripped optical fibers arranged between opposing upper and lower glass plates, with first and second alignment pins each arranged within quartets of glass rods at first and second sides of the array, respectively, and with a housing surrounding the foregoing items and being in contact with the glass plates and peripheral glass rods of the glass rod quartets.

FIG. 73 is a cross-sectional view of an adhered 12×24 array of stripped optical fibers arranged between opposing upper and lower glass plates, with first and second alignment pins arranged within glass rods at first and second sides of the array, respectively, and with a housing surrounding the foregoing items and being in contact with the glass plates and the glass tubes.

FIG. 74 is a cross-sectional view of an adhered 8×24 array of stripped optical fibers arranged between opposing upper and lower glass plates, with first and second glass spacers abutting left and right boundaries of the array, respectively, and with first and second alignment pins abutting the first and second glass spacers.

FIG. 75 is a cross-sectional view of an adhered 8×8 array of stripped optical fibers array with columns of peripheral fibers having enhanced hardness outer surfaces at peripheral sides thereof, arranged between opposing upper and lower glass plates, and with first and second alignment pins abutting the columns of enhanced surface hardness peripheral fibers.

FIG. 76A is a cross-sectional view of an adhered 8×24 array of stripped optical fibers arranged between opposing upper and lower glass plates, with first and second alignment pins and pairs of glass rods arranged proximate to opposing first and second sides of the array, respectively, with one pair of glass rods arranged between each alignment pin and peripheral optical fibers of the array.

FIG. 76B is a cross-sectional view of an adhered 8×32 array of stripped optical fibers arranged between opposing upper and lower glass plates, with first and second alignment pins and pairs of glass rods arranged proximate to opposing first and second sides of the array, respectively, with one pair of glass rods arranged between each alignment pin and peripheral optical fibers of the array.

FIG. 76C is a cross-sectional view of an adhered 12×32 array of stripped optical fibers arranged between opposing upper and lower glass plates, with first and second alignment pins and pairs of glass rods arranged proximate to opposing first and second sides of the array, respectively, with one pair of glass rods arranged between each alignment pin and peripheral optical fibers of the array.

FIG. 77 is a perspective view of three discontinuous adhered 8×8 arrays of stripped optical fibers arranged between opposing upper and lower glass plates with fiber-free regions between arrays, with outwardly protruding tabs extending from rear portions of the glass plates, and unstripped segments of multiple optical fiber ribbons extending rearwardly from the arrays of stripped optical fibers.

FIG. 78A is a front elevational view of an adhered two-dimensional array of stripped optical fibers having a generally circular arrangement.

FIG. 78B is a perspective view of the adhered two-dimensional array of stripped optical fibers of FIG. 78A extending forward from a square-shaped shoulder member, with unstripped segments of multiple optical fiber ribbons extending rearwardly from the array of stripped optical fibers.

FIG. 79 is a perspective view of two stripped arrays of optical fibers according to FIG. 78B in abutting and mating relationship within a generally cylindrical sleeve, with associated shoulder members supported by a glass sheet.

### DETAILED DESCRIPTION

Various embodiments will be further clarified by examples in the description below. In general, the description relates to fiber optic cable assemblies having two-dimensional arrays of stripped optical fibers (2D fiber arrays) comprising glass, and methods for their fabrication, in which perimeter external surfaces a 2D fiber array are used as datum surfaces for alignment structures for 2D fiber array connector mating. Using external surfaces of a 2D fiber array leverages the inherent mechanical precision and accuracy of optical fiber geometry to enable production of very dense, mechanically accurate fiber optic connectors without requiring conventional ferrules. Various fiber optic cable assemblies disclosed herein are devoid of ferrules retaining stripped fiber segments. Exemplary alignment structures include one or more of alignment pins, precision glass tubes, precision thickness glass sheets, precision glass rods, fiber array rafts, V-blocks, and the like, wherein such structures may optionally be adhered to a 2D fiber array. In certain embodiments, a plurality of precision thickness glass sheets or rods may be arranged around at least half of a perimeter of a 2D fiber array including at least two adjacent perimeter sides thereof, and bonded to at least some optical fibers of the array. In certain embodiments, 2D fiber arrays may include non-uniform peripheral boundaries (e.g., peripheral involutions and/or peripheral protrusions) to serve as mating locations for alignment structures and/or to serve as keying structures for connector orientation. In certain embodiments, a removable sleeve may be positioned around at least a portion a 2D fiber array, as well as around at least a portion of one or more alignment structures (if provided), wherein such a sleeve may be used to bias one or more alignment structures to a desired position relative to a 2D fiber array. In certain embodiments, fiber-free areas may be provided in an interior of a 2D fiber array to receive alignment structures, optionally wherein the 2D fiber array is continuous and each fiber-free area is surrounded by optical fibers. In certain embodiments, one or more compliant members may be configured to press first and second alignment structures toward one another, with at least a portion of a 2D fiber array being arranged between the alignment structures. A method for fabricating at least one fiber optic cable assembly includes separately forming an adhered first window stripped optical fiber group and a second window stripped optical fiber group, and adhering the groups to one another with adhesive material in interstitial areas, without causing adhesive material to protrude beyond outermost surfaces of optical fibers at a perimeter of a resulting 2D fiber array. A method for coupling first and second fiber array cable assemblies each including a plurality of glass sheets or rods arranged around at least half of a perimeter of a 2D fiber array includes receiving end faces of the fiber optic cable assemblies in abutting relationship with a sleeve, and biasing the glass sheets or rods of the respective fiber optic cable assemblies toward one another.

Further details regarding the subject matter of the disclosure are provided hereinafter, after introduction to terminology and a brief introduction to conventional multi-fiber connectors to provide context for the disclosure.

### Reference Numbers and Terminology

The use herein of ordinals in conjunction with an element is solely for distinguishing what might otherwise be similar or identical labels, such as “first layer” and “second layer,” and does not imply a priority, a type, an importance, or other attribute, unless otherwise stated herein.

The term “about” as used herein in conjunction with a numeric value means any value that is within a range of ten percent greater than or ten percent less than the numeric value.

The term “substantially” used herein in conjunction with a geometric property or characteristic (e.g., “substantially flush”) includes slight deviations from the geometric property/characteristic in question due to manufacturing limitations and tolerances.

In this disclosure, when numerical ranges are discussed (e.g., “X to Y” or “between X and Y”, with X and Y being integers), the ranges include the stated end points.

As used herein, the articles “a” and “an” in reference to an element refers to “one or more” of the element unless otherwise explicitly specified. The word “or” as used herein is inclusive unless contextually impossible. As an example, the recitation of A or B means A, or B, or both A and B.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In this disclosure, the term “optical fiber” (or “fiber”) is used in a generic sense and may encompass bare optical fibers, coated optical fibers, or buffered optical fibers, as well as optical fibers including different sections corresponding to these fiber types, unless it is clear from the context which of the types is intended. “Bare optical fibers” (including “bare glass optical fibers”) or “bare sections” are those with no coating present on the fiber cladding. “Coated optical fibers” or “coated sections” include a single or multi-layer polymeric coating (typically acrylic) material surrounding the fiber cladding and have a nominal (i.e., stated) diameter no greater than twice the nominal diameter of the bare optical fiber. In certain embodiments, an optical fiber having a glass core as disclosed herein may be configured to carry (e.g., conduct) optical signals in a wavelength range of 850 nm to 1550 nm.

The term “stripped” as used herein (e.g., in the context of a “stripped region”) in connection with a glass optical fiber refers to an optical fiber for which any (and all) polymer coating layers have been removed. In certain embodiments, a stripped glass optical fiber may include an enhanced hardness outer surface having a hardness greater than a remaining (internal) portion of the glass cladding material, wherein such an enhanced hardness outer surface may be modified by physical means and/or chemical means (e.g., ion exchange), or may include a precision thickness layer of an enhanced hardness (e.g., ceramic) material.

This disclosure also refers to optical fibers having various “regions,” such as “stripped regions” or “stripped regions.” It will be clear from the context that, in some instances, a region of an optical fiber segment may be coextensive with the length of the optical fiber segment. For example, in some instances it will be clear that an optical fiber segment comprising a “stripped region” does not necessarily mean that there is some other, adjacent unstripped region; this is not the case unless the context makes clear otherwise.

Groups of coated optical fibers (e.g., at least 4, 8, 12, or 24 optical fibers) may be held together using a matrix material, intermittent inter-fiber binders (“spiderwebs”), or tape to form “optical fiber ribbons” or “ribbonized optical fibers” to facilitate packaging either within cables or outside of cables, with each fiber having a different color for ease of identification.

### Conventional Ferrule-Based Multi-Fiber Connectors

Before discussing novel fiber optic cable assemblies and fabrication methods according to the present disclosure, an introduction to two types of conventional ferrule-based multi-fiber connectors (i.e., fiber-to-fiber connectors) each configured to retain multiple optical fibers will be provided to facilitate discussion and provide context for the disclosure.

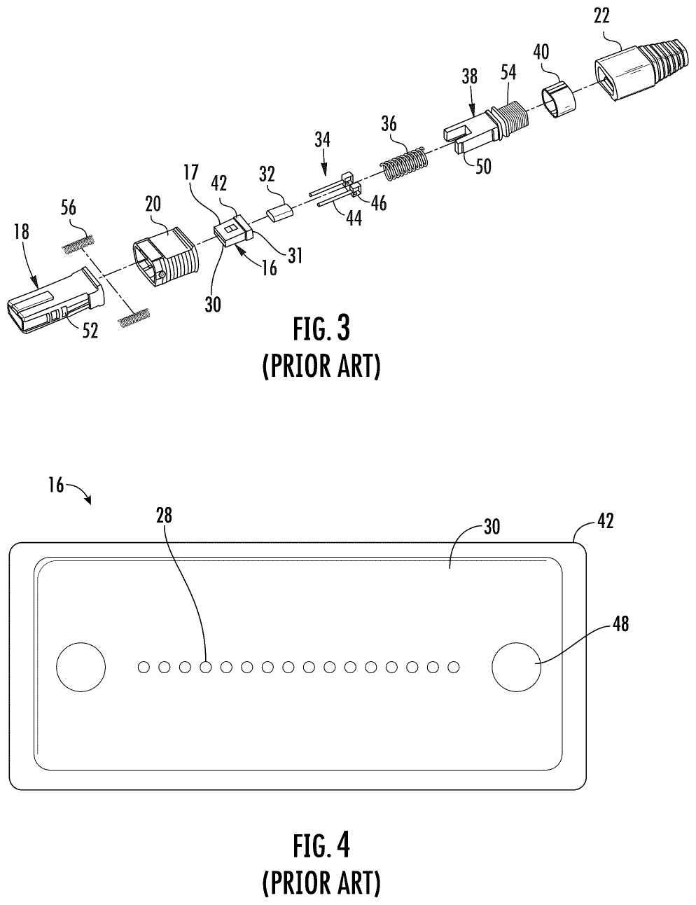

A first example of a ferrule-based fiber optic connector 10 (also referred to as “optical connector 10”, or simply “connector 10”) is shown in FIG. 2, with an exploded view of the connector being provided in FIG. 3, and with a magnified front view of a ferrule 16 of the connector being provided in FIG. 4. The connector 10 is shown in the form of an MTP® connector, which is particular type of MPO connector (MTP® is a trademark of US Conec Ltd.). As shown in FIG. 2, the connector 10 may be installed on a fiber optic cable 12 (“cable”) to form a fiber optic cable assembly 14. The connector 10 includes a ferrule 16, a housing 18 received over the ferrule 16, a slider 20 received over the housing 18, and a boot 22 received over the cable 12. The ferrule 16 includes a body 17 and is spring-biased within the housing 18 so that a front portion 24 of the ferrule 16 extends beyond a front end 26 of the housing 18. Optical fibers (not shown) carried by the cable 12 extend through micro-passages (also known as micro-holes or micro-bores, or simply bores) 28 defined in the ferrule 16 before terminating at or near a front end face 30 of the ferrule 16. The optical fibers are secured within micro-passages (28 in FIG. 4) of the ferrule 16 using an adhesive material and can be presented for optical coupling with optical fibers of a mating component (e.g., another fiber optic connector; not shown) when the housing 18 is inserted into an adapter, receptacle, or the like.

As shown in FIG. 3, the connector 10 also includes a ferrule boot 32, guide pin assembly 34, spring 36, crimp body 38, and crimp ring 40. The ferrule boot 32, which is unitary in character, is received in a rear portion 42 of the ferrule 16 to help support the optical fibers extending to the micro-passages 28 (shown in FIG. 4). In particular, optical fibers extend through an aperture (not shown) defined through the ferrule boot 32. The guide pin assembly 34 includes a pair of guide pins 44 extending from a pin keeper 46. Features on the pin keeper 46 cooperate with features on the guide pins 44 to retain portions of the guide pins 44 within the pin keeper 46. When the connector 10 is assembled, the pin keeper 46 is positioned against a back surface of the ferrule 16, and the guide pins 44 extend through pin holes 48 (shown in FIG. 4) provided in the ferrule 16 so as to project beyond the front end face 30 of the ferrule 16.

Both the ferrule 16 and guide pin assembly 34 are biased to a forward position relative to the housing 18 by the spring 36. More specifically, the spring 36 is positioned between the pin keeper 46 and a portion of the crimp body 38. The crimp body 38 is inserted into the housing 18 when the connector 10 is assembled and includes latching arms 50 that engage recesses 52 in the housing 18. The spring 36 is compressed by this point and exerts a biasing force on the ferrule 16 via the pin keeper 46. The rear portion 42 of the ferrule 16 defines a flange that interacts with a shoulder or stop formed within the housing 18 to retain the rear portion 42 of the ferrule 16 within the housing 18. The rear portion 42 of the ferrule 16 also includes a recess (not shown) configured to receive at least a front portion of the ferrule boot 32.

In a manner not shown in the figures, aramid yarn or other strength members from the cable 12 are positioned over an end portion 54 of the crimp body 38 that projects rearwardly from the housing 18. The aramid yarn is secured to the end portion 54 by the crimp ring 40, which is slid over the end portion 54 and deformed after positioning the aramid yarn. The boot 22 covers this region, as shown in FIG. 2, and provides strain relief for optical fibers emanating from the fiber optic cable 12 by limiting the extent to which the connector 10 can bend relative to the fiber optic cable 12.

FIG. 4 is a front elevational view of the ferrule 16, showing a one-dimensional array of micro-passages 28 extending to a front end face 30 thereof. As shown, the front end face 30 has a reduced height and width compared to a rear portion 42 thereof. The ferrule 16 may comprise a polymer material (e.g., polyphenylene sulfide), optionally reinforced with inorganic fillers such as glass fibers or beads. Although only a single linear array of micro-passages 28 forming a 1×12 array is shown in FIG. 4, various known multi-fiber connectors include multiple vertically displaced rows of micro-passages (e.g., forming a 2×12 or other array), with the various rows being separated from one another by intervening material of a unitary ferrule.

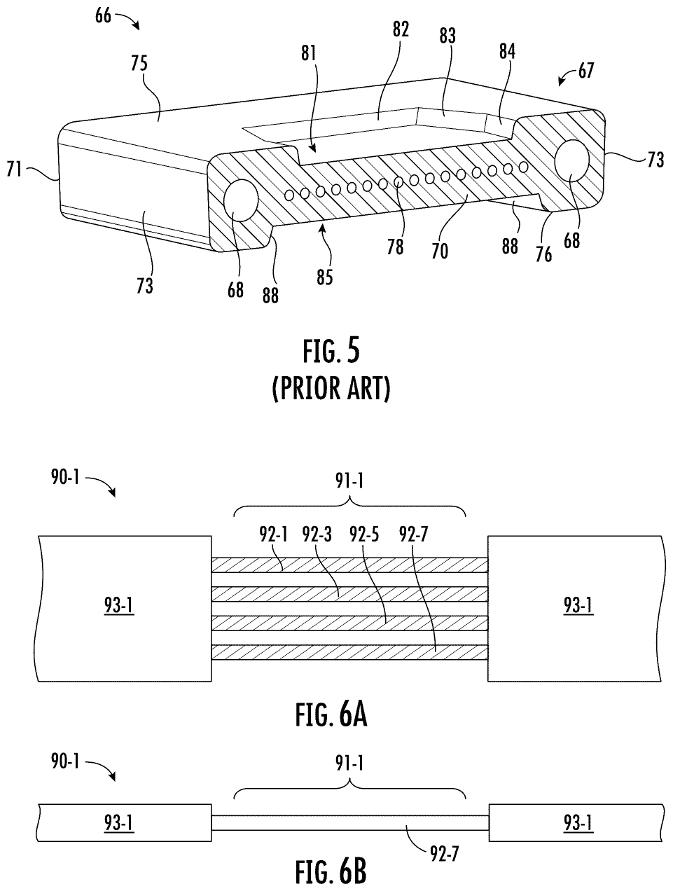

A front perspective view of another exemplary multi-fiber (i.e., a first TMT-type) ferrule 66 including a one-dimensional array of micro-passages 78 is shown in FIG. 5. The ferrule 66 includes a ferrule body 67 having a front end face 70, a rear end face 71, lateral surfaces 73, a top surface 75 and a bottom surface 76. An upper recess 81 is defined in the top surface 75 and extends to the front end face 70. Edges of the upper recess 81 are bounded by an upper recess boundary surfaces 82-84. A lower recess 85, which is wider than the upper recess 81, is defined in the bottom surface 76 and also extends to the front end face 70, with edges of the lower recess 85 being bounded by lower recess boundary surfaces 88. Pin holes 68 suitable for receiving alignment pins (not shown) extend from the front end face 70 to the rear end face 71 parallel to the lateral surfaces 73. A rear central recess (not shown) extends from the rear end face 71 into the ferrule body 67, and may have sufficient width and height to receive unstripped portions of multiple optical fibers (not shown). Although only a single linear array of micro-passages 78 is shown, it is to be appreciated that other TMT-type ferrules may include multiple linear arrays of micro-passages, with such arrays being vertically displaced relative to one another.

### Preferred Embodiments

Reference will now be made in detail to the presently preferred embodiments, examples of which are illustrated in the following drawings. Whenever possible, the same or corresponding reference numerals will be used throughout the drawings to refer to the same or like parts.

The embodiments set out below represent the information to enable those skilled in the art to practice the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Fiber optic cable assemblies having two-dimensional arrays of stripped optical fibers (2D fiber arrays) comprising glass, and methods for their fabrication, incorporate 2D fiber arrays in which perimeter external surfaces of a 2D fiber array are used as datum surfaces for alignment structures for 2D fiber array connector mating. This approach leverages the inherent mechanical precision and accuracy of optical fiber geometry to enable production of very dense, mechanically accurate fiber optic connectors for fiber optic cable assemblies without requiring conventional ferrules. This approach enables multiple benefits. Firstly, highly dense and simple connector designs are provided, thereby enabling more input/output per unit cross-sectional area at a significantly reduced cost per connection. As a point of reference, a standard MTP ferrule holds an array of 12 (or 24) optical fibers; however, nearly 1,000 stripped optical fibers arranged in a rectangular array can fit inside the same frontal area as a conventional MTP ferrule. Secondly, the present disclosure provides rematable connectors that can be interchangeably mated with any other connectors of the same general design, as opposed to matched-pair connector designs. A related benefit is that many connector designs disclosed herein do not embody have specific left-hand or right-hand connectors because of the inherent bilateral symmetry of the fiber array geometries, which will simplify polarity management and deployment of cable infrastructure in hyperscale data centers and other facilities.

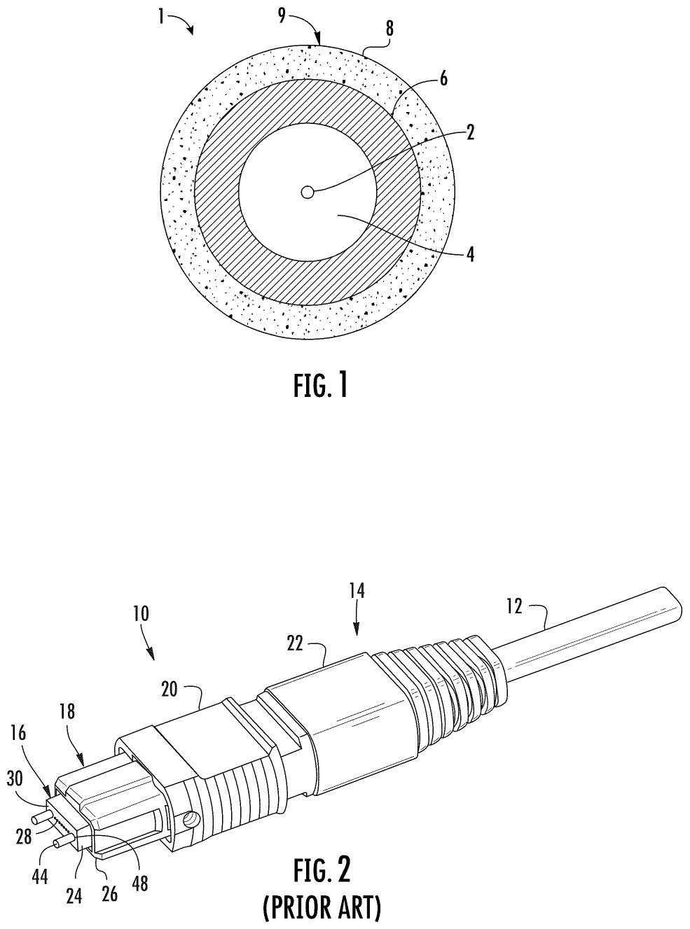

Various methods disclosed herein utilize stripped optical fibers, which may emanate from one or more ribbons optionally include a cable jacket. A stripping processes for removing a cable jacket may utilize mechanical strippers, which heat and soften the cable jacket prior to removal using a pair of serrated blades. Following removal of a jacket, matrix material and/or a polymer coating (e.g., 9 in FIG. 1) may be removed using a similar mechanical process, or a hot gas (e.g., hot nitrogen) stripping process, or a laser-based stripping process, all as known in the art, to expose bare glass (e.g., glass cladding layer 4 in FIG. 1) of one or more optical fibers. In certain embodiments, the foregoing stripping steps may be applied to an intermediate section (or “window,” according to a process referred to a “window stripping”) to yield a window stripped fiber, in which a bare glass section is intermediately arranged between surrounding sections that including a polymer coating (optionally in conjunction with a jacket and/or matrix material), with unstripped sections of the same optical fibers embodying continuous extends of the stripped sections. After stripping is performed, the stripped sections may be cleaned according to conventional cleaning steps.

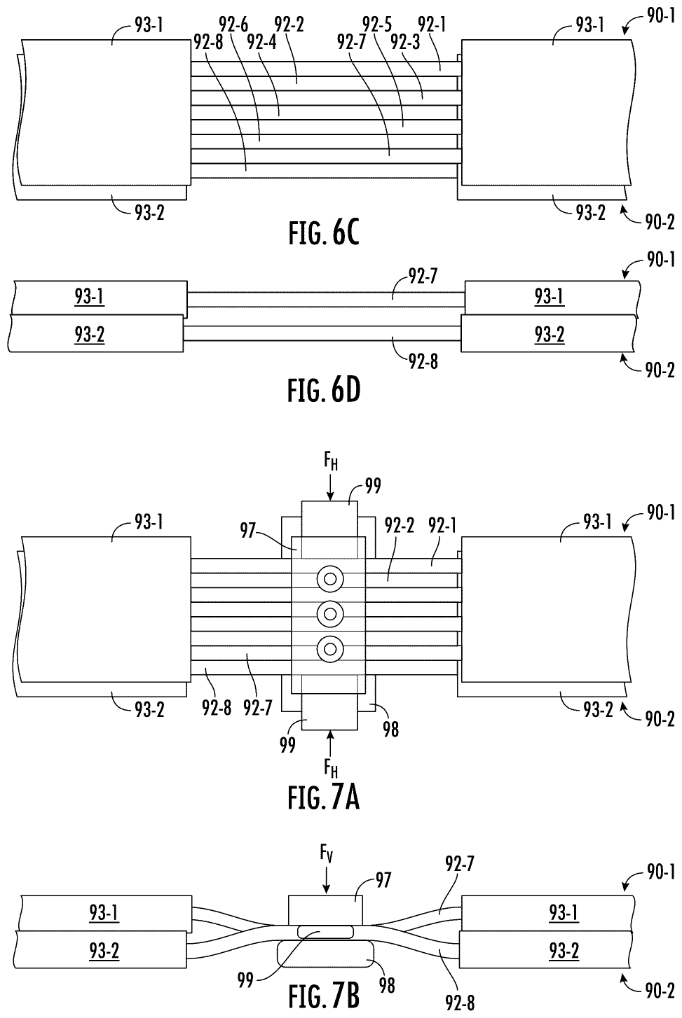

FIGS. 6A and 6B are top plan and side elevational views, respectively, of a first window stripped optical fiber ribbon 90-1 including a window stripped region 91-1 with four stripped (bare) optical fibers 92-1, 92-3, 92-5, 92-7 arranged in a one-dimensional (1×4) array arranged between unstripped regions 93-1 (which, as shown, may optionally be jacketed, with a jacket extending over polymer coated fibers). As shown in FIGS. 6C and 6D, the first window stripped optical fiber ribbon 90-1 (of FIGS. 6A and 6B) may be stacked over and laterally offset (i.e., a distance equal to the fiber spacing in the first ribbon 90-1) over a second window stripped optical fiber ribbon 90-2 having four stripped optical fibers 92-2, 92-4, 92-6, 92-8 arranged in a one-dimensional (1×4) array arranged between unstripped regions 93-2, in preparation for making an interdigitated eight fiber (1×8) array. As shown in FIG. 6C, the stacked and offset stripped optical fibers 92-1 to 92-8 of the window stripped ribbons 90-1, 90-2 appear interdigitated when viewed from above.

FIGS. 7A and 7B provide top plan and side elevational views, respectively, of the pair of window stripped ribbons 90-1, 90-2 of FIGS. 6C and 6D, with central portions of stripped (i.e., bare) regions of optical fibers thereof (encompassing stripped optical fibers 92-1 to 92-8) being pressed between a deformable upper pad 97, a rigid, precision flatness lower plate 98, and two lateral pushers 99 of a joining fixture to form an interdigitated 1×8 array. The precision flatness lower plate 98 may include a surface roughness well below 1 μm, and may include, for example, a precision diamond turned flat surface, or a precision ground fusion glass block. During a squeezing step, an applied vertical force (Fv) exerts downward pressure on the upper pad 97 to press downward on the interdigitated 1×8 array against the flat lower plate 98 to cause the stripped optical fibers 92-1 to 92-8 to lie in the same horizontal plane, while the lateral pushers 99 apply a horizontal force (FH) to exert lateral pressure in order to press the stripped optical fibers 92-1 to 92-8 into lateral contact with one another. Either before or during the squeezing step, adhesive material (not shown) may be applied to the stripped optical fibers 92-1 to 92-8 and the deformable upper pad 97 will displace or prevent formation of any excess adhesive along (at least) upper portions of the stripped optical fibers 92-1 to 92-8. After curing (e.g., using heat, UV emissions, or the like), the stripped optical fibers 92-1 to 92-8 will remain interdigitated and bound to one another where adhesive is present, with the stripped optical fibers 92-1 to 92-8 laterally contacting one another.

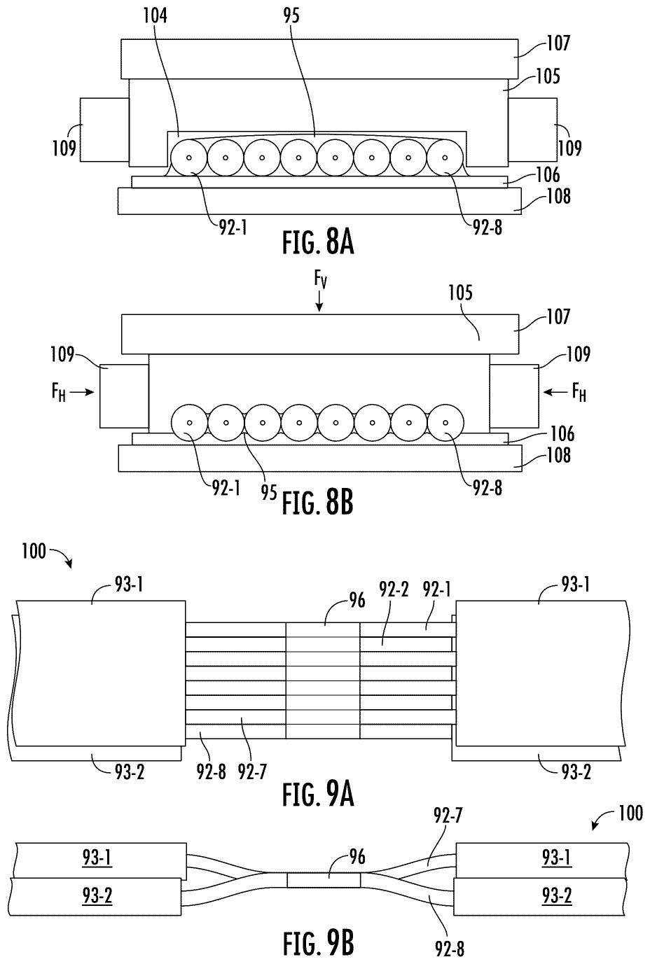

In certain embodiments, deformable pads may be provided around multiple surfaces of an array of stripped optical fibers to displace or prevent accumulation of adhesive material around multiple boundaries (surfaces) of the array. For example, FIG. 8A shows the stripped optical fibers 92-1 to 92-8 (previously shown in FIG. 6C) arranged between (i) a deformable upper pad 105 defining a lower recess 104 and having an associated upper plate 107, (ii) side pushers 109 arranged proximate to the upper pad 105, and (iii) a deformable lower pad 106 having an associated precision flatness lower plate 108, with adhesive material 95 applied to the stripped optical fibers 92-1 to 92-8, with the pads 105, 106 shown in an uncompressed state. FIG. 8B shows the foregoing items (including the upper plate 107, upper pad 105, lower pad 106, lower plate 108, and side pushers 109, all being part of a joining fixture) following application of a vertical force Fv to exert compressive pressure between the upper and lower plates 107, 108 application of a horizontal force FH to exert compressive pressure between the side pushers 109, to compress the upper pad 105 in both vertical and lateral directions and to compress the lower pad 106 in a vertical direction. Such action causes the stripped optical fibers 92-1 to 92-8 to be squeezed between the pads 105, 106 in multiple directions, thereby displacing excess adhesive material 95 (or preventing addition of excess adhesive material), and ensuring that the adhesive material 95 remains below tangential planes extending along adjacent stripped optical fibers 92-1 to 92-8. Avoiding excess adhesive material around a perimeter of the contacting stripped optical fibers 92-1 to 92-8 ensures that aggregate cross-sectional dimensions (e.g., aggregate height and aggregate width) a resulting adhered group of stripped optical fibers 92-1 to 92-8 are defined by dimensions of the stripped optical fibers 92-1 to 92-8.

FIGS. 9A and 9B are top plan and side elevational views, respectively, of the stacked window stripped optical ribbons 90-1, 90-2 to form a first fiber group 100 with an adhered central portion 96 of interdigitated stripped optical fibers 92-1 to 92-8. The adhered central portion 96 comprises optical fibers 92-1 to 92-8 contacting one another in a 1×8 array, while an unstripped portion 93-1, 93-2 of each ribbons 90-1, 90-2 contains optical fibers (not shown) 1×4 array. Additionally, FIGS. 7A to 9B show interdigitation of arrays where the optical fiber pitch or center-to-center spacing in the unstripped portion 93-1, 93-2 of each ribbons 90-1, 90-2 is approximately equal to twice the optical fiber cladding diameter. In certain embodiments, the optical fiber pitch may be larger or less than twice the optical fiber cladding diameter, leading to bending of the optical fibers in the top plan views in addition to the bending visible in the side elevational views

Although various preceding figures (e.g., FIGS. 7A to 9B) show formation of an adhered interdigitated 1×8 array of stripped optical fibers from two four-fiber ribbons, it is to be appreciated that a non-interdigitated, adhered one-dimensional array of stripped optical fibers may be formed from a single multi-fiber ribbon, and any suitable number of optical fibers may be provided in an interdigitated or non-interdigitated adhered one-dimensional array of stripped optical fibers.

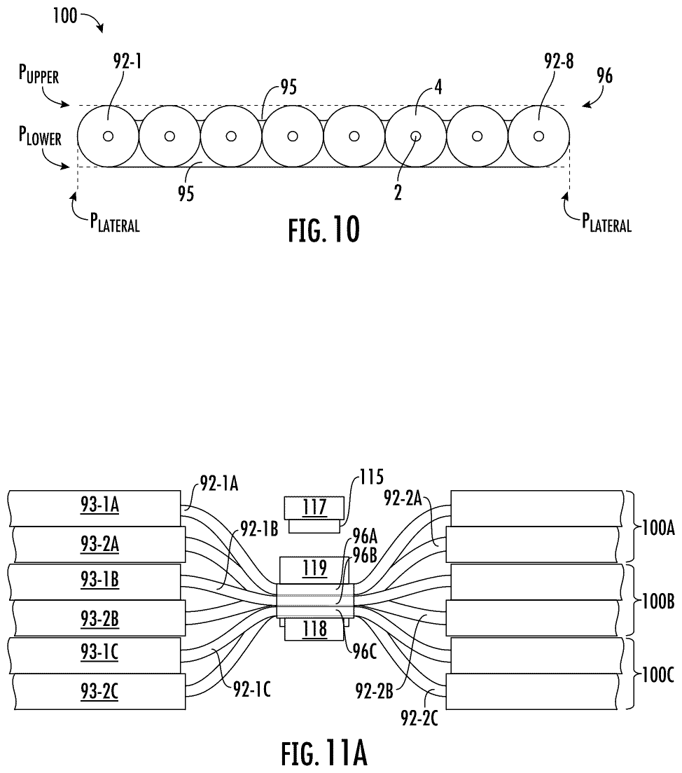

FIG. 10 is a cross-sectional view of an adhered central portion 96 of the first fiber group 100 of interdigitated stripped optical fibers 92-1 to 92-8 configured in a 1×8 array. Each stripped optical fiber 92-1 to 92-8 includes a glass core 2 surrounded by glass cladding 4. The 1×8 array includes adhesive material 95 between optical fibers 92-1 to 92-8 that is substantially flush with a lower datum plane (P_{LOWER}) of the optical fibers 92-1 to 92-8, and that is recessed relative to an upper datum plane (P_{UPPER}) of the optical fibers 92-1 to 92-8. The lower datum plane (P_{LOWER}) corresponds to a lower tangential plane extending along a lower boundary of adjacent optical fibers 92-1 to 92-8, while the upper datum plane (P_{UPPER}) corresponds to an upper tangential plane extending along an upper boundary of adjacent of the optical fibers 92-1 to 92-8. Lateral boundaries of endmost optical fibers 92-1 and 92-8 are arranged along lateral datum planes (P_{LATERAL}) that extend perpendicular to the upper datum plane (P_{UPPER}) and the lower datum plane (P_{LOWER}). The adhesive material 95 is substantially flush with lowermost boundaries of the optical fibers 92-1 to 92-8, which remain exposed. Providing adhesive material that is recessed relative to a datum plane (e.g., as shown for the adhesive material 95 relative to the upper datum plane (P_{UPPER})) provides interstitial space between fiber groups for receiving inter-group adhesive material when such groups are stacked relative to one another. Since the adhesive material 95 does not extend beyond any of the datum planes shown in FIG. 10, the adhered central portion 96 of the first fiber group 100 (embodying a one-dimensional array) may be replicated, stacked, and adhered to form a two-dimensional array of stripped optical fibers (as described hereinafter), with direct contact between adjacent optical fibers both within and between respective fiber groups, to provide precise and repeatable spacing between fiber cores owing to the precise controlled diameters of glass optical fibers. This permits a two-dimensional array of stripped optical fibers to be integrated into high-density fiber optic connectors, in which perimeter external surfaces of a 2D fiber array are used as datum surfaces for alignment structures for 2D fiber array connector mating, without requiring use of ferrules.

Having described fabrication of a single fiber group 100 (as shown in FIGS. 9A-9B and 10), fabrication of a 2D fiber array including multiple fiber groups will now be described. Briefly, multiple fiber groups may be stacked together in a suitable joining fixture, pressed or squeezed together (preferably in multiple directions simultaneously), and adhered to one another using adhesive material. Adhesive material may be applied between successive fiber groups (i.e., 1D fiber arrays), or may be applied over a stack of fiber groups in a single step, so that the adhesive wicks to fill gaps between fiber groups. In certain embodiments, a joining fixture may utilize one or more deformable pads around peripheral surfaces of a 2D fiber array to displace excess adhesive material and/or prevent addition of adhesive material outside of inter-fiber regions arranged below tangential planes extending along outermost points of adjacent optical fibers along outer surfaces of the 2D fiber array, noting that each deformable pad should be positioned opposite a precision flat plate, and not another deformable pad, so that fibers in the 2D fiber array are precisely aligned to one another.

Various methods may be performed to adhered stripped optical fibers when forming adhered 1D fiber arrays and/or adhered 2D fiber arrays. In certain embodiments, 1D fiber arrays can be spray-coated, dip-coated or inkjet printed to provide thin layers of adhesive that will not flow extensively to fill gaps between fibers in 1D or 2D arrays. In certain embodiments, stripped fibers may be coated with nano-metal particles that can be sintered via laser, thermal, or microwave heating processes to serve as an adhesive to join optical fibers together. Depending on how a 2D fiber array is configured (e.g., in a square or hexagonal packing configuration), in certain embodiments, adhesive may be applied on less than all fibers (e.g., on every other fiber) while still achieving adhesive bonding between all fibers of the 2D fiber array.

FIG. 11A is a side elevational view of three stacked fiber groups 100A-100C, each according to the fiber group 100 previously described in connection with FIGS. 9A-9B and FIG. 10. Each fiber group 100A-100C includes eight interdigitated stripped optical fibers (with only fibers 92-1A, 92-2A, 92-1B, 92-2B, 92-1C, 92-2C being visible), includes an adhered central portion 96A, 96B, 96C comprising optical fibers contacting one another in a 1×8 array, and includes unstripped portions 93-1A, 93-2A, 93-1B, 93-2B, 93-1C, 93-2C extending to either side. The adhered central portions 96A-96C of the fiber groups 100A-100C are stacked in contacting relationship and supported by a lower plate 118 of a joining fixture, with a deformable pad 115 supported by an upper plate 117 being superimposed over the stacked adhered central portions 96A-96C, and with two side pushers (wherein only one side pusher 119 is shown, extending behind adhered central portions 96A-96C) arranged to lateral sides of the stack. FIG. 11B shows the items of FIG. 11A following contact of the deformable pad 115 with the uppermost adhered fiber group 96A as part of a step of adhering the three central portions 96A-96C of interdigitated stripped optical fibers to one another with interstitially arranged adhesive (i.e., adhesive provided between optical fibers of the central portions 96A-96C) to form an adhered 2D fiber array 101 (as part of a combination group 102 incorporating the fiber groups 100A-100B). In the adhered 2D fiber array 101, each optical fiber of the central portions 96A-96C is directly contacting multiple other optical fibers, without adhesive material protruding beyond outermost surface of optical fibers of the central portions 96A-96C at a perimeter of the adhered 2D fiber array 101.

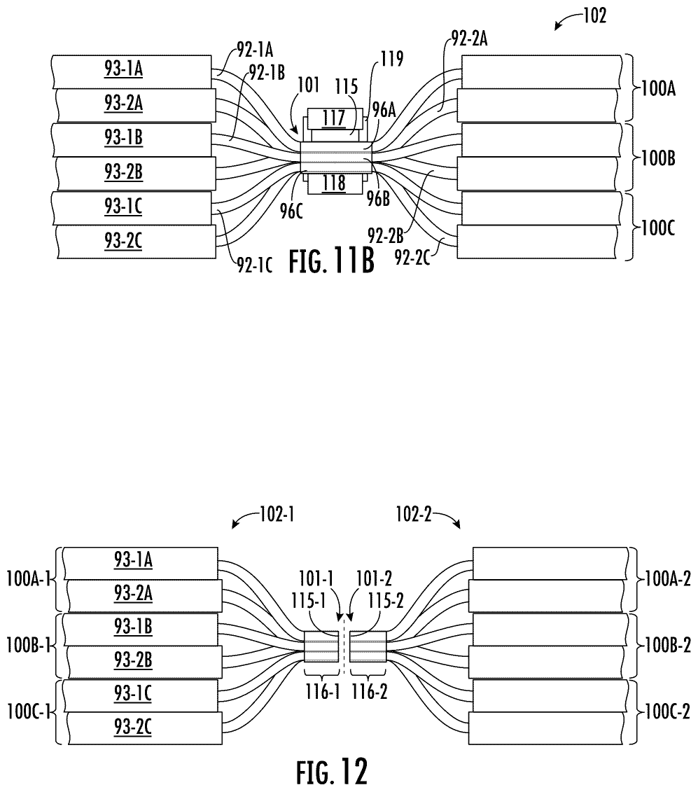

Referring to FIG. 12, after formation of the adhered 2D fiber array 101 of the combination group 102 (shown in FIG. 11B), the adhered 2D fiber array 101 may be sawed or cut (e.g., by laser cutting) in a direction non-parallel to longitudinal axes of optical fibers therein, to form two combination group portions 102-1, 102-2 each including an adhered end portion 116-1, 116-2 (with each adhered end portion 116-1, 116-2 embodying a cut half of the adhered central portions 96A-96C shown in FIG. 11B). Each adhered end portion 116-1, 116-2 includes an adhered 2D fiber array 101-1, 101-2 with an end face 115-1, 115-2 where ends of multiple optical fibers are exposed. For example, the sawed or cut face may be perpendicular to the fiber axes or tilted by 8° away from perpendicular to minimize optical back-reflections at the sawed or cut face

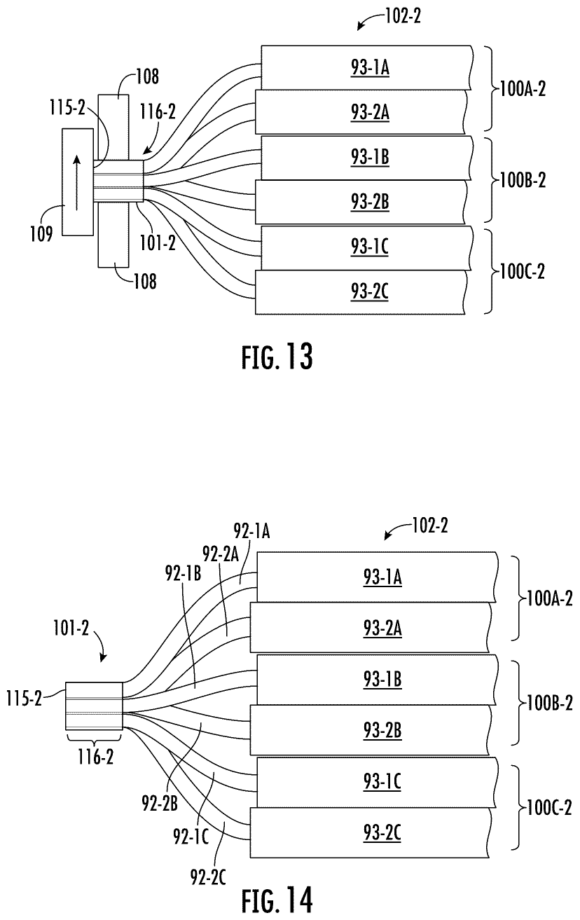

Following formation of the combination group portions 102-1, 102-2 each having an adhered 2D fiber array 101-1, 101-2, the end faces 115-1, 115-2 may be polished. FIG. 13 is a side elevational view of one combination group portion 102-2 of FIG. 12, with an adhered end portion 116-2 thereof positioned in a polishing apparatus (including holder 108 and polishing wheel 109) to enable groupwise polishing of cut end faces 115-2 of optical fibers of the adhered 2D fiber array 101-2. Thereafter, the end-polished combination group portion 102-2 may be removed from the holder 108 and polishing wheel 109. FIG. 14 shows the resulting end-polished combination group portion 102-2 having an adhered end portion 116-2 with an adhered 2D fiber array 101-2 and a polished end face 115-2, with the 2D fiber array embodying adhered stripped optical fibers (incorporating stripped regions 92-1A, 92-2A, 92-1B, 92-2B, 92-1C, 92-2C as shown) extending to unstripped regions 93-1A, 93-2A, 93-1B, 93-2B, 93-1C, 93-2C.

Although FIG. 13 shows polishing of an end face of a previously adhered 2D fiber array 101-2, in certain embodiments, an adhered one-dimensional fiber array (which may or may not embody include interdigitated fibers) may be produced from one or more window stripped optical fiber ribbons, and optical fibers of the adhered one-dimensional fiber array may be cleaved. Thereafter, adhered end portions of several one-dimensional (1D) fiber arrays may be stacked on top of one another and placed into an alignment fixture including an upper plate, a lower plate, an end face plate, and side plates, wherein the cleaved ends of the stacked 1D fiber arrays may be aligned by positioning against the end face plate (which is perpendicular to the upper, lower, and side plates), and the stacked, individually adhered 1D fiber arrays may be adhered to one another while being pressed or squeezed between the upper, lower, and side plates to form an adhered 2D fiber array. An advantage of this approach is that it can be easily used to create 2D fiber arrays with a reduced end face quality, wherein array end faces may be covered with an index-matched fluid or adhesive to accommodate reduced smoothness of the end faces while still providing sufficient optical coupling.

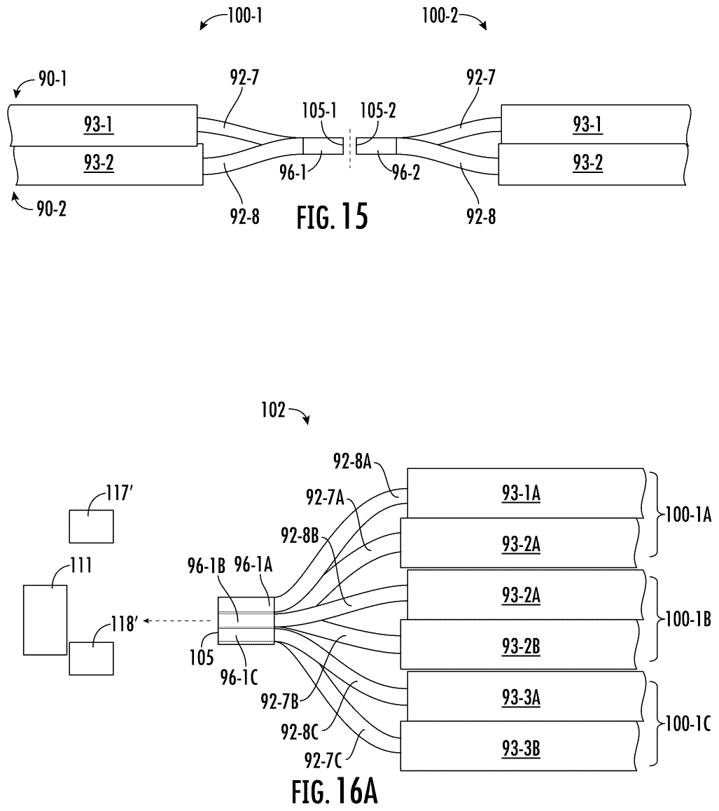

FIG. 15 is a side elevational view of a stacked pair of window stripped ribbons 90-1, 90-2 including unstripped portions 93-1, 93-2 and stripped portions (e.g., 92-7, 92-8) that form a combined group of adhered interdigitated stripped optical fibers configured in a 1×8 array, following cleaving of an adhered region to form fiber groups 100-1, 100-2 each having an adhered end portion 96-1, 96-2. Although only two stripped fibers 92-7 and 92-8 are shown in the side elevational view, it is to be appreciated that eight stripped optical fibers are present in each fiber group 100-1, 100-2, arranged in a 1×8 array. Cleaving may be performed via a laser, or by traditional scoring and cleaving, as known in the art. If cleaved end faces 105-1, 105-2 of optical fibers at the adhered end portions 96-1, 96-2 are insufficiently smooth, then they can be polished (e.g., laser polished, or polishing on a polishing wheel) before multiple fiber groups are joined together to form a 2D fiber array.

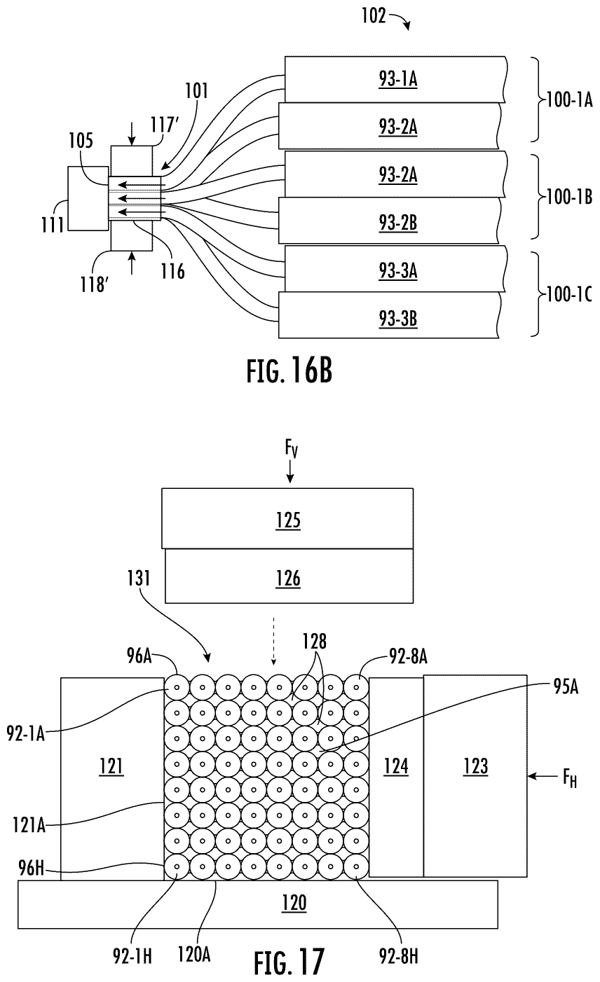

FIG. 16A is a side elevational view of three fiber groups 100-1A to 100-1C, each produced in accordance with FIG. 15, with individually adhered end portions 96-1A to 96-1C being stacked together and arranged proximate to a joining fixture that includes an upper plate 117′, a lower plate 118′, an end face plate 111, and side pushers (not shown). Each fiber group 100-1A to 100-1C includes an unstripped region 93-1A, 93-1B, 93-2A, 93-2B, 93-3A, 93-3B, and includes a stripped region having eight optical fibers (with only 92-7A, 92-8A, 92-7B, 92-8B, 92-7C, 92-8C being shown), wherein each individually adhered end portion 96-1A to 96-1C includes adhered stripped optical fibers arranged in a 1×8 array. In preparation for joining the fiber groups 100-1A to 100-1C to one another, end faces 105 of the stripped optical fibers may be aligned with one another and positioned against the end face plate 111, while stacked end portions 96-1A to 96-1C may be received between the upper plate 117′, the lower plate 118′, and side pushers (not shown). FIG. 16B shows the items of FIG. 16A, following positioning of cleaved end faces 105 against the end face plate 111 and compression of the upper and lower plates 117′, 118′ around the stacked end portions 96-1A to 96-1C (labeled in FIG. 16A), to permit the stacked end portions to be adhered to one another with interstitially arranged adhesive to form an adhered end portion 116 including an adhered 2D fiber array 101. The resulting combination group 102 incorporating the fiber groups 100-1A to 100-1C and the adhered 2D fiber array 101 may be removed from the joining fixture (including the end face plate 111, upper plate 117′, the lower plate 118′, and side pushers (not shown)) for further processing and/or use, such as to be incorporated in an of various fiber optic cable assemblies as described herein.

Various joining fixtures and methods may be used to promote stacking of multiple separately adhered 1D fiber arrays and to permit stacked 1D fiber arrays to be adhered to one another to form an adhered 2D fiber array, with optical fibers in square packed or hexagonal packed configurations. Any suitable number of multiple optical fibers may be adhered to form an adhered 1D fiber array, and any suitable number of 1D fiber arrays may be joined to form an adhered 2D fiber array. In certain embodiments, multiple individually adhered 2D fiber arrays may also be combined to form a larger adhered 2D fiber array, optionally including one or more fiber-free areas within an interior of the larger adhered 2D fiber array.

FIG. 17 is a cross-sectional view of eight stacked individually adhered grouped end portions 96A-96H (which may be referred to hereinafter as “fiber groups 96A-96H”) of stripped optical fibers (i.e., from uppermost stripped fibers 92-1A to 92-8A to lowermost stripped fibers 92-1H to 92-8H, with each fiber group 96A-96H configured in 1×8 array), arranged within a joining fixture that includes a lower alignment block 120, one (left) side alignment block 121, a deformable (right) side pad 124 having an associated side pusher 123, and a deformable upper pad 126 having an associated upper pusher 125. The lower alignment block 120 includes a precision flatness surface 120A, and the side alignment block includes a precision flatness surface 121A. The precision flatness surfaces 120A, 121A may include a surface roughness well below 1 μm, and may include, for example, a precision diamond turned flat surface, or a precision ground fusion glass block. In certain embodiments, the precision flatness surfaces 120A, 121A may be coated with a non-stick coating to prevent adhesive from bonding thereto. FIG. 17 shows the upper pad 126 and upper pusher 125 superimposed above the remaining items, in a state prior to the upper pad 126 contacting the uppermost group 96A of adhered stripped optical fibers. Adhesive 95A may be applied between fiber groups 96A-96H, or over the fiber groups 96A-96H in combination, to permit the eight stacked groups of stripped optical fibers 96A-96H to be adhered to one another with adhesive remaining in interstitial areas 128 between fiber groups 96A-96H. In use, the upper pusher 125 and associated upper pad 126 are pressed downward (by application of a vertical force Fv) to contact fibers 92-1A to 92-8A of the uppermost fiber group 96A, and the side pusher 123 and associated side pad 124 are pressed laterally (by application of a horizontal force FH) to contact rightmost fibers 92-8A to 92-8H to promote direct contact between all optical fibers (i.e., from uppermost stripped fibers 92-1A to 92-8A to lowermost stripped fibers 92-1H to 92-8H) and adhesive material in interstitial areas 128 is cured to form an adhered 2D optical fiber array 131 with fibers arranged in an 8×8 array with rectangular packing. The resulting adhered 2D optical fiber array 131 may thereafter be removed from the fixture for further processing and/or use, wherein all four peripheral sides of the adhered 2D optical fiber array 131 may be used as datum surfaces for use in subsequent passive alignment of the adhered 2D optical fiber array 131 to other precision surfaces.

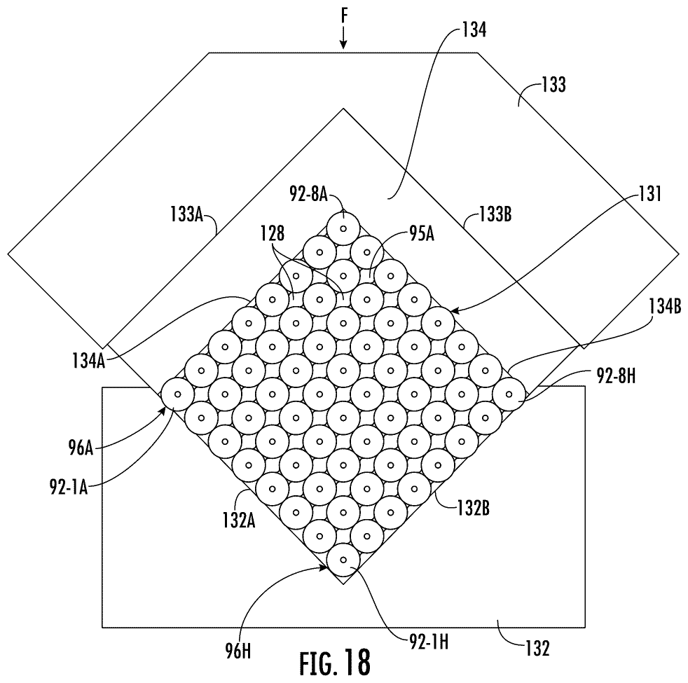

In certain embodiments, a joining fixture may include an alignment block configured to receive (and align) two adjacent sides of a 2D array of optical fibers, and a pusher and associated pad may be arranged to simultaneously press on two other adjacent sides of the 2D array, as part of a step of forming an adhered 2D optical fiber array. For example, FIG. 18 shows eight stacked individually adhered groups 96A-96H of stripped optical fibers (i.e., from uppermost stripped fibers 92-1A to 92-8A to lowermost stripped fibers 92-1H to 92-8H, with each fiber group 96A-96H configured in 1×8 array), arranged within a joining fixture that includes a lower alignment block 132 having orthogonally arranged first and second (precision flatness) alignment surfaces 132A, 132B, a V-shaped deformable pad 134 having orthogonally arranged surfaces 134A, 134B, and an upper pusher 133 having orthogonally arranged pushing surfaces 133A, 133B. The alignment surfaces 132A, 132B may include a surface roughness well below 1 μm, and may be diamond turned from the same piece of material (e.g., precision ground fusion glass block). In certain embodiments, the alignment surfaces 132A, 132B may be coated with a non-stick coating to prevent adhesive from bonding thereto. Adhesive 95A may be applied between fiber groups 96A-96H, or over the fiber groups 96A-96H in combination, to permit the eight stacked groups of stripped optical fibers 96A-96H to be adhered to one another with adhesive remaining in interstitial areas 128 between fiber groups 96A-96H. In use, the upper pusher 133 and associated upper pad 134 are pressed downward (by application of force F) so that upper pad 134 contacts fibers 92-1A to 92-8A, as well as fibers 92-8A to 92-8H, to promote direct contact between all optical fibers (i.e., from stripped fibers 92-1A to 92-8A through stripped fibers 92-1H to 92-8H) and adhesive material in interstitial areas 128 is cured to form an adhered 2D optical fiber array 131 with fibers arranged in an 8×8 array. The resulting adhered 2D optical fiber array 131 may thereafter be removed from the fixture for further processing and/or use, wherein all four peripheral sides of the adhered 2D optical fiber array 131 may be used as datum surfaces for use in subsequent passive alignment of the adhered 2D optical fiber array 131 to other precision surfaces.

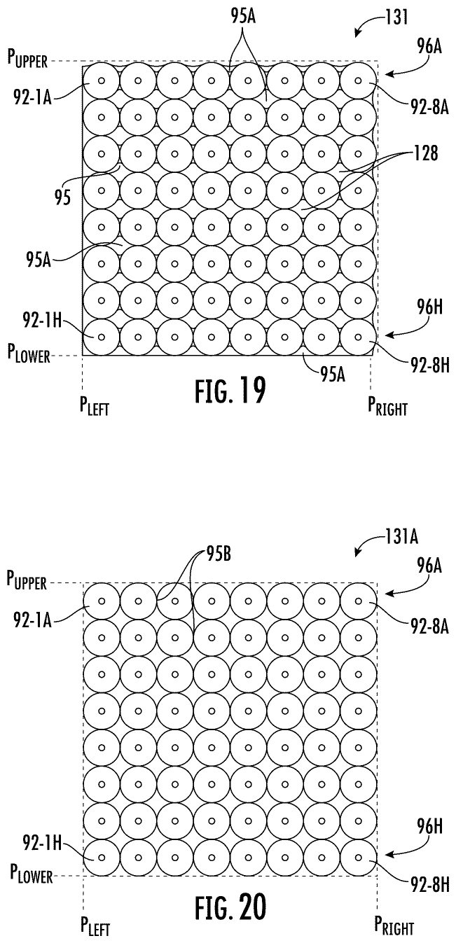

FIG. 19 is a cross-sectional view of an adhered 2D optical fiber array 131 including adhered groups 96A-96H of stripped optical fibers (i.e., from uppermost stripped fibers 92-1A to 92-8A to lowermost stripped fibers 92-1H to 92-8H joined within groups 96A-96H using adhesive 95) that are joined with adhesive 95A in interstitial areas 128 to form a rectangular packed 8×8 array. Peripheral fibers define four datum planes (P_{UPPER}, P_{LOWER}, P_{LEFT}, P_{RIGHT}), wherein adhesive material 95A is substantially flush with outermost points of stripped fibers 92-1A to 92-1H at the left datum plane P_{LEFT}, and at outermost points of stripped fibers 92-1H to 92-8H at the lower datum plane P_{LOWER}, and wherein adhesive material 95A is recessed relative to outermost points of stripped fibers 92-1A to 92-8A below upper datum plane P_{UPPER}, and at outermost points of stripped fibers 92-8A to 92-8H to the left of right datum plane P_{RIGHT}. The adhered 2D optical fiber array 131 may be produced using the joining fixtures shown in FIG. 17 or 18, with recessed adhesive material 95A along two datum planes P_{UPPER} and P_{RIGHT} being attributable to the incursion of deformable pads into spaces between fibers during a compression or squeezing step. Since the adhesive material 95A does not extend beyond any of the datum planes (P_{UPPER}, P_{LOWER}, P_{LEFT}, P_{RIGHT}) shown in FIG. 19, each peripheral side of the adhered 2D fiber array 131 embodies a datum surfaces that may be used in subsequent passive alignment of the adhered 2D optical fiber array 131 to other precision surfaces.

FIG. 20 is a cross-sectional view of an adhered 2D optical fiber array 131A including adhered groups 96A-96H of stripped optical fibers (i.e., from uppermost stripped fibers 92-1A to 92-8A to lowermost stripped fibers 92-1H to 92-8H) that are joined with adhesive 95B solely at contact points between fibers to form a rectangular packed 8×8 array. Peripheral fibers define four datum planes (P_{UPPER}, P_{LOWER}, P_{LEFT}, P_{RIGHT}). The adhered 2D optical fiber array 131 may be produced using the joining fixtures shown in FIG. 17 or 18, with selective application of adhesive material solely at or near contact points between adjacent fibers (e.g., by adhesive inkjet printing, nanoparticulate patterning followed by sintering, or the like). Since all fibers of the array 131 are contacting one another, and outermost surfaces of peripheral fibers (i.e., 92-1A to 92-8A, 92-8A to 92-8H, 92-1A to 92-1H, and 92-1H to 92-8H) are devoid of adhesive, each peripheral side of the adhered 2D fiber array 131 embodies a datum surfaces that may be used in subsequent passive alignment of the adhered 2D optical fiber array 131 to other precision surfaces.

One issue that may arise when using packed 2D arrays of stripped optical fibers as datum surfaces in fiber optic connectors and the like, particularly without the presence of conventional ferrules for retaining and protecting stripped regions of glass fibers, is that glass cladding surfaces may be subjected to mechanical damage (e.g., scraping, abrasion, etc.). To mitigate this issue, in certain embodiments, one or more stripped optical fibers of an adhered 2D fiber array may include enhanced hardness outer surfaces to provide enhanced durability. Such enhanced hardness surfaces may be fabricated using chemically strengthened or coated glass cladding surfaces that are less likely to be scraped or damaged when subjected to contact with other surfaces (e.g., within or between fiber optic connectors). In certain embodiments, an enhanced hardness outer surface of, or on, an outer surface of glass cladding has a hardness at least 20%, at least 30%, at least 40%, at least 50%, or at least 100% greater than a hardness of a remaining internal portion of the glass cladding material. In certain embodiments, some (e.g., peripheral) or all optical fibers of an adhered 2D fiber array may embody titania-clad (e.g., aluminum titanate clad) optical fibers, such as Corning® Titan® (commercially available from Corning, Inc. (Corning, New York, US)). In certain embodiments, enhanced hardness optical fibers along a periphery of an adhered 2D fiber array may include optical cores configured for transmission of optical signals, whereas in other embodiments, enhanced hardness optical fibers along a periphery of an adhered 2D fiber array may embody mere glass rods (without optical cores configured for transmission of optical signals) that serve a sole purpose of protecting an exterior of an adhered 2D fiber array. If an enhanced hardness cladding surface is applied to (e.g., deposited on) one or more optical fibers (whether throughout an entirety of an adhered 2D fiber array, or solely along a perimeter thereof), in certain embodiments enhanced hardness cladding is highly uniform and has a thickness of less than 20 nm, less than 10 nm, less than 5 nm, or less than 2 nm. In certain embodiments, an entire length of optical fiber (including stripped and unstripped portions thereof) is pre-fabricated with enhanced hardness material along an outer portion of glass cladding. In certain embodiments, an enhanced hardness material is provided (whether by chemical treatment, physical treatment, and/or material deposition) only on stripped portions of an optical fiber, after a stripping process is performed. Whether or not an enhanced hardness cladding surface is deposited or otherwise present on some or all stripped optical fibers in an adhered 2D fiber array, in certain embodiments, an end face of each stripped fiber in such an array is positioned no greater than 0.5 μm, no greater than 0.2 μm, or no greater than 0.1 μm from a target position, to promote reliable alignment and optical coupling in fiber-to-fiber connections incorporating adhered 2D fiber arrays as disclosed herein.

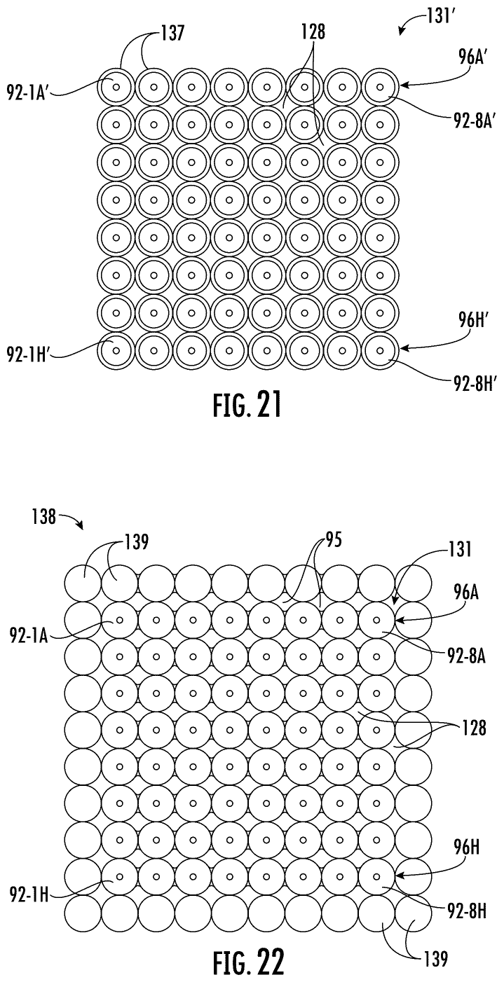

FIG. 21 is a cross-sectional view of an adhered 2D (8×8) optical fiber array 131′ arranged with rectangular packing, with each optical fiber (within adhered groups 96A′-96H′ of stripped optical fibers, from uppermost stripped fibers 92-1A′ to 92-8A′ to lowermost stripped fibers 92-1H′ to 92-8H′) having a durable, enhanced hardness material 137 (optionally embodying a deposited material) along an outer surface thereof. Optical fibers (i.e., from uppermost stripped fibers 92-1A′ to 92-8A′ to lowermost stripped fibers 92-1H′ to 92-8H′) of the 2D optical fiber array 131′ may be adhered to one another using adhesive arranged in interstitial areas 128 between adjacent fibers, or solely at contact points between adjacent stripped fibers.

FIG. 22 is a cross-sectional view of an adhered 2D optical fiber array 138, in which perimeter fibers 139 have a durable, enhanced hardness material along outer surfaces thereof, while interior fibers of the array lack enhanced hardness outer surfaces. An interior (8×8) array portion 131 includes groups 96A-96H of stripped optical fibers (adhered with intra-group adhesive material 95), from uppermost stripped fibers 92-1A to 92-8A to lowermost stripped fibers 92-1H to 92-8H, with the interior array portion 131 being surrounded by perimeter fibers 139 to form a 10×10 array 138. In certain embodiments, the perimeter fibers 139 may include optical cores configured for transmission of optical signals; in other embodiments, the perimeter fibers 139 may be devoid of optical cores and merely serve as precision thickness glass rods to protect the interior (8×8) array portion 131. Optical fibers of the interior array portion 131 and/or the peripheral fibers may be adhered to one another using adhesive arranged in interstitial areas 128 between adjacent fibers, or solely at contact points between adjacent fibers.

Various preceding embodiments have illustrated adhered 2D optical fiber arrays with fibers arranged in rectangular packed configuration, but the present disclosure encompasses any suitable packing type, including hexagonal packing, mixed rectangular-hexagonal packing, and other packing configuration. In certain embodiments, different rows in an adhered 2D optical fiber array may have the same number of stripped optical fibers, or different rows may have different numbers of optical fibers.

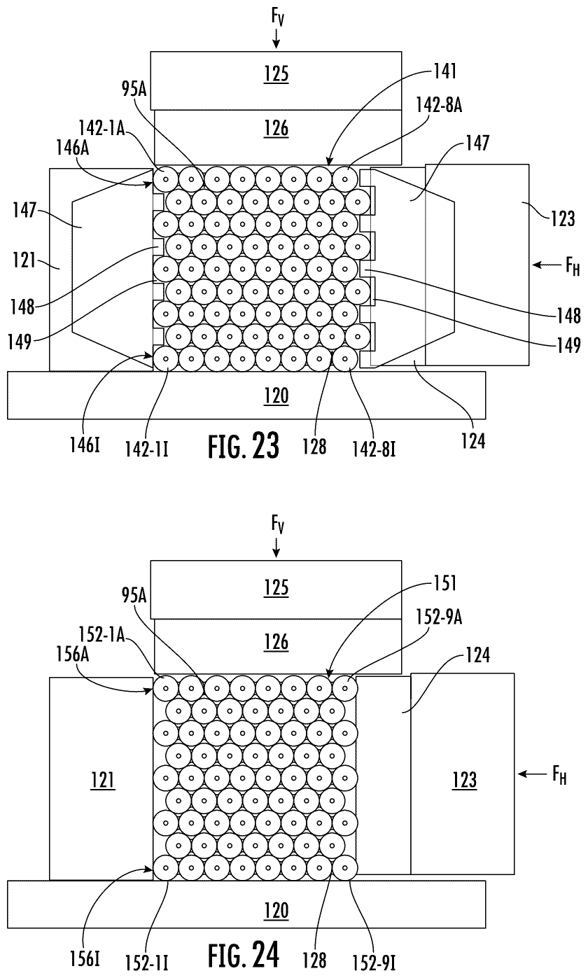

FIG. 23 is a cross-sectional view of a nine stacked individually adhered fiber groups 146A-146I of stripped optical fibers (i.e., from uppermost stripped fibers 142-1A to 142-9A to lowermost stripped fibers 142-1I to 142-9I, with each fiber group 146A-146I configured in a 1×8 array), arranged within a joining fixture configured to produce an adhered 9×8 optical fiber array with hexagonal packing. The joining fixture includes a lower alignment block 120, one (left) side alignment block 121, a deformable (right) side pad 124 having an associated side pusher 123, and a deformable upper pad 126 having an associated upper pusher 125. The alignment fixture further includes left and right guides 147 each having alternating grooves 149 and protrusions 148, with the grooves 149 each configured to receive one stripped fiber per fiber group 146A-146I. The left and right guides 147 may be offset (to the front and/or rear) of the side alignment block 121 and the side pusher 123, and may be used to maintain packing between the fiber groups 146A-146I. Adhesive 95A may be applied between fiber groups 146A-146H, or over the fiber groups 146A-146H in combination, to permit the eight stacked groups of stripped optical fibers 146A-146H to be adhered to one another with adhesive remaining in interstitial areas 128 between fiber groups 146A-146H. In use, the upper pusher 125 and associated upper pad 126 are pressed downward (by application of a vertical force Fv) to contact fibers 142-1A to 142-8A of the uppermost fiber group 146A, and the side pusher 123 and associated side pad 124 are pressed laterally (by application of a horizontal force FH) to contact rightmost fibers 142-8A to 142-8H to promote direct contact between all optical fibers (i.e., from uppermost stripped fibers 142-1A to 142-8A to lowermost stripped fibers 142-1H to 142-8H) and adhesive material in interstitial areas 128 is cured to form an adhered 2D optical fiber array 141 with fibers arranged in an 8×8 array with hexagonal packing. The resulting adhered 2D optical fiber array 141 may thereafter be removed from the fixture for further processing and/or use.

FIG. 24 is a cross-sectional view of nine stacked individually adhered groups of optical fibers, including alternating groups of stripped optical fibers configured in 1×9 and 1×8 arrays, from uppermost stripped fibers 152-1A to 152-9A to lowermost stripped fibers 152-1I to 152-9I, arranged within a joining fixture configured to produce an adhered two-dimensional optical fiber array with hexagonal packing. The joining fixture includes a lower alignment block 120, one (left) side alignment block 121, a deformable (right) side pad 124 having an associated side pusher 123, and a deformable upper pad 126 having an associated upper pusher 125. Adhesive 95A may be applied between fiber groups 156A-156I, or over the fiber groups 156A-156I in combination, to permit the nine stacked groups of stripped optical fibers 156A-156I to be adhered to one another with adhesive remaining in interstitial areas 128 between fiber groups 156A-156I. In use, the upper pusher 125 and associated upper pad 126 are pressed downward (by application of a vertical force Fv) to contact fibers 152-1A to 152-9A of the uppermost fiber group 156A, and the side pusher 123 and associated side pad 124 are pressed laterally (by application of a horizontal force FH) to contact rightmost fibers 152-8A to 152-9I to promote direct contact between all optical fibers (i.e., from uppermost stripped fibers 152-1A to 152-9A to lowermost stripped fibers 152-1H to 152-9I and adhesive material 95A in interstitial areas 128 is cured to form an adhered 2D optical fiber array 151 with fibers arranged in a 2D array with hexagonal packing. The resulting adhered 2D optical fiber array 151 may thereafter be removed from the fixture for further processing and/or use.

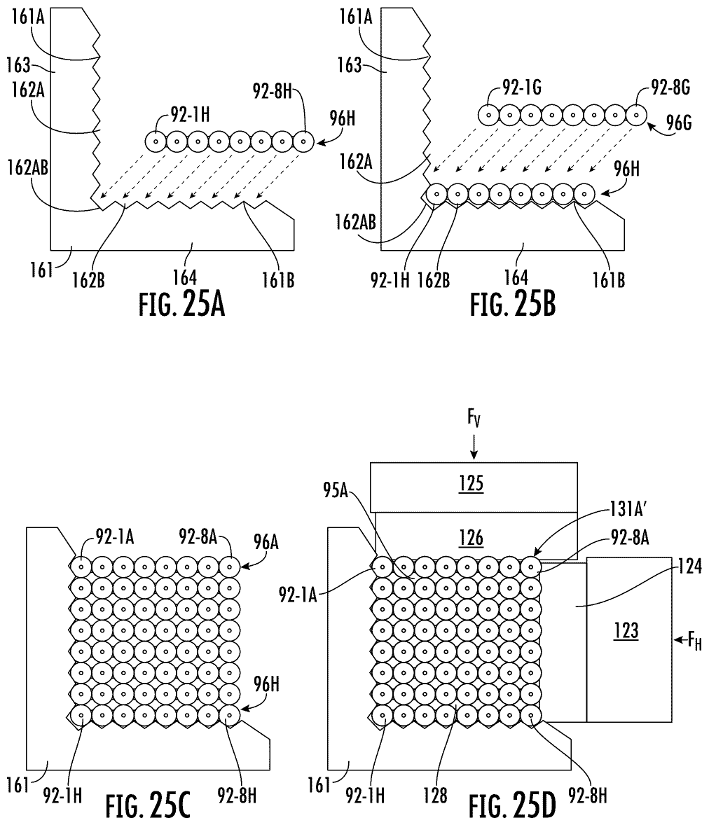

In certain embodiments, a joining fixture may include one or more alignment blocks with grooves and/or protrusions configured to promote a desired alignment between fiber groups, wherein the protrusions may further be used to prevent incursion of adhesive material in selected areas between peripheral fibers of an optical fiber array. An example of such an alignment block is shown in FIGS. 25A-25D.

FIG. 25A is a cross-sectional view of an L-shaped alignment block 161 having V-grooves (including alternating grooves 162A and protrusions 161A) defined in a left wall 163 and having V-grooves (including alternating grooves 162B and protrusions 161B) defined in a bottom wall 164 thereof, with a corner groove 162AB provided at an intersection between the walls 163, 164. FIG. 25A further shows a superimposed first group 96H of stripped optical fibers 92-1H to 92-8H configured in a 1×8 array, about to be received by the alignment block 161. FIG. 25B shows the items of FIG. 25A, with the stripped optical fibers 92-1H to 92-8H of the first fiber group 96H received by the protrusions 161B of the bottom wall 164 (including reception of the leftmost fiber 92-1H in the corner groove 162AB), and showing a superimposed second group 96G of stripped optical fibers 92-1G to 92-8G about to be stacked atop the first fiber group 96H, with the leftmost fiber 92-1G to be received in a single groove 162A defined in the left wall 163. FIG. 25C shows the alignment block 161 of FIGS. 25A-25B with stacked eight groups of optical fibers 96A-96H (from uppermost optical fibers 92-1A to 92-8A to lowermost optical fibers 92-1H to 92-8H) received therein. FIG. 25D shows the items of FIG. 25C, with addition of a deformable (right) side pad 124 having an associated side pusher 123, and a deformable upper pad 126 having an associated upper pusher 125. Adhesive 95A may be applied between fiber groups 96A-96H, or over the fiber groups 96A-96H in combination, to permit the eight stacked groups of stripped optical fibers 96A-96H to be adhered to one another with adhesive remaining in interstitial areas 128 between fiber groups 96A-96H. In use, the upper pusher 125 and associated upper pad 126 are pressed downward (by application of a vertical force Fv) to contact fibers 92-1A to 92-8A of the uppermost fiber group 96A, and the side pusher 123 and associated side pad 124 are pressed laterally (by application of a horizontal force FH) to contact rightmost fibers 92-8A to 92-8H to promote direct contact between all optical fibers (i.e., from uppermost stripped fibers 92-1A to 92-8A to lowermost stripped fibers 92-1H to 92-8H) and adhesive material 95A in interstitial areas 128 is cured to form an adhered 2D optical fiber array 131A′ with fibers arranged in a 2D array with square packing. The resulting adhered 2D optical fiber array 131A′ may thereafter be removed from the alignment block, pads 124, 126, and pushers 123, 125 (in combination embodying a joining fixture) for further processing and/or use.

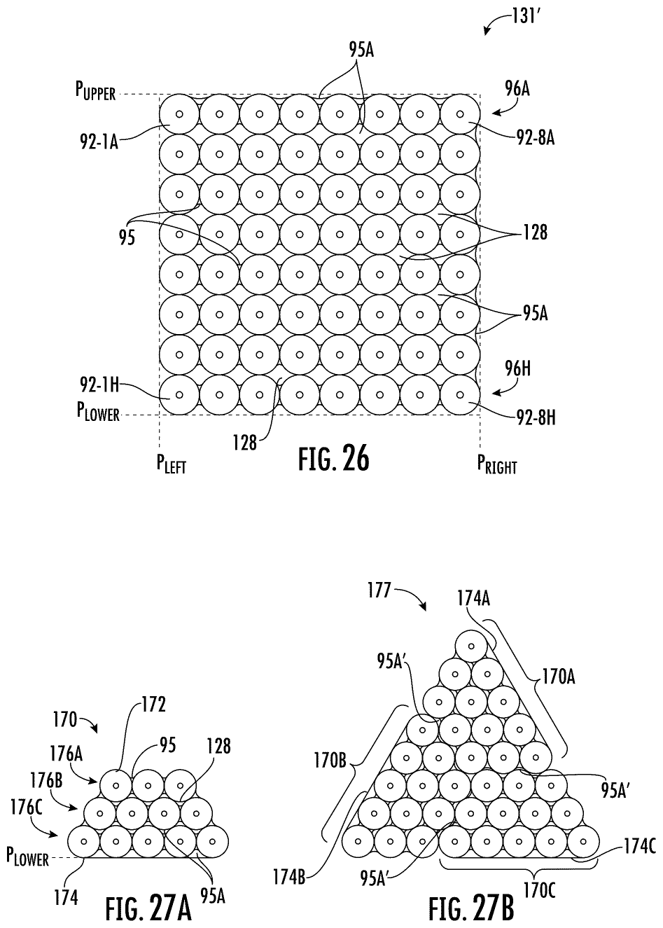

The adhered 2D optical fiber array 131A′ produced in FIG. 25D is shown in greater detail in FIG. 26. Peripheral fibers of the array 131A′ define four datum planes (P_{UPPER}, P_{LOWER}, P_{LEFT}, P_{RIGHT}), wherein adhesive material 95A is recessed but visible relative to outermost points of stripped fibers 92-1A to 92-8A below upper datum plane P_{UPPER}, and recessed but visible relative to outermost points of stripped fibers 92-8A to 92-8H to the left of (or below, if reoriented) right datum plane P_{RIGHT}. Due to usage of the L-shaped alignment block 161 having V-grooves, adhesive material 95A is even further recessed (and not visible) relative outermost points of stripped fibers 92-1A to 92-1H at the left datum plane P_{LEFT}, and relative to outermost points of stripped fibers 92-1H to 92-8H at the lower datum plane P_{LOWER}. Adhesive material 95A remains present in interstitial areas between fibers of the array 131A′.

Although various embodiments herein incorporate 1D fiber arrays into generally rectangular 2D arrays, the present disclosure is not so limited. In certain embodiments, multiple 2D fiber arrays (e.g., non-linear subarrays) of any suitable sizes and cross-sectional shapes (e.g., triangular, oval, hexagonal, round, trapezoidal, regular or non-regular polygonal, etc.) may be incorporated into larger 2D arrays. As one non-limiting example, FIG. 27A shows an adhered non-linear (2D) sub-array 170 of twelve stripped optical fibers 172 in a hexagonal packed configuration, with a first row 176A of three optical fibers, a second row 176B of four optical fiber, and a third row 176C of five optical fibers. A first (e.g., intra-row) adhesive 95 is provided between individual fibers in each row 176A-176C, and a second adhesive 95A (which may be compositionally identical to, or different from, the first adhesive 95) is provided in other areas, include interstitial areas 128 (e.g., between fiber rows 176A-176C) and proximate to (but not extending beyond) outermost surfaces of optical fibers of the third row 176C to provide a substantially flush adhesive surface 174. Since this adhesive surface 174 does not extend beyond outermost datum planes of the optical fibers 172 (including lower datum plane (P_{LOWER})), multiple sub-arrays 170 may be adhered to one another form a larger two-dimensional array of stripped optical fibers with direct contact between adjacent optical fibers both within and between respective sub-arrays 170. FIG. 27B shows an adhered triangular (2D) optical fiber array 177 including eight stripped optical fibers per side, formed from three sub-arrays 170A-170C (each according to the sub-array 170 of FIG. 27A), with adhesive material 95A between sub-arrays 170A-170C, and respective substantially flush adhesive surfaces 174A-174C not extending beyond outermost surfaces of peripheral fibers (provided by fiber groups 176A-176C) of the triangular optical fiber array 177.

In certain embodiments, precisely dimensioned spacers may be provided between 1D arrays of stripped optical fibers within a 2D optical fiber array. In certain embodiments, such spacers may comprise fiber array rafts (i.e., groupings of laterally contacting glass fibers, which may or may not include optical cores, and which may be arranged in parallel or perpendicular to arrays of stripped optical fibers configured to transmit optical data). In certain embodiments, such spacers may comprise precisely dimensioned glass sheets. If provided, spacers may be pre-attached (e.g., adhered) to individual 1D fiber arrays prior to stacking, or multiple sequentially arrayed spacers and 1D fiber arrays may receive adhesive in a single step, such as within a joining fixture.

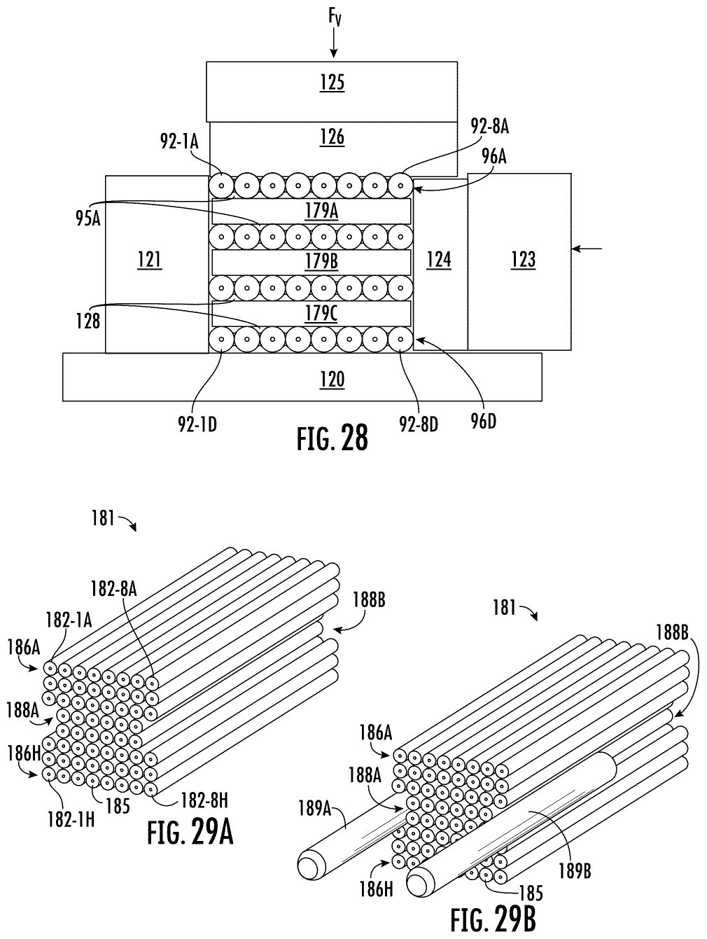

FIG. 28 is a cross-sectional view of a four stacked groups 96A-96D of adhered optical fibers, with each group 96A-96D having stripped optical fibers (from uppermost fibers 92-1A to 92-8A to lowermost fibers 92-1D to 92-8D) configured in a 1×8 array, and with transversely arranged optical fiber array rafts 179A-179C positioned between closest optical fiber groups 96A-96D. The foregoing items are arranged within a joining fixture that includes a lower alignment block 120, one (left) side alignment block 121, a deformable (right) side pad 124 having an associated side pusher 123, and a deformable upper pad 126 having an associated upper pusher 125. Adhesive 95A may be applied to interstitial areas 128 between optical groups 96A-96D and fiber array rafts 179A-179C. In use, the upper pusher 125 and associated upper pad 126 are pressed downward (by application of a vertical force Fv) to contact fibers 92-1A to 92-8A of the uppermost fiber group 96A, and the side pusher 123 and associated side pad 124 are pressed laterally (by application of a horizontal force FH) to contact rightmost fibers 92-8A to 92-8D to promote direct contact between all optical fibers (i.e., from uppermost stripped fibers 92-1A to 92-8A to lowermost stripped fibers 92-1D to 92-8D) and adhesive material 95A in interstitial areas 128 is cured to form an adhered 2D optical fiber array including the fiber groups 96A-96D and spacers 179A-179C, which may thereafter be removed from the fixture for further processing and/or use.

In certain embodiments, 2D fiber arrays may include non-uniform peripheral boundaries (e.g., peripheral involutions and/or peripheral protrusions) to serve as mating locations for alignment structures and/or to serve as keying structures for connector orientation. In certain embodiments, non-uniform peripheral boundaries may be provided along opposing peripheral surfaces of a 2D fiber array. In certain embodiments, non-uniform peripheral boundaries of a single 2D fiber array may include multiple involutions, multiple protrusions, or at least one involution in combination with at least one protrusion. Various different types of alignment structures may be employed with 2D fiber arrays that include non-uniform peripheral boundaries. In certain embodiments, an alignment structure includes multiple (e.g., first and second) alignment pins, which may include tapered ends, and may be fabricated of metal, ceramic, glass, and/or other suitable materials. In certain embodiments, one or more alignment pins may be separated from optical fibers of a 2D optical fiber array by one or more intermediate members (e.g., one or more glass sheets, glass tubes, glass rods, and/or fiber array rafts), with a resulting alignment structure including alignment pins in combination with the one or more intermediate members. In certain embodiments, an alignment structure includes multiple V-shaped blocks (“V-blocks”) that may either contact one or more optical fibers of a 2D fiber array, or be separated from a 2D fiber array by one or more intermediate members (e.g., one or more glass sheets, glass tubes, glass rods, and/or fiber array rafts), with a resulting alignment structure including V-blocks in combination with the one or more intermediate members. V blocks may be fabricated of precision thickness glass or other materials. The foregoing intermediate members may be configured to distribute mechanical stress over multiple optical fibers of an array, and/or prevent mechanical damage (e.g., attributable to scraping or abrasion) of optical fibers of an array. In certain embodiments, some (e.g., peripheral) or all fibers of a 2D fiber array may comprise an enhanced hardness outer surface to reduce the likelihood of damage when contacting one or more alignment structures.

In certain embodiments, a first alignment structure comprises a first glass sheet, a first glass tube, or a first plurality of glass rods arranged between the first alignment pin and end portions of a first subgroup of optical fibers, and a second alignment structure comprises a second glass sheet, a second glass tube, or a second plurality of glass rods arranged between the second alignment pin and end portions of a second subgroup of optical fibers.

In certain embodiments, a first alignment structure comprises a first glass tube arranged between a first alignment pin and end portions of a first subgroup of optical fibers, and the second alignment structure comprises a second glass tube arranged between a second alignment pin and end portions of a second subgroup of optical fibers.

In certain embodiments, a first alignment structure comprises a first glass sheet arranged between a first alignment pin and end portions of a first subgroup of optical fibers, and a second alignment structure comprises a second glass sheet arranged between a second alignment pin and end portions of a second subgroup of optical fibers.

In certain embodiments, a first alignment structure comprises a first glass sheet or a first fiber array raft, and a second alignment structure comprises a second glass sheet or a second fiber array raft. In certain embodiments, a first alignment structure comprises a first V-block, and a second alignment structure comprises a second V-block.

In certain embodiments, an alignment structure comprises a sleeve configured to engage portions of a 2D fiber array, either by direct contact with peripheral fibers of a 2D fiber array, or indirect contact with a 2D fiber array via one or more intermediate structures (e.g., glass plates, glass rods, V-blocks, fiber array rafts, glass tubes, alignment pins, and the like). In certain embodiments, a sleeve may be removable relative to a 2D fiber array and/or a remainder of a 2D fiber array cable assembly. In certain embodiments, a sleeve may be substantially rigid. In certain embodiments, a sleeve may comprise metal, polymeric, or composite material, optionally to provide spring action to apply a biasing force (either directly or indirectly) on or proximate to one or more portions of a 2D fiber array.

In certain embodiments, any of the various alignment structures disclosed herein may be combined in a 2D fiber array connector or 2D fiber array connector combination.

In certain embodiments, a first alignment structure is adhered to end portions of a first subgroup of optical fibers of 2D fiber array, and a second alignment structure is adhered to end portions of a second subgroup of optical fibers of the 2D fiber array.

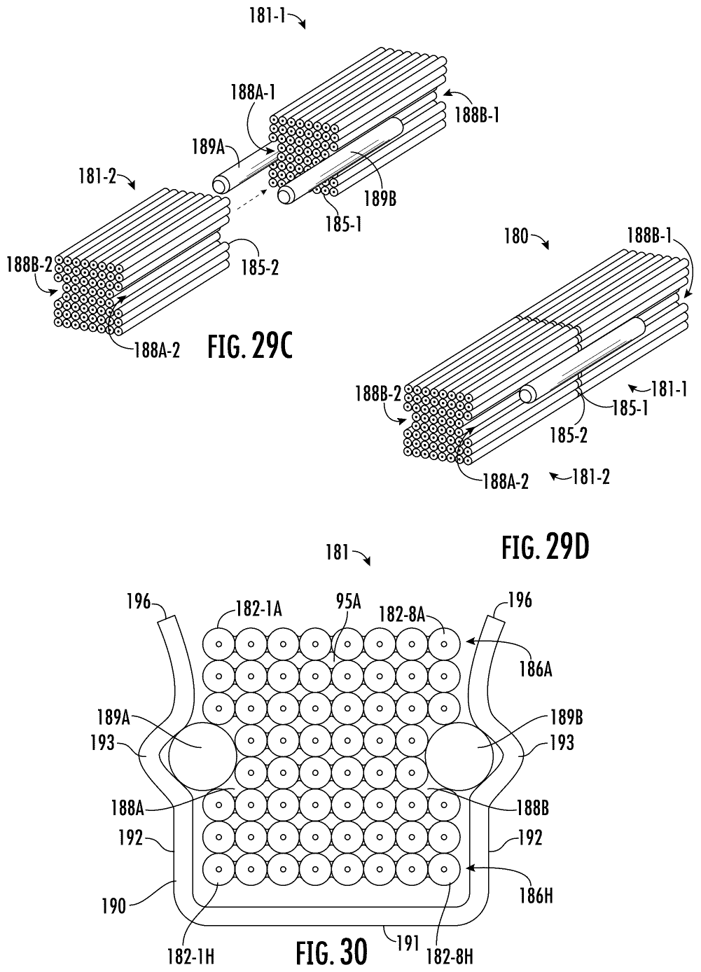

Various non-limiting examples of 2D fiber arrays including non-uniform boundaries are provided in FIGS. 29A to 31, FIGS. 36 to 38B, and FIGS. 42-44, and FIG. 47.

FIG. 29A is a perspective view of an adhered 2D fiber array 181 composed of eight stacked stripped fiber groups 186A-186H (from uppermost optical fibers 182-1A to 182-8A to lowermost optical fibers 182-1H to 182-8H, including two rows of six optical fibers sandwiched between three upper rows and three lower rows each having eight optical fibers). Although only stripped fiber groups 186-186H are shown for ease of illustration, it is to be appreciated that unstripped fibers regions (not shown) may extend continuously therefrom. A perimeter of the 2D fiber array 181 has non-uniform peripheral boundaries in the form of opposing first and second involutions 188A, 188B (formed by reduced presence of optical fibers in two rows of the stacked stripped fiber groups 186A-186H), which are configured to receive first and second alignment pins, and the involutions 188A, 188B extend to a front of the 2D fiber array 181 along end faces 185 of the optical fibers (i.e., including uppermost optical fibers 182-1A to 182-8A to lowermost optical fibers 182-1H to 182-8H).

FIG. 29B is a perspective view of the adhered 2D fiber array 181 of FIG. 29A, with first and second alignment pins 189A, 189B received in the first and second involutions 188A, 188B defined in the perimeter of the adhered 2D fiber array 181. As shown, the alignment ins 189A, 189B extend beyond optical fiber end faces 185 of the fiber groups 186A-186H. In certain embodiments, the first and second alignment pins 189A, 189B may be adhered to the 2D fiber array 181 against optical fibers bounding the first and second involutions 188A, 188B.

FIG. 29C is a perspective view of first and second adhered 2D fiber arrays 181-1, 181-2 (each according to the 2D fiber array 181 of FIG. 29A) separated from one another and with exposed optical fiber end faces 185-1, 185-2, with the first 2D fiber array 181-1 having alignment pins 189A, 189B received in first and second involutions 188A-1, 188B-1 of the first 2D fiber array 181-1. As shown, the second 2D fiber array 181-2 includes first and second involutions 188A-2, 188B-2 that are also configured to receive portions of the alignment pins 189A, 189B. FIG. 29D is a perspective view of the first and second adhered 2D fiber arrays 181-1, 181-2 of FIG. 29C in a mated configuration, with optical fiber end faces 185-1 of the first 2D fiber array 181-1 aligned with and contacting optical fiber end faces 185-2 of the second 2D fiber array 181-2, and with the alignment pins (including alignment pin 189B as shown) received in involutions (including 188B1, 188A2, and 188B2 as shown) of the first and second 2D fiber arrays 181-1, 181-2. Contact between the alignment pins 189A, 189B and optical fibers bounding the involutions 188A1, 188B1, 188A2, 188B2 promotes alignment between end faces 185-1, 185-2 of the 2D fiber arrays 181-1, 181-2.

In certain embodiments, a removable sleeve may be provided to maintain contact between one or more alignment structures and either a single 2D fiber array or multiple mated 2D fiber arrays. For example, FIG. 30 is a front elevational view of the adhered 2D fiber array 181 and alignment pins 189A, 189B of FIG. 29B, with a sleeve 190 fitting around a portion (e.g., 75%) of an aggregate perimeter of the 2D fiber array 181 and arranged in contact with the alignment pins 189A, 189B, to press the alignment pins 189A, 189B into the peripheral involutions 188A, 188B and into contact with optical fibers bounding the peripheral involutions 188A, 188B. The sleeve 190 has a modified semi-rectangular shape, including a base portion 191 (e.g., proximate to optical fibers 182-1H to 182-8H of the lowermost fiber group 186H), with left and right side portions 192 each defining one outwardly-flared region 193 configured to receive the alignment pins 189A, 189B. The left and right side portions 192 terminate at ends 196, which extend just past optical fibers 182-1A to 182-8A of the uppermost fiber group 186A. In certain embodiments, the sleeve 190 may be fabricated of metal or metal alloy to provide spring action, but other suitable materials including polymers and/or composites may be employed. In certain embodiments, the sleeve 190 may be as long as, or longer than, one or more contacting and/or adjacent alignment structures such as the alignment pins 189A, 189B. In certain embodiments, the sleeve 190 may extend in a lengthwise direction past optical fiber end faces of the 2D fiber array 181 to engage corresponding surfaces of another 2D fiber array (not shown). In certain embodiments, the alignment pins 189A, 189B may be adhered to optical fibers bounding the involutions 188A, 188B, such as by using the same or different adhesive 95A as may be provided in interstitial areas between optical fibers of the 2D fiber array 191.

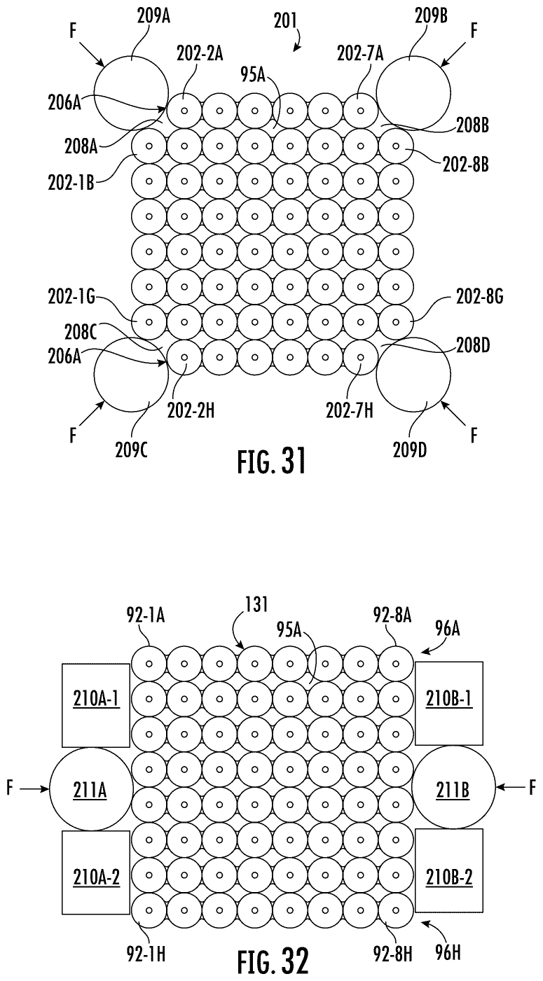

In certain embodiments, an adhered 2D fiber array may include non-uniform peripheral boundaries at one or more corners thereof. For example, FIG. 31 is a front elevational view of an adhered quasi-rectangular 2D fiber array 201 having involutions 208A-208D arranged at corner areas thereof. The 2D fiber array 201 includes eight fiber groups 206A-206H (including six rows of eight optical fibers, from upper 202-1B to 202-8B to lower 202-1G to 202-8G) sandwiched between an uppermost row and a lowermost row each having six optical fibers (i.e., 202-2A to 202-7A and 202-2H to 202-7H). Adhesive 95A may be provided in interstitial areas between optical fibers. First to fourth alignment pins 209A-209D are partially received within corresponding first to fourth involutions 208A-208D at corners of the 2D fiber array 201. When the 2D fiber array 201 and alignment pins 209A-209D are integrated into a fiber optic connector or the like, a biasing force F may be applied (e.g., via a sleeve, housing, compliant member, or other member, not shown) to press the alignment pins 209A-209D into contact with fibers of the 2D fiber array 201.

In certain embodiments, one or more alignment structures may be provided in contact with peripheral optical fibers of a 2D fiber array, and spacer structures also in contact with peripheral optical fibers of a 2D fiber array may be provided to promote and/or maintain a desired positioning of the alignment structures.

FIG. 32 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with glass sheets or fiber array rafts 210A-1, 210A-2, 210B-1, 210B-2 arranged along discontinuous portions of opposing first and second sides of the 2D fiber array 131, and with first and second alignment pins 211A, 211B arranged in the discontinuous portions between pairs of glass sheets of fiber array rafts 210A-1, 210A-2, 210B-1, 210B-2. The left glass sheets or fiber array rafts 210A-1, 210A-2 and first alignment pin 211A each contact multiple of the leftmost optical fibers 92-1A to 92-1H of the 2D fiber array 131, while the right glass sheets or fiber array rafts 210B-1, 210B-2 and second alignment pin 211B each contact multiple of the right optical fibers 92-18 to 92-8H of the 2D fiber array 131. In certain embodiments, the glass sheets or fiber array rafts 210A-1, 210A-2, 210B-1, 210B-2, and/or the alignment pins 211A, 211B may be adhered to peripheral fibers of the 2D fiber array 131. Adhesive 95A may be provided in interstitial areas between optical fibers. When the 2D fiber array 131, alignment pins 211A, 211B, and glass sheets or fiber array rafts 210A-1, 210A-2, 210B-1, 210B-2 are integrated into a fiber optic connector or the like, a biasing force F may be applied (e.g., via a sleeve, housing, compliant member, or other member, not shown) to press the alignment pins 211A, 211B toward one another and into contact with peripheral fibers of the 2D fiber array 131.

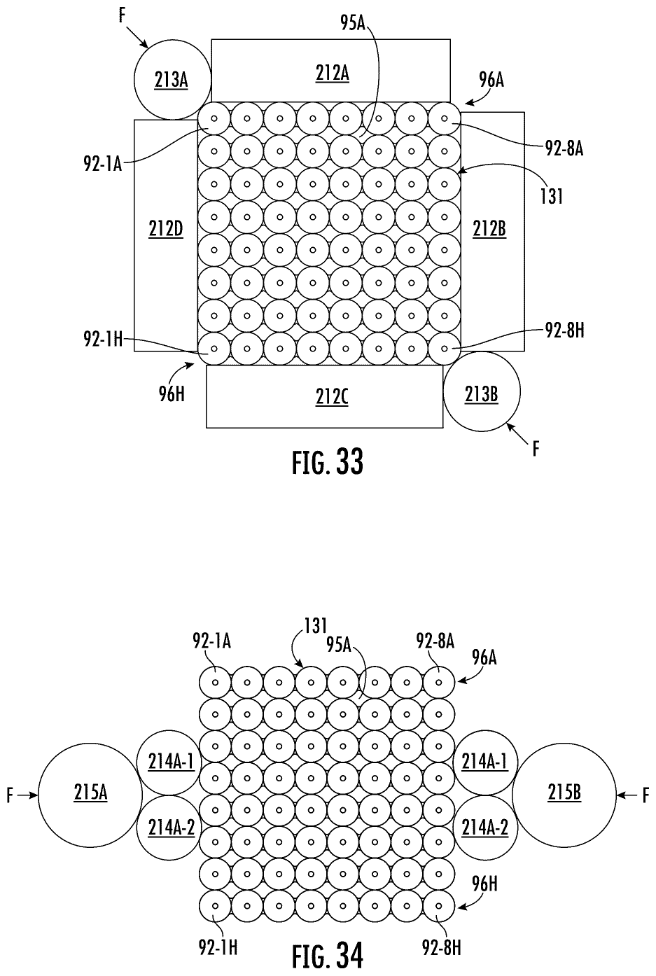

FIG. 33 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with four glass sheets or fiber array rafts 212A-212D arranged along four corresponding sides of the 2D fiber array 131, and with first and second alignment pins 213A, 213B each arranged in contact with two different glass sheets or fiber array rafts 212A-212D and each arranged in contact with a corner fiber 92-1A, 92-8H at non-adjacent corners of the 2D fiber array 131. The uppermost stripped fibers 92-1A to 92-8A are in contact with a first glass sheet or fiber array raft 212A, the rightmost stripped fibers 92-8A to 92-8H are in contact with a second glass sheet or fiber array raft 212B, the lowermost stripped fibers 92-1H to 92-8H are in contact with a third glass sheet or fiber array raft 212C, and the leftmost stripped fibers 92-1A to 92-1H are in contact with a fourth glass sheet or fiber array raft 212D. In certain embodiments, the glass sheets or fiber array rafts 212A-212D and/or the alignment pins 213A, 213B may be adhered to peripheral fibers of the 2D fiber array 131. Adhesive 95A may be provided in interstitial areas between optical fibers. When the 2D fiber array 131, alignment pins 213A, 213B, and glass sheets or fiber array rafts 212A-212D are integrated into a fiber optic connector or the like, a biasing force F may be applied (e.g., via a sleeve, housing, compliant member, or other member, not shown) to press the alignment pins 213A, 213B toward one another and into contact with corner fibers 92-1A, 92-8H of the 2D fiber array 131.

In certain embodiments, one or more spacer structures may be interposed between peripheral surfaces of a 2D fiber array, and arranged between the 2D fiber array and one or more alignment structures that are not in direct contact with fibers of the 2D fiber array. Non-limiting examples of such an arrangement are shown in FIGS. 34-37B.

FIG. 34 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with pairs of glass rods 214A-1, 214A-2, 214B-1, 214B-2 contacting selected optical fibers opposing peripheral sides of the 2D fiber array, and alignment pins 215A, 215B contacting the glass rods 214A-1, 214A-2, 214B-1, 214B-2. In particular, a left pair of glass rods 214A-1, 214A-2 is arranged against a left peripheral side bounded by leftmost stripped fibers 92-1A to 92-1H, and a right pair of glass rods 214B-1, 214B-2 is arranged against a right peripheral side bounded by rightmost stripped fibers 92-8A to 92-8H. In certain embodiments, the glass rods 214A-1, 214A-2, 214B-1, 214B-2 may be adhered to peripheral fibers of the 2D fiber array 131, and/or the alignment pins 215A, 215B may be adhered to pairs of glass rods 214A-1, 214A-2, 214B-1, 214B-2. Adhesive 95A may be provided in interstitial areas between optical fibers. When the 2D fiber array 131, alignment pins 215A, 215B, and glass rods 214A-1, 214A-2, 214B-1, 214B-2 are integrated into a fiber optic connector or the like, a biasing force F may be applied (e.g., via a sleeve, housing, compliant member, or other member, not shown) to press the alignment pins 215A, 215B toward one another and into contact with the glass rods 214A-1, 214A-2, 214B-1, 214B-2 positioned against peripheral sides of the 2D fiber array 131.

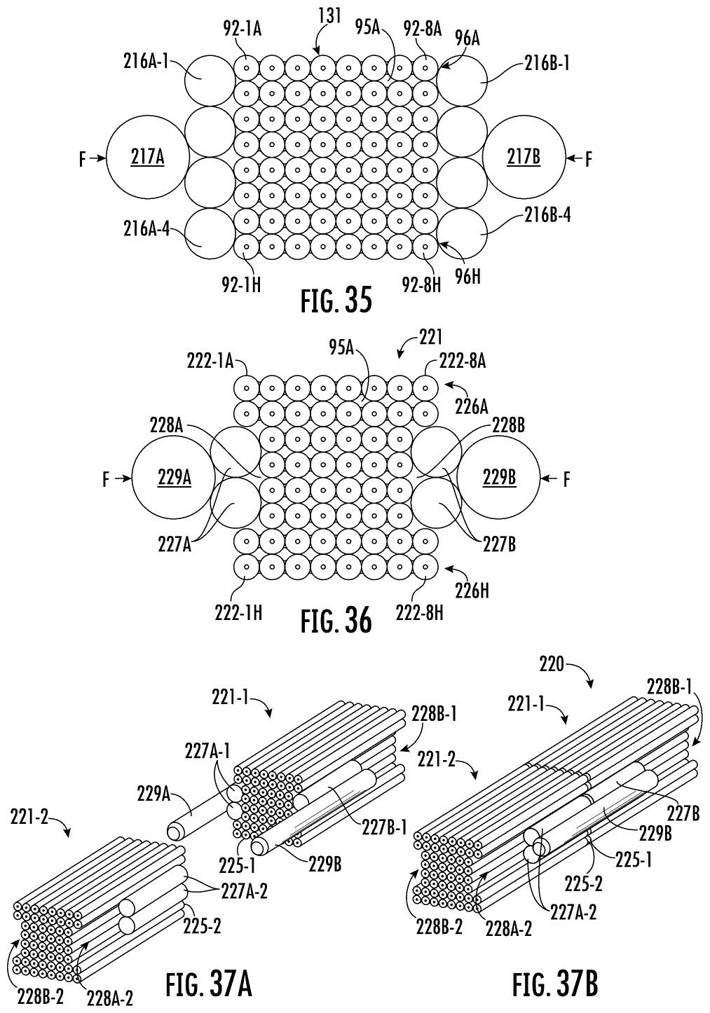

FIG. 35 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with quartets of glass rods 216A-1 to 216A-4, 216B-1 to 216B-4 contacting selected optical fibers opposing peripheral sides of the 2D fiber array 131, and with alignment pins 217A, 217B contacting the middle pairs of the glass rods 216A-1 to 216A-4, 216B-1 to 216B-4. In particular, a left quartet of glass rods 216A-1 to 216A-4 is arranged against a left peripheral side bounded by leftmost stripped fibers 92-1A to 92-1H, and a right quartet of glass rods 216B-1 to 216B-4 is arranged against a right peripheral side bounded by rightmost stripped fibers 92-8A to 92-8H. In certain embodiments, the glass rods 216A-4 to 216A-2, 216B-1 to 216B-4 may be adhered to peripheral fibers of the 2D fiber array 131, and/or the alignment pins 217A, 217B may be adhered to pairs of glass rods 216A-1 to 216A-4, 216B-1 to 216B-4. Adhesive 95A may be provided in interstitial areas between optical fibers. When the 2D fiber array 131, alignment pins 217A, 217B, and glass rods 216A-1 to 216A-4, 216B-1 to 214B-4 are integrated into a fiber optic connector or the like, a biasing force F may be applied (e.g., via a sleeve, housing, compliant member, or other member, not shown) to press the alignment pins 217A, 217B toward one another and into contact with the glass rods 216A-1-216A-4, 216B-1, 216B-4 positioned against peripheral sides of the 2D fiber array 131.

FIG. 36 is a perspective view of an adhered 2D fiber array 221 composed of eight stacked stripped fiber groups 226A-226H (from uppermost optical fibers 222-1A to 222-8A to lowermost optical fibers 222-1H to 222-8H, including four rows of six optical fibers sandwiched between two upper rows and two lower rows each having eight optical fibers). A perimeter of the 2D fiber array 221 has non-uniform peripheral boundaries in the form of opposing first and second involutions 228A, 228B (formed by reduced presence of optical fibers in four middle rows of the stacked stripped fiber groups 226A-226H), which are configured to receive pairs of glass rods 227A, 227B, wherein the glass rods 227A, 227B contact peripheral fibers of the 2D fiber array 221 bounding the involutions 228A, 228B. The glass rods 227A, 227B are intermediately arranged between the 2D fiber array 221 and alignment pins 229A. 229B, which do not directly contact the 2D fiber array 221. In certain embodiments, the glass rods 227A, 227B may be adhered to peripheral fibers of the 2D fiber array 221, and/or the alignment pins 229A, 229B may be adhered to the glass rods 227A, 227B. Adhesive 95A may be provided in interstitial areas between optical fibers. When the 2D fiber array 221, alignment pins 229A, 229B, and glass rods 227A, 227B are integrated into a fiber optic connector or the like, a biasing force F may be applied (e.g., via a sleeve, housing, compliant member, or other member, not shown) to press the alignment pins 229A, 229B toward one another and into contact with the glass rods 227A, 227B received by involutions in peripheral sides of the 2D fiber array 221.

FIG. 37A is a perspective view of a first adhered 2D fiber array 221-1 of stripped optical fibers with pairs of glass rods 227A-1, 227B-1 received in peripheral involutions 228A-1, 228B-1 and with alignment pins 229A, 229B against the glass rods 227A-1, 227B-1, all according to the correspondingly numbered items in FIG. 36, arranged proximate to a second adhered two-dimensional array 221-2 of stripped optical fibers with pairs of glass rods 227A-2, 227B-2 received in peripheral involutions 228A-2, 228B-2, also according to the correspondingly numbered items in FIG. 36. Each adhered 2D fiber array 221-1, 221-2 includes optical fiber end faces 225-1, 225-2 at one end thereof. Although only stripped optical fibers of the 2D fiber arrays 221-1, 221-2 are shown for ease of illustration, it is to be appreciated that unstripped fibers regions (not shown) may extend continuously from the illustrated 2D fiber arrays 221-1, 221-2. The glass rods 227B-2 (225-A-2 not shown) contacting the second 2D fiber array 221-2 are identical to the corresponding elements of the first 2D fiber array 221-1, and are configured to receive the alignment pins 229A, 229B when the 2D fiber arrays 221-1, 221-2 are mated together (i.e., with respective optical fiber end faces 225-1, 225-2 contacting one another). FIG. 37B is a perspective view of the first and second adhered 2D fiber arrays 221-1, 221-2 of FIG. 37A in a mated configuration, with optical fiber end faces 225-1 of the first 2D fiber array 221-1 aligned with and contacting optical fiber end faces 225-2 of the second 2D fiber array 221-2, and with the alignment pins (including alignment pin 229B as shown) received against glass rods (including 227B-1, 227B-2 as shown) that are themselves received partially within involutions (including 228B-2, 228A-2, and 228A-1 as shown) of the first and second 2D fiber arrays 221-1, 221-2. Contact between the alignment pins 229A, 229B and the glass rods (including 227B-1 and 227B-2 as shown) promotes alignment between end faces 225-1, 225-2 of the 2D fiber arrays 221-1, 221-2.

In certain embodiments, alignment structures for 2D fiber arrays include glass tubes, which may contact optical fibers of a 2D fiber array, and may optionally receive alignment pins therein. One advantage of such an alignment structure arrangement is that glass tubes can accommodate (repeated) insertion and removal of alignment pins without subjecting optical fibers to abrasion or other mechanical damage that could otherwise result if alignment pins were configured to directly contact optical fibers.

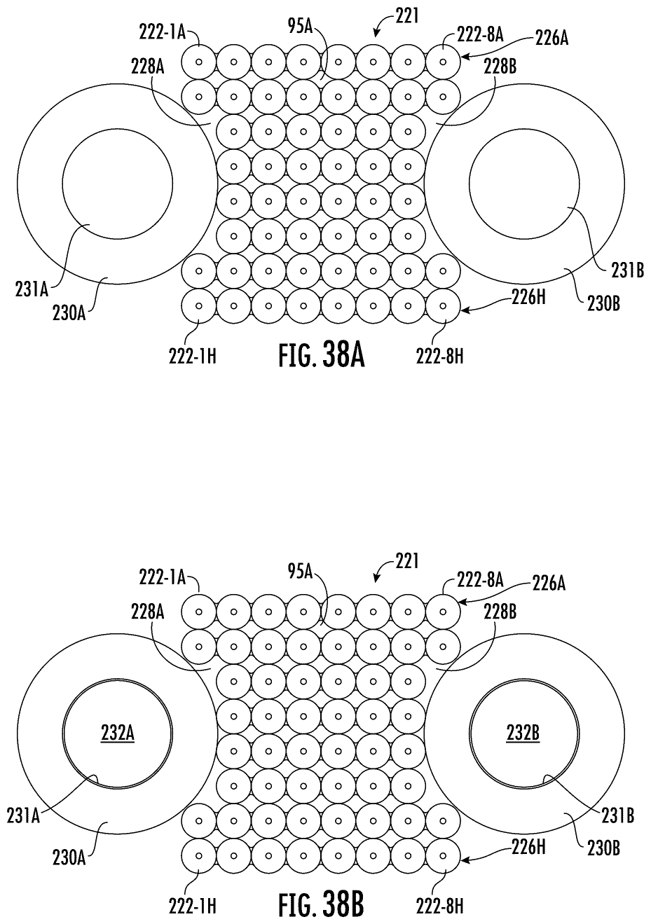

FIG. 38A is a perspective view of an adhered 2D fiber array 221 composed of eight stacked stripped fiber groups 226A-226H (from uppermost optical fibers 222-1A to 222-8A to lowermost optical fibers 222-1H to 222-8H, including four rows of six optical fibers sandwiched between two upper rows and two lower rows each having eight optical fibers). A perimeter of the 2D fiber array 221 has non-uniform peripheral boundaries in the form of opposing first and second involutions 228A, 228B (formed by reduced presence of optical fibers in four middle rows of the stacked stripped fiber groups 226A-226H), which are configured to receive glass tubes 230A, 230B each having a bore 231A, 231B, wherein the glass tubes 230A, 230B contact peripheral fibers of the 2D fiber array 221 bounding the involutions 228A, 228B. In certain embodiments, the glass tubes 230A, 230B may be adhered to peripheral fibers of the 2D fiber array 221. Adhesive 95A may be provided in interstitial areas between optical fibers. When the 2D fiber array 221 and glass tubes 230A, 230B are integrated into a fiber optic connector or the like, a biasing force may be applied (e.g., via a sleeve, housing, compliant member, or other member, not shown) to press the glass tubes 230A, 230B toward one another and into the involutions 228A, 228B in peripheral sides of the 2D fiber array 221. FIG. 38B is a front elevational view of the items of FIG. 38A, with the addition of first and second alignment pins 232A, 232B received within bores 231A, 231B of the first and second glass tubes 230A, 230B.

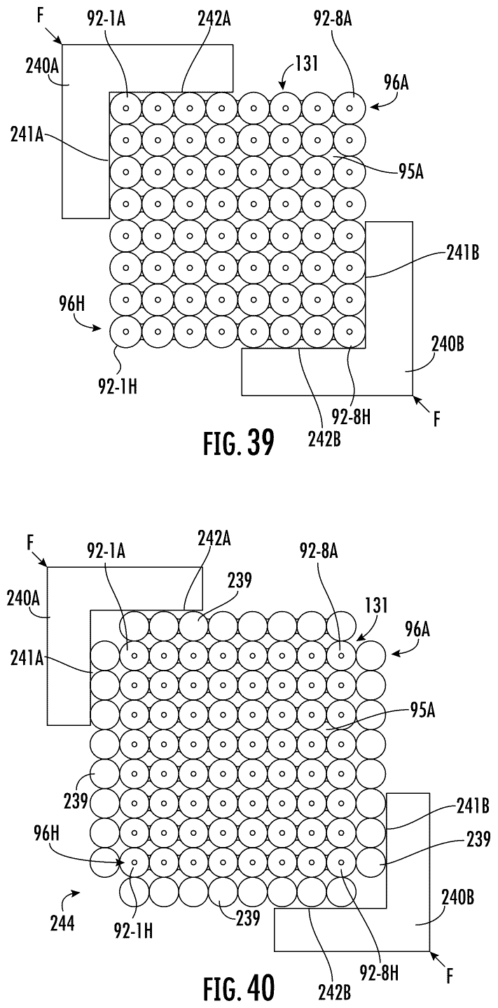

In certain embodiments, V-blocks (which may have angled portions resembling a letter “V” or “L” to fit around another structure, such as one or more optical fibers, or may embody a V-groove block configured to receive an alignment pin) may be used as alignment structures for 2D fiber arrays, whether directly in contact with optical fibers, or in indirect contact via intermediately arranged spacer structures. Non-limiting examples of arrangements utilizing V-blocks are shown in FIGS. 39-42.

FIG. 39 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with first and second V-blocks 240A, 240B serving as alignment features positioned around non-adjacent corners of the 2D fiber array 131 in contact with peripheral optical fibers thereof. The first V-block 240A includes a first (e.g., vertical) surface 241A arranged against peripheral fibers along a left peripheral side of the 2D fiber array 131 defined by leftmost stripped fibers 92-1A to 92-1H, and the first V-block 240A includes a second (e.g., horizontal) surface 242A against peripheral fibers along an upper side defined by the uppermost stripped fibers 92-1A to 92-8A. The second V-block 240B includes a first (e.g., vertical) surface 241B arranged against peripheral fibers along a right peripheral side of the 2D fiber array 131 defined by leftmost stripped fibers 92-8A to 92-8H, and the second V-block 240B includes a second (e.g., horizontal) surface 242B against peripheral fibers along a lower side defined by the lowermost stripped fibers 92-1H to 92-8H. The V-blocks 240A, 240B may extend in a lengthwise direction past optical fiber end faces of the 2D fiber array 131 to engage corresponding surfaces of another 2D fiber array (not shown). In certain embodiments, the V-blocks 240A, 240B may be adhered to peripheral fibers of the 2D fiber array 131. Adhesive 95A may be provided in interstitial areas between optical fibers. When the 2D fiber array 131 and V-blocks 240A, 240B are integrated into a fiber optic connector or the like, a biasing force F may be applied (e.g., via a sleeve, housing, compliant member, or other member, not shown) to press the V-blocks 240A, 240B toward one another and into contact with peripheral sides of the 2D fiber array 131.

FIG. 40 is a front elevational view of an adhered 2D optical fiber array 244, with first and second V-blocks 240A, 240B serving as alignment features positioned around non-adjacent corners of the 2D fiber array 244. In the 2D optical fiber array 244, perimeter fibers 239 have a durable, enhanced hardness material along outer surfaces thereof, while interior fibers of the array 244 (including interior 2D fiber array portion 131) lack enhanced hardness outer surfaces. The interior 2D fiber array portion 131 includes groups 96A-96H of stripped optical fibers, from uppermost stripped fibers 92-1A to 92-8A to lowermost stripped fibers 92-1H to 92-8H, with the interior 2D array portion 131 being surrounded by eight perimeter fibers 239 on each of four sides thereof. In certain embodiments, the perimeter fibers 239 may include optical cores configured for transmission of optical signals; in other embodiments, the perimeter fibers 239 may be devoid of optical cores and merely serve as precision thickness glass rods to protect the interior (8×8) 2D array portion 131. In certain embodiments, the perimeter fibers 239 along each side of the 2D fiber array 244 embody a fiber array raft, with each fiber array raft oriented parallel to optical fibers of the interior 2D fiber array portion 131. The first V-block 240A includes a first (e.g., vertical) surface 241A arranged against peripheral fibers 239 along a left peripheral side of the 2D fiber array 244, and includes a second (e.g., horizontal) surface 242A against peripheral fibers 239 along an upper side of the 2D fiber array 244. The second V-block 240B includes a first (e.g., vertical) surface 241B arranged against peripheral fibers 239 along a right peripheral side of the 2D fiber array 244, and includes a second (e.g., horizontal) surface 242B against peripheral fibers 239 along a lower side of the 2D fiber array 244. The V-blocks 240A, 240B may extend in a lengthwise direction past optical fiber end faces of the 2D fiber array 244 to engage corresponding surfaces of another 2D fiber array (not shown). In certain embodiments, the V-blocks 240A, 240B may be adhered to peripheral fibers 239 of the 2D fiber array 244. Adhesive 95A may be provided in interstitial areas between optical fibers. When the 2D fiber array 244 and V-blocks 240A, 240B are integrated into a fiber optic connector or the like, a biasing force F may be applied (e.g., via a sleeve, housing, compliant member, or other member, not shown) to press the V-blocks 240A, 240B toward one another and into contact with peripheral sides of the 2D fiber array 244.

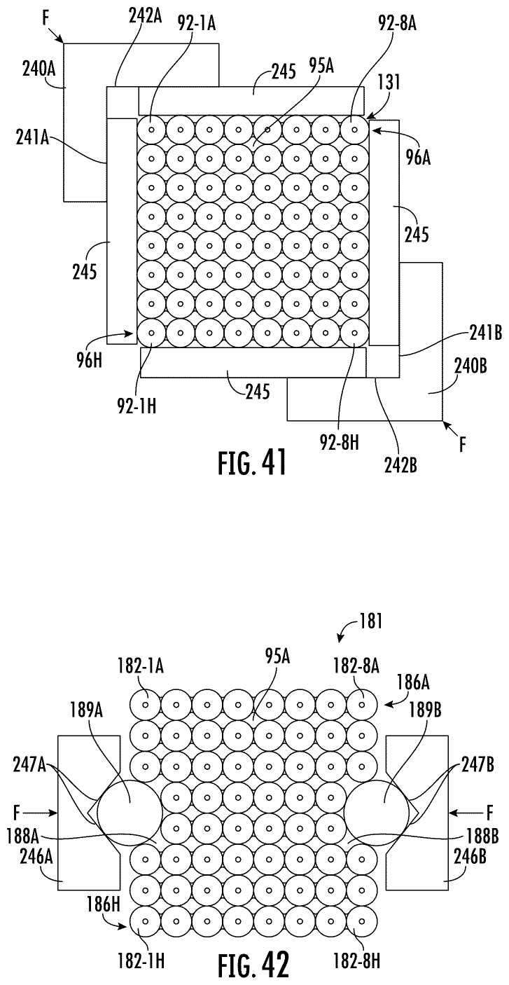

FIG. 41 is a front elevational view of an adhered 2D fiber array 131 including eight fiber groups 96A-96H of stripped optical fibers (i.e., from uppermost stripped fibers 92-1A to 92-8A to lowermost stripped fibers 92-1H to 92-8H), surrounded on four sides with glass sheets or fiber array rafts 245, with first and second V-blocks 240A, 240B serving as alignment features contacting the glass sheets or fiber array rafts 245. The first and second V-blocks 240A, 240B are positioned proximate to non-adjacent corners of the 2D fiber array 131 and in contact with the glass sheets or fiber array rafts 245, which serve to protect the 2D fiber array 131. The first V-block 240A includes a first (e.g., vertical) surface 241A and second (e.g., horizontal) surface 242A arranged to contact first and second glass sheets or fiber array rafts 245, respectively, each contacting a first corner fiber 92-1A of the 2D fiber array 131. The second V-block 240B includes a first (e.g., vertical) surface 241B and second (e.g., horizontal) surface 242B arranged to contact third and fourth glass sheets or fiber array rafts 245, respectively, each contacting a third corner fiber 92-8H of the 2D fiber array 131. The V-blocks 240A, 240B may extend in a lengthwise direction past optical fiber end faces of the 2D fiber array 131 to engage corresponding surfaces of another 2D fiber array (not shown). In certain embodiments, the glass sheets or fiber array rafts 245 may be adhered to peripheral fibers of the 2D fiber array 131, and/or the glass sheets or fiber array rafts 245 may be adhered to the V-blocks 240A, 240B. Adhesive 95A may be provided in interstitial areas between optical fibers. When the 2D fiber array 131, the glass sheets or fiber array rafts 245, and the V-blocks 240A, 240B are integrated into a fiber optic connector or the like, a biasing force F may be applied (e.g., via a sleeve, housing, compliant member, or other member, not shown) to press the V-blocks 240A, 240B toward one another and into contact with the glass sheets or fiber array rafts 245, which in turn are pressed into contact with peripheral sides of the 2D fiber array 131.

FIG. 42 shows an adhered 2D fiber array 181 composed of eight stacked stripped fiber groups 186A-186H (from uppermost optical fibers 182-1A to 182-8A to lowermost optical fibers 182-1H to 182-8H, including two rows of six optical fibers sandwiched between three upper rows and three lower rows each having eight optical fibers). A perimeter of the 2D fiber array 181 has non-uniform peripheral boundaries in the form of opposing first and second involutions 188A, 188B (formed by reduced presence of optical fibers in two rows of the stacked stripped fiber groups 186A-186H), wherein portions of first and second alignment pins 189A, 189B are received in the involutions 188A, 188B, and portions of the first and second alignment pins 189A, 189B are further received in V grooves 247A, 247B defined in V-blocks 246A, 246B. The V-blocks 246A, 246B and/or the alignment pins 189A, 189B may extend in a lengthwise direction past optical fiber end faces of the 2D fiber array 181 to engage corresponding surfaces of another 2D fiber array and/or other V-blocks (not shown). In certain embodiments, alignment pins 189A, 189B may be adhered to peripheral fibers of the 2D fiber array 181 bounding the involutions 188A, 188B. Adhesive 95A may be provided in interstitial areas between optical fibers. When the 2D fiber array 131, the alignment pins 189A, 189B, and the V-blocks 246A, 246B are integrated into a fiber optic connector or the like, a biasing force F may be applied (e.g., via a sleeve, housing, compliant member, or other member, not shown) to press the V-blocks 246A, 246B toward one another, thereby causing the alignment pins 189A, 189B to be pressed toward one another and into contact with optical fibers bounding the involutions 188A. 188B of the 2D fiber array 131.

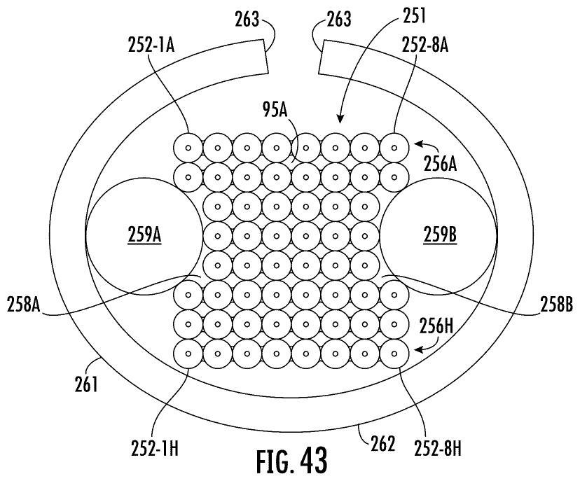

As introduced previously herein (e.g., in connection with FIG. 30), in certain embodiments, a removable sleeve may be provided to maintain contact between one or more alignment structures and either a single 2D fiber array or multiple mated 2D fiber arrays. In certain embodiments, a removable sleeve may be arranged in contact with one or more spacer structures in contact with a 2D fiber array, wherein such spacer structures may be provided to promote and/or maintain a desired positioning of alignment structures. In certain embodiments, a removable sleeve may be as long as, or longer than, one or more contacting and/or adjacent alignment structures (e.g., alignment pins, glass tubes, V-blocks, etc.). In certain embodiments, a sleeve may directly contact stripped fibers of one or more 2D fiber arrays. In certain embodiments, a sleeve may be fabricated of metal or metal alloy to provide spring action (optionally with one or more coatings), but other suitable materials including polymers and/or composites may be employed. Non-limiting examples of arrangements utilizing removable sleeves are shown in FIGS. 43-48.

FIG. 43 is a cross-sectional view of an adhered 2D fiber array 251 composed of eight stacked stripped fiber groups 256A-256H (from uppermost optical fibers 252-1A to 252-8A to lowermost optical fibers 252-1H to 252-8H, including three rows of six optical fibers sandwiched between two upper rows and three lower rows each having eight optical fibers). A perimeter of the 2D fiber array 251 has non-uniform peripheral boundaries in the form of opposing first and second involutions 258A, 258B (formed by reduced presence of optical fibers in three rows of the stacked stripped fiber groups 256A-256H), wherein portions of first and second alignment pins 259A, 259B are received in the involutions 258A, 258B, and portions of the first and second alignment pins 259A, 259B are further arranged in contact with an oval-shaped sleeve 261 that surrounds substantially an entire (more than 90% of an) aggregate perimeter of the 2D fiber array 251. The sleeve 261 has a generally oval-shaped body 262 that terminates at two ends 263. Optionally, the sleeve 261 may contact corner fibers 252-1H, 252, 8H of the 2D fiber array 251. Adhesive 95A may be provided in interstitial areas between optical fibers. The sleeve 261 and/or the alignment pins 259A, 259B may extend in a lengthwise direction past optical fiber end faces of the 2D fiber array 251 to engage corresponding surfaces of another 2D fiber array (not shown). When the sleeve 261 is fitted (e.g., by sliding) over the alignment pins 259A, 259B that are received by involutions 258A, 258B of the 2D fiber array 251, the sleeve 261 exerts a biasing force that presses the alignment pins 259A, 259B toward one another and into contact with optical fibers bounding the involutions 258A, 258B.

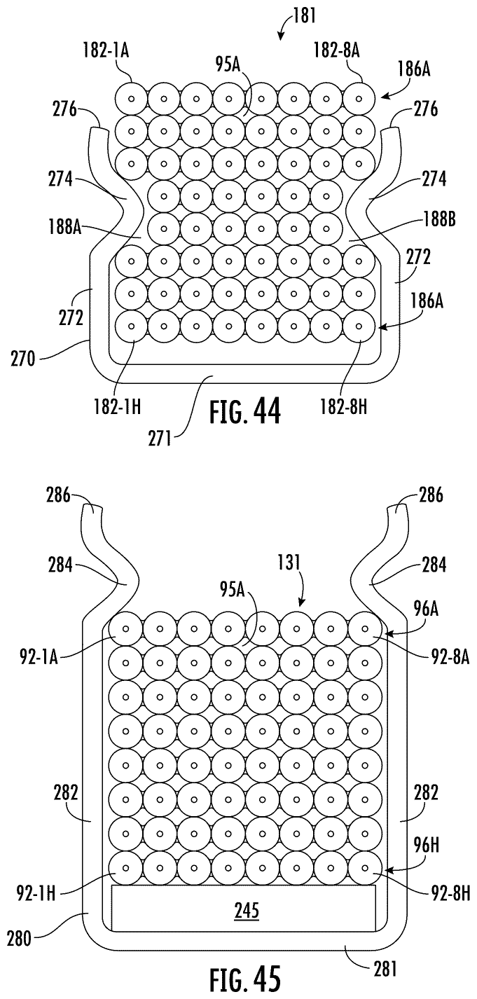

FIG. 44 shows an adhered 2D fiber array 181 composed of eight stacked stripped fiber groups 186A-186H (from uppermost optical fibers 182-1A to 182-8A to lowermost optical fibers 182-1H to 182-8H, including two rows of six optical fibers sandwiched between three upper rows and three lower rows each having eight optical fibers), wherein a perimeter of the 2D fiber array 181 has non-uniform peripheral boundaries in the form of opposing first and second involutions 188A, 188B (formed by reduced presence of optical fibers in two rows of the stacked stripped fiber groups 186A-186H). A semi-rectangular shaped removable sleeve 270 surrounds a majority (e.g., more than 65 percent) of an aggregate perimeter of the 2D fiber array 181, with inwardly flared regions 274 of the sleeve 270 protruding into the first and second involutions 188A, 188B and arranged in contact with selected peripheral optical fibers bounding the involutions 188A. 188B. The sleeve 270 includes a base portion 271 (e.g., proximate to optical fibers 182-1H to 182-8H of the lowermost fiber group 186H), with left and right side portions 272 each defining one of the inwardly-flared regions 274, and terminating at ends 276. When the sleeve 270 is fitted (e.g., by sliding) over a portion of the 2D fiber array 181, the inwardly flared regions 274 are received by the involutions 188A, 188B of the 2D fiber array 181. The sleeve 270 may extend in a lengthwise direction past optical fiber end faces of the 2D fiber array 181 to engage corresponding surfaces of another 2D fiber array (not shown). Thus, in certain embodiments, the sleeve 270 may itself serve as an alignment structure for mating adjacent 2D fiber arrays, without need for alignment pins, glass tubes, or the like.

FIG. 45 is a cross-sectional view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with a glass sheet or fiber array raft 245 contacting the lowermost stripped fibers 92-1H to 92-8H, and with a removable sleeve 280 surrounding a majority (e.g., more than 75% of) an aggregate perimeter of the 2D fiber array 131. The sleeve 280 has a modified rectangular shape, including a base portion 281 proximate to (i.e., contacting) the glass sheet or fiber array raft 245, including left and right side portions 282 each defining an inwardly-flared regions 284 and terminating at ends 286. The inwardly-flared regions 284 of the sleeve 280 are arranged in contact with corner fibers 92-1A, 92-8A of the 2D fiber array 131. The sleeve 280 may be fitted over a portion of the 2D fiber array 131 by sliding or other means. In certain embodiments, the sleeve 280 and/or the glass sheet or fiber array raft 245 may extend in a lengthwise direction past optical fiber end faces of the 2D fiber array 131 to engage corresponding surfaces of another 2D fiber array (not shown). Thus, in certain embodiments, the sleeve 280, or the sleeve 280 in combination with the glass sheet or fiber array raft 245, may serve as an alignment structure for mating adjacent 2D fiber arrays, without need for alignment pins, glass tubes, or the like. Adhesive 95A may be provided in interstitial areas between optical fibers. In certain embodiments, the glass sheet or fiber array raft 245 may be adhered to lowermost fibers 92-1H to 92-8H of the 2D fiber array 131, or the glass sheet or fiber array raft 245 may be adhered to the base portion 281 of the sleeve 280.

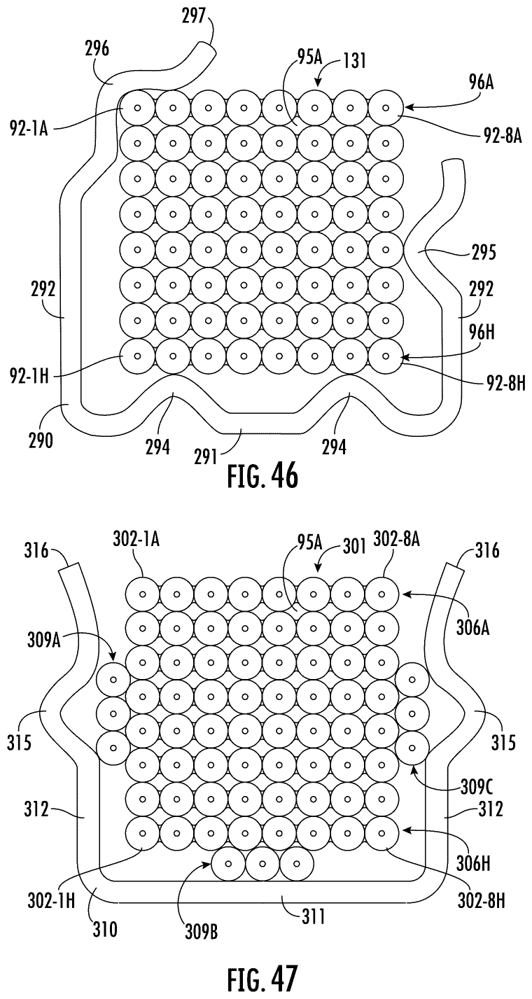

FIG. 46 is a cross-sectional view of an adhered 2D fiber array 131 including eight fiber groups 96A-96H of stripped optical fibers (i.e., from uppermost stripped fibers 92-1A to 92-8A to lowermost stripped fibers 92-1H to 92-8H), and with a removable sleeve 290 surrounding a majority (e.g., approximately 75% of) an aggregate perimeter of the 2D fiber array 131. Adhesive 95A may be provided in interstitial areas between optical fibers. The sleeve 290 has a modified rectangular shape, including a base portion 291 proximate to the lowermost stripped fibers 92-1H to 92-8H, and including left and right side portions 292 extending generally perpendicular to the base portion 291. The base portion 291 includes two inwardly-flared regions 294 that contact selected ones of the lowermost peripheral fibers 92-1H to 92-8H, and the right side portion 292 includes an inwardly-flared region 295 that contacts one of the rightmost peripheral fibers (i.e., between second and third corner fibers 92-8A to 92-8H). The left side portion 292 leads to an inward corner bend 296 that contacts a first corner fiber 92-1A of the 2D fiber array 131, and both side portions terminate at ends 297. The sleeve 290 may be fitted over a portion of the 2D fiber array 131 by sliding or other means. In certain embodiments, the sleeve 290 may extend in a lengthwise direction past optical fiber end faces of the 2D fiber array 131 to engage corresponding surfaces of another 2D fiber array (not shown). Thus, in certain embodiments, the sleeve 290 may serve as an alignment structure for mating adjacent 2D fiber arrays, without need for alignment pins, glass tubes, or the like.

FIG. 47 is a cross-sectional view of an adhered 2D fiber array 301 of stripped optical fibers, including eight rows 306A-306H of eight optical fibers (i.e., from uppermost stripped fibers 302-1A to 302-8A to lowermost stripped fibers 302-1H to 302-8H) arranged in a rectangular packed configuration, with groups of three additional optical fibers 309A-309C arranged in a hexagonal packed configuration along three sides (e.g., right, left, and lower sides) of the 2D fiber array 301 to form protrusions. The 2D fiber array 301 is received within a modified semi-rectangular shaped sleeve 310 surrounding a majority (e.g., about 75 percent) of an aggregate perimeter of the 2D fiber array 301. The sleeve 310 includes a base portion 311 arranged in contact with a protrusion formed by optical fiber group 309B. The sleeve also includes left and right portions 312 that each define one outwardly flared region 315, which are arranged in contact with protrusions formed by optical fiber groups 309A, 309C at opposing left and right sides of the 2D fiber array 301. The left and right portions 312 of the sleeve 310 terminate at ends 316. The sleeve 310 may be fitted over a portion of the 2D fiber array 301 by sliding or other means. In certain embodiments, the sleeve 310 may extend in a lengthwise direction past optical fiber end faces of the 2D fiber array 301 to engage corresponding surfaces of another 2D fiber array (not shown). Thus, in certain embodiments, the sleeve 310 may serve as an alignment structure for mating adjacent 2D fiber arrays, without need for alignment pins, glass tubes, or the like.

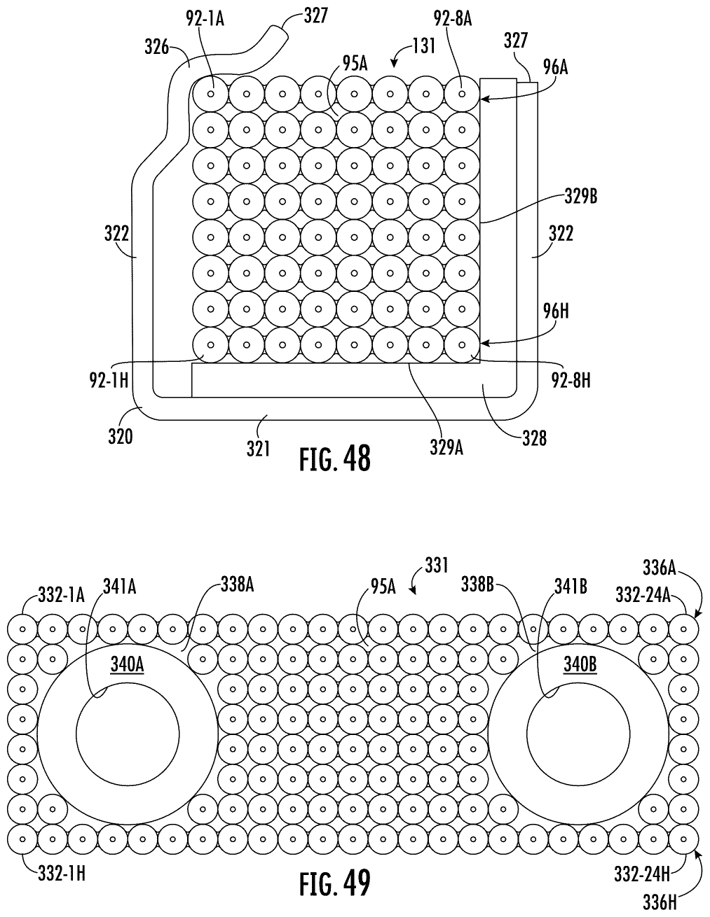

FIG. 48 is a cross-sectional view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with a V-block 328 contacting optical fibers along two (left and lower) peripheral sides of the 2D fiber array 131, and with a removable sleeve 320 contacting the V-block 328 and surrounding a majority (e.g., approximately 75% of) an aggregate perimeter of the 2D fiber array 131. The V-block 328 includes a vertical surface 329B contacting rightmost stripped fibers 92-8A to 92-8H of the 2D fiber array 131, and includes a horizontal surface 329A contacting the lowermost stripped fibers 92-1H to 92-8H. The removable sleeve 320 includes a base portion 321 parallel to the horizontal surface 329A of the V-block, with left and right side portions 322 extending perpendicular thereto. The right side portion 322 extends parallel to the vertical surface 329B of the V-block. The left side portion 322 leads to an inward corner bend 326 that contacts a first corner fiber 92-1A of the 2D fiber array 131, and both side portions terminate at ends 327. The sleeve 320 may be fitted over a portion of the 2D fiber array 131 and the V-block 328 by sliding or other means. In certain embodiments, the sleeve 320 and/or the V-block 328 may extend in a lengthwise direction past optical fiber end faces of the 2D fiber array 131 to engage corresponding surfaces of another 2D fiber array (not shown). In certain embodiments, the V-block 328 may be adhered to peripheral fibers of the 2D fiber array 131, or to the sleeve 320. Adhesive 95A may be provided in interstitial areas between optical fibers.

In certain embodiments, alignment structures may be provided in fiber-free areas within 2D fiber arrays, whether such arrays are continuous (i.e., with fibers surrounding fiber-free areas on all sides), or discontinuous (i.e., with fibers surrounding at least half, but less than an entirety, of fiber-free areas). Non-limiting examples of alignment structures provided in fiber-free areas of continuous 2D fiber arrays are provided in FIGS. 49 and 50.

FIG. 49 is a front elevational view of an adhered 2D fiber array 331 of stripped optical fibers, including eight rows 336A-336H of multiple optical fibers (i.e., from uppermost stripped fibers 332-1A to 332-24A to lowermost stripped fibers 332-1H to 332-24H) arranged in a rectangular packed configuration, with two fiber-free areas 338A, 338B provided in an interior of the 2D fiber array 331. Alignment structures in the form of glass tubes 340A, 340B (having bores 341A, 341B) are received within the fiber-free areas 338A, 338B and arranged in contact with multiple optical fibers of the 2D fiber array 331. Adhesive 95A may be provided in interstitial areas between optical fibers in the 2D fiber array 331. In certain embodiments, the glass tubes 340A, 340B may extend in a lengthwise direction past optical fiber end faces of the 2D fiber array 331 to engage corresponding surfaces of another 2D fiber array (not shown). In certain embodiments, the glass tubes 340A, 340B may be adhered to optical fibers of the 2D fiber array 331. In certain embodiments, the glass tubes 340A, 340B may be configured to receive alignment pins (not shown) in the bores 341A, 341B to facilitate alignment with another 2D fiber array (not shown).

FIG. 50 is a front elevational view of an adhered 2D fiber array 351 of stripped optical fibers, including eight rows 356A-356H of multiple optical fibers (i.e., from uppermost stripped fibers 352-1A to 352-24A to lowermost stripped fibers 352-1H to 352-24H) arranged in a rectangular packed configuration, with two fiber-free areas 358A, 358B provided in an interior of the 2D fiber array 351. Alignment structures in the form of generally cylindrical alignment pins 359A, 359B are received within the fiber-free areas 358A, 358B and arranged in contact with multiple optical fibers of the 2D fiber array 351. Adhesive 95A may be provided in interstitial areas between optical fibers in the 2D fiber array 351. In certain embodiments, the alignment pins 359A, 359B may extend in a lengthwise direction past optical fiber end faces of the 2D fiber array 351 to engage corresponding surfaces of another 2D fiber array (not shown). In certain embodiments, the alignment pins 359A, 359B may be adhered to optical fibers of the 2D fiber array 331.

In certain embodiments, peripheral side portions proximate to end faces of adhered 2D fiber arrays may be surrounded with one or more structures configured to provide mechanical protection to the 2D fiber arrays, such as for use in fiber-to-fiber connectors. Examples of protective structures include glass sheets, fiber array rafts, and the like. In certain embodiments, a front boundary perimeter (e.g., front faces) of such protective structures may be shaped (e.g., beveled or rounded) to facilitate insertion into receiving structures, while a rear boundary perimeter (e.g., rear faces) thereof may be shaped (e.g., reverse angled) to engage retention structures with enhanced reliability.

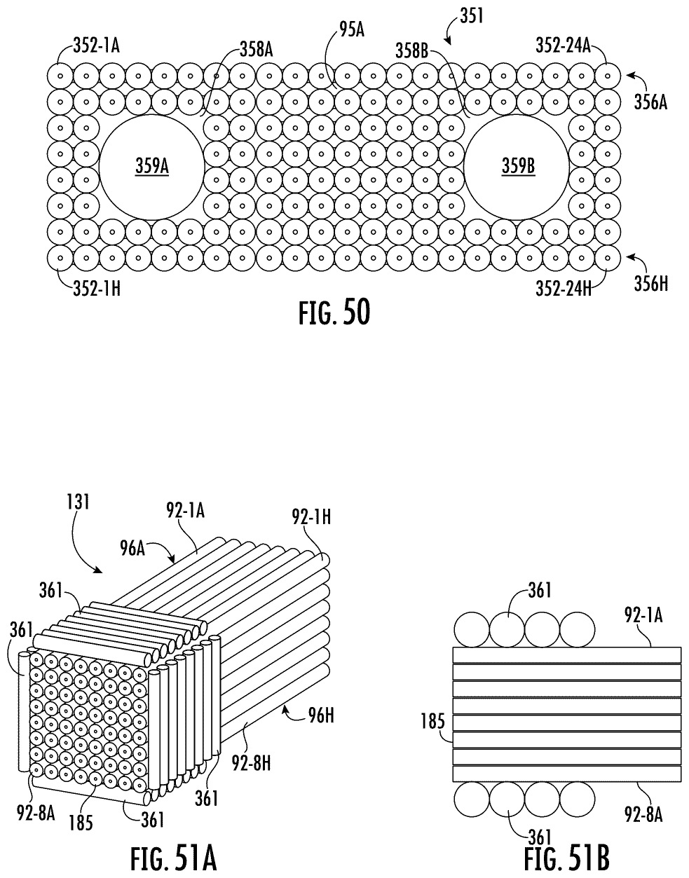

FIG. 51A is a perspective view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with fiber array rafts 361 arranged on four peripheral sides of the 2D fiber array 131 proximate to optical fiber end faces 185, and with raft fibers of the fiber array rafts 361 being transversely oriented relative to optical fibers of the 2D fiber array 131. Although only stripped fiber groups 96A-96H are shown for ease of illustration, it is to be appreciated that unstripped fibers regions (not shown) may extend continuously therefrom at portions opposing the optical fiber end faces 185. FIG. 51B is a side cross-sectional view of the adhered 2D fiber array 131 and (upper and lower) fiber array rafts 361 of FIG. 51A, showing one vertical grouping of stripped fibers 92-1A to 92-8A.

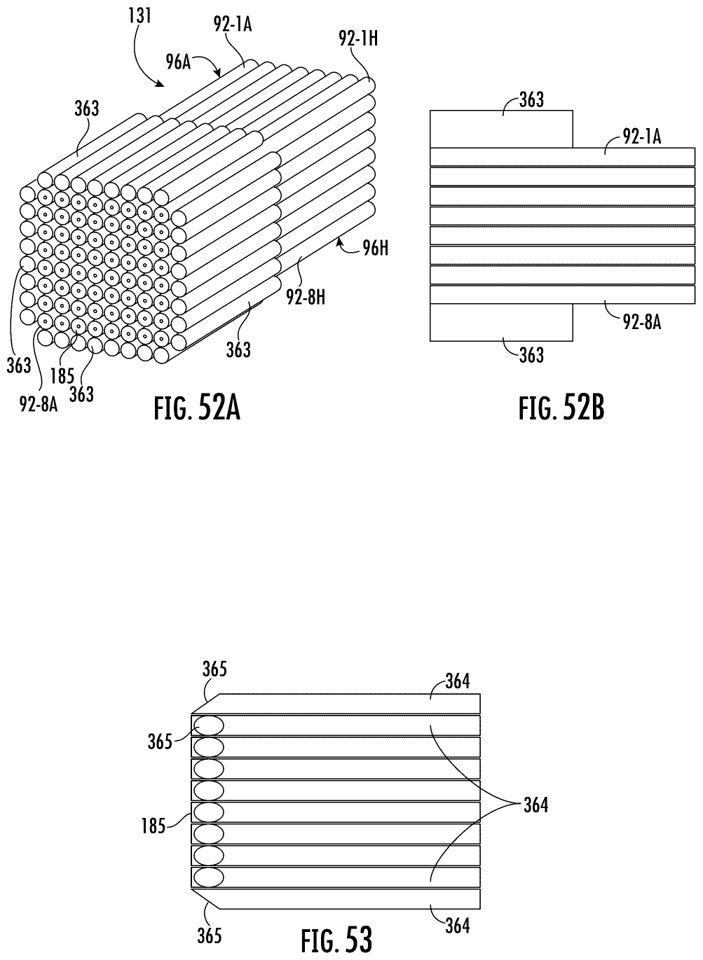

FIG. 52A is a perspective view of an adhered 2D fiber array 131 including eight fiber groups 96A-96H of stripped optical fibers (i.e., from uppermost stripped fibers 92-1A to 92-8A to lowermost stripped fibers 92-1H to 92-8H), with fiber array rafts 363 arranged on four peripheral sides of the 2D fiber array 131 proximate to optical fiber end faces 185, and with raft fibers of the fiber array rafts 363 being oriented parallel to optical fibers of the 2D fiber array 131. Although only stripped fiber groups 96A-96H are shown for ease of illustration, it is to be appreciated that unstripped fibers regions (not shown) may extend continuously therefrom at portions opposing the optical fiber end faces 185. FIG. 52B is a side cross-sectional view of the adhered 2D fiber array 131 and (upper and lower) fiber array rafts 363 of FIG. 52A, showing one vertical grouping of stripped fibers 92-1A to 92-8A.

In certain embodiments, front end faces of fiber array raft fibers may be beveled, shaped, or otherwise profiled to facilitate insertion of a corresponding 2D fiber array during assembly with other connector components.

FIG. 53 is a side elevational view of an adhered 2D (8×8) fiber array of stripped optical fibers (with only optical fiber end faces 185 being labeled), including fiber array rafts 364 (with raft fibers oriented parallel to optical fibers of the 8×8 array) arranged on four peripheral sides of the 8×8 array, and with raft fibers of the fiber array rafts 364 having beveled ends 365 at a front boundary perimeter of the array, proximate to the optical fiber end faces 185.

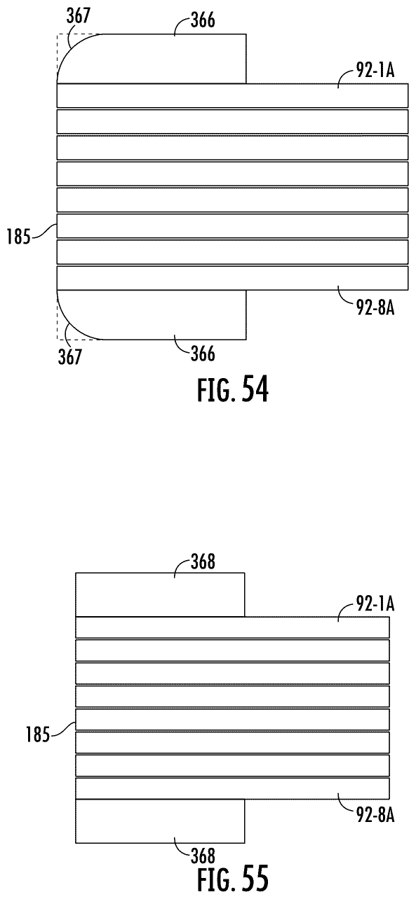

FIG. 54 is a side cross-sectional view of an adhered 2D (8×8) fiber array of stripped optical fibers (with one vertical group of optical fibers 92-1A to 92-8A being shown), with fiber array rafts 366 (having raft fibers thereof oriented parallel to optical fibers 92-1A to 92-8A of the array) arranged on four peripheral sides of the 2D fiber array, and with raft fibers of the fiber array rafts having rounded ends 367 at a front boundary perimeter of the array, proximate to the optical fiber end faces 185.

FIG. 55 is a side cross-sectional view of an adhered 2D (8×8) fiber array of stripped optical fibers (with one vertical group of optical fibers 92-1A to 92-8A being shown), with glass sheets 368 arranged on peripheral sides of the 2D fiber array, at an end portion of the fiber array at a front boundary perimeter of the array proximate to the optical fiber end faces 185.

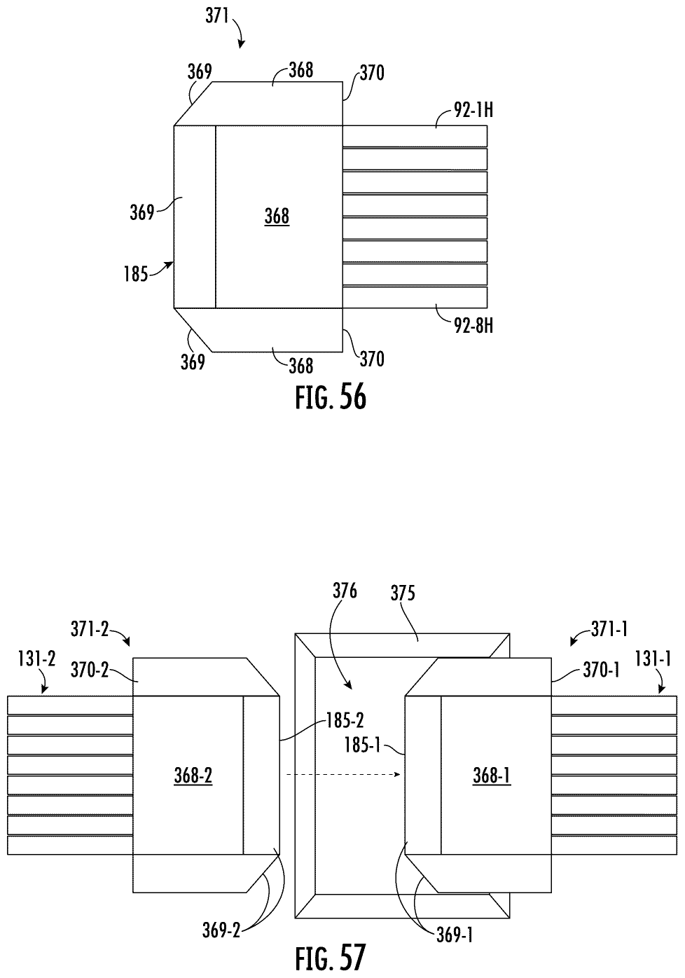

FIG. 56 is a side cross-sectional view of an adhered 2D (8×8) fiber array 131 of stripped optical fibers (with one vertical group of optical fibers 92-1H to 92-8H being shown), with glass sheets 368 arranged on peripheral sides of the 2D array. The glass sheets 368 have beveled front ends 369 at a front boundary perimeter of the array proximate to the optical fiber end faces 185, and have perpendicular rear ends 370, wherein the fiber array 131 and peripheral glass sheets 368 in combination may form a fiber optic connector 371.

FIG. 57 is a side cross-sectional view of first and second adhered 2D (8×8) fiber arrays 131-1, 131-2 of stripped optical fibers, each having glass sheets 368-1, 368-2 with beveled front ends 369-1, 369-2 (and perpendicular rear ends 370-1, 370-2) arranged on peripheral sides of the respective fiber array 131-1, 131-2. As shown, the first 2D fiber array 131-1 and associated peripheral glass sheets 368-1 (together forming a first fiber optic connector 371-1) are received in a first portion of a cavity 376 of a connector sleeve 375, while the second 2D fiber array 131-2 with associated peripheral glass sheets 368-2 (together forming a second fiber optic connector 371-2) is arranged proximate to, but outside, a second portion of the cavity 376 of the connector sleeve 375. Each fiber array 131-1, 131-2 includes optical fiber end faces 185-1, 185-2 proximate to the beveled front ends 369-1, 369-2. The beveled front ends 369-1, 369-2 facilitate insertion of the glass-sheet-clad 2D fiber arrays 131-1, 131-2 (i.e., connectors 371-1, 371-2) into the connector sleeve 375.

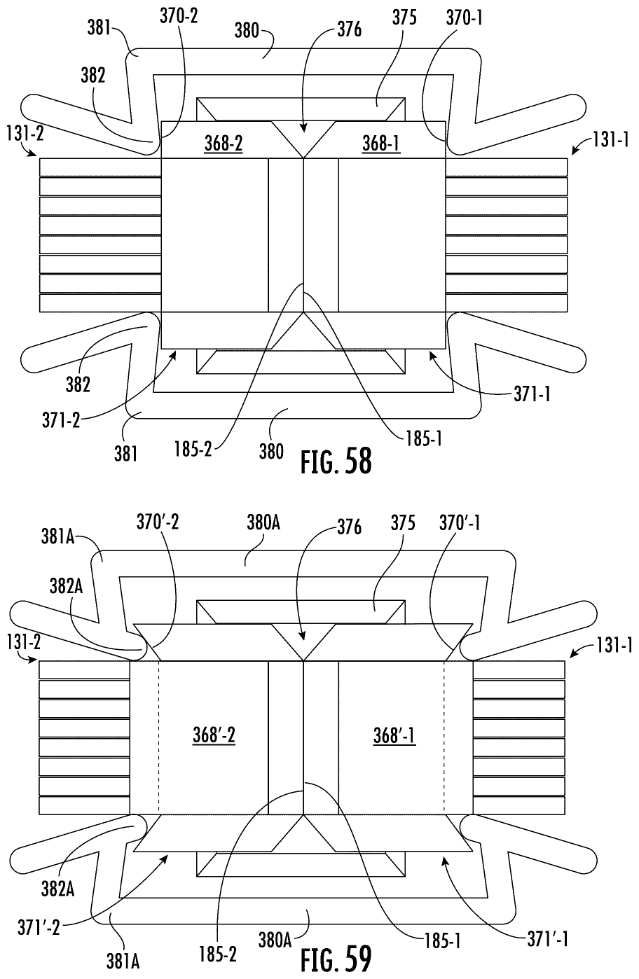

FIG. 58 is a side cross-sectional view of the first and second adhered 2D (8×8) fiber arrays 131-1, 131-2 of stripped optical fibers and associated front-beveled peripheral glass sheets 368-1, 368-2 (in combination forming fiber optic connectors 371-1, 371-2) received in respective first and second portions of the cavity 376 of the connector sleeve 375 of FIG. 57, to cause abutment between aligned optical fiber end faces 185-1, 185-2. FIG. 58 further shows the addition of (two) removable clips 380 configured to engage perpendicular rear surfaces 370-1, 370-2 of the peripheral glass sheets 368-1, 368-2 to apply a biasing force pressing the glass sheets 368-1, 368-2 of connectors 371-1, 371-2 into the connector sleeve 375, and pressing optical fiber end faces 185-1, 185-2 of the 2D fiber arrays 131-1, 131-2 into contact with one another. Each removable clip 380 includes bends 381 leading to mating portions 382 configured to engage the perpendicular rear ends 370-1, 370-2 of the peripheral glass sheets 368-1, 368-2. In certain embodiments, the removable clips 380 may be fabricated of metal or metal alloy to provide spring action, but other suitable materials including polymers and/or composites may be employed.

In certain embodiments, rear surfaces of peripheral glass sheets bounding adhered 2D fiber arrays may be reverse angled to enhance mechanical engagement and retention of removable clips. FIG. 59 is a side cross-sectional view of first and second adhered 2D (8×8) fiber arrays 131-1, 131-2 of stripped optical fibers having associated front-beveled peripheral glass sheets 368′-1, 368′-2 (together forming fiber optic connectors 371′-1, 371′-2) received in respective first and second portions of the cavity 376 of a connector sleeve 375 according to FIGS. 57-58 to cause abutment between aligned optical fiber end faces 185-1, 185-2. As opposed to the arrangement shown in FIGS. 57-58, the peripheral glass sheets 368′-1, 368′-2 of the fiber optic connectors 371′-1, 371′-2 of FIG. 59 have reverse-angled rear ends 370′-1, 370′-2. Two removable clips 380A are configured to engage the reverse-angled rear surfaces 370′-1, 370′-2 of the peripheral glass sheets 368′-1, 368′-2 to apply a biasing force pressing the glass sheets 368′-1, 368′-2 of fiber optic connectors 371′-1, 371′-2 into the connector sleeve 375, and pressing optical fiber end faces 185-1, 185-2 of the 2D fiber arrays 131-1, 131-2 into contact with one another. Each removable clip 380A includes bends 381A leading to mating portions 382A with extended tips configured to engage the reverse-angled rear ends 370′-1, 370′-2 of the peripheral glass sheets 368′-1, 368′-2. In use, the fiber optic connectors 371′-1, 371′-2 are inserted first into the connector sleeve 375, and the removable clips 380A are fitted over the reverse-angled rear ends 370′-1, 370′-2 of the peripheral glass sheets 368′-1, 368′-2 to promote mechanical retention.

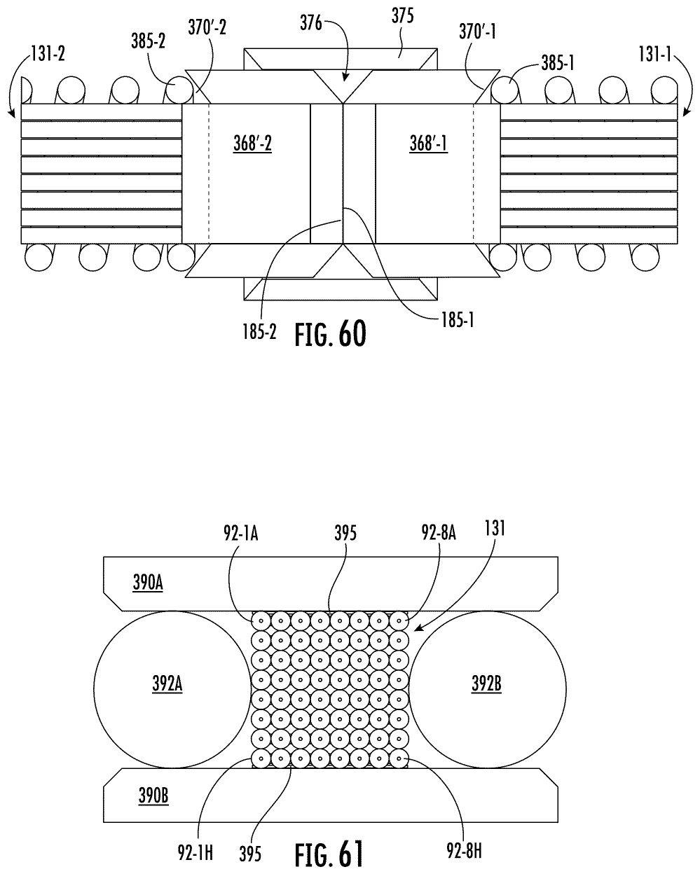

As an alternative to using removable clips according to FIGS. 58-59, in certain embodiments, other means such as coil springs may be used to mechanically bias fiber optic connectors 371-1, 371-2, 371′-1, 371′-2 into a connector sleeve to ensure proper contact between optical fiber end faces 185-1, 185-2. FIG. 60 shows the same fiber optic connectors 371′-1, 371′-2 (including first and second adhered 2D (8×8) fiber arrays 131-1, 131-2 of stripped optical fibers having associated front-beveled peripheral glass sheets 368′-1, 368′-2) as previously shown in FIG. 59, but with addition of coil springs 385-1, 385-2 (in lieu of removable clips 380A) to engage the reverse-angled rear ends 370′-1, 370′-2 of the peripheral glass sheets 368′-1, 368′-2. Such coil springs 385-1, 385-2 may fit around portions of 2D fiber arrays 131-1, 131-2 and apply a biasing force pressing the glass sheets 368′-1, 368′-2 of fiber optic connectors 371′-1, 371′-2 into the connector sleeve 375, and pressing optical fiber end faces 185-1, 185-2 of the 2D fiber arrays 131-1, 131-2 into contact with one another.

In certain embodiments, one or more 2D fiber arrays may be adhered between first and second precision thickness fusion glass sheets or fiber array rafts, and one or more alignment structures (optionally incorporating spacers) may be provided between the same precision thickness fusion glass sheets or fiber array rafts.

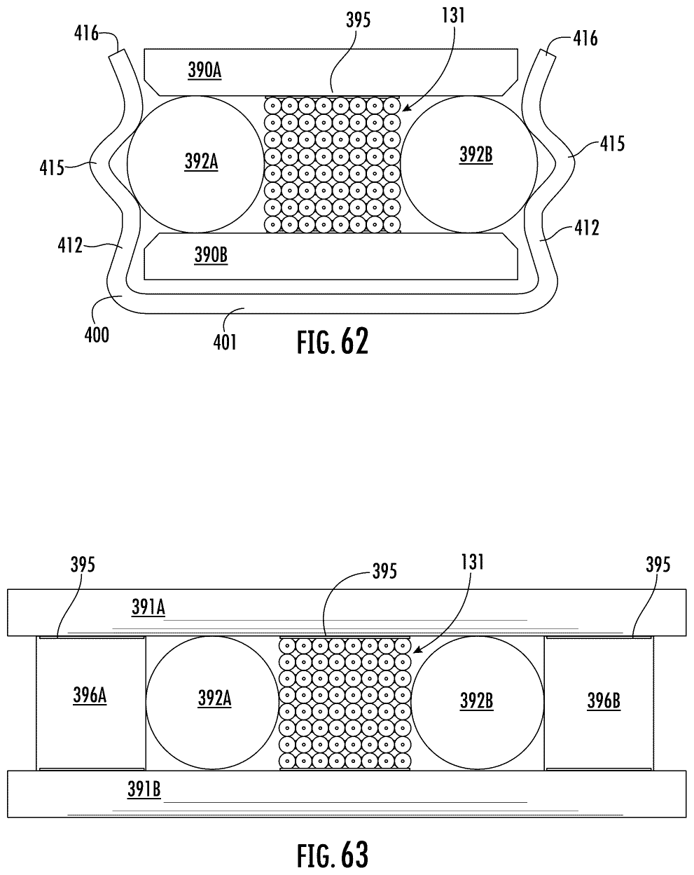

FIG. 61 is a cross-sectional view of an adhered 2D fiber array 131, spanning from uppermost stripped fibers 92-1A to 92-8A to lowermost stripped fibers 92-1H to 92-8H, adhered (with adhesive 395) between first and second glass sheets 390A-390B that extend beyond peripheral sides of the array, with first and second alignment pins 392A, 392B received between the glass sheets 390A-390B and also arranged in contact with peripheral fibers of the adhered 2D fiber array 131. When the 2D fiber array 131 and alignment pins 392A, 392B are integrated into a fiber optic connector or the like, a biasing force may be applied (e.g., via a sleeve, housing, compliant member, or other member) to press the alignment pins 392A, 392B toward one another and into contact with fibers of the 2D fiber array 131. For example, FIG. 62 shows the 2D fiber array 131, glass sheets 390A, 390B, and alignment pins 392A, 392B of FIG. 61 received in a removable sleeve 400, with the sleeve 400 arranged around a majority (e.g., about 75% of) an aggregate peripheral area of the 2D fiber array 131. The sleeve 400 includes a base portion 401 arranged parallel and proximate to the lower glass sheet 390A, with left and right portions 412 arranged generally perpendicular to the base portion 401 and each incorporating an outwardly flared portion 415 receiving a portion of a corresponding left or right alignment pin 392A, 392B, with the left and right portions 412 terminating at ends 416. The sleeve 400 and/or the alignment pins 392A, 392B may extend in a lengthwise direction past optical fiber end faces of the 2D fiber array 131 to engage corresponding surfaces of another 2D fiber array (not shown). When the sleeve 400 is fitted (e.g., by sliding) over the alignment pins 392A, 392B contacting the 2D fiber array 251, the sleeve 400 exerts a biasing force that presses the alignment pins 392A, 392B toward one another and into contact with optical fibers bounding the 2D fiber array 131.

FIG. 63 is a cross-sectional view of an adhered 2D (8×8) fiber array 131 of stripped optical fibers, coupled with adhesive 395 between first and second fiber array rafts 391A-391B that extend beyond peripheral sides of the array, wherein first and second alignment pins 392A, 392B received between the fiber array rafts 391A-391B and also arranged in contact with peripheral fibers of the adhered 2D fiber array 131. Spacer blocks 396A, 396B, which are also adhered to the fiber array rafts 391A, 391B with adhesive 395, are further provided in contact with the alignment pins 392A, 392B, such that each alignment pin 392A, 392B is arranged between, and in contact with, the 2D fiber array 131 as well as one of the two spacer blocks 396A, 396B. The spacer blocks 396A, 396B may comprise glass, may be substantially rectangular in shape, and extend continuously between the upper and lower fiber array rafts 391A-39B. Fixing the spacer blocks 396A, 396 as well as the 2D fiber array 131 to the fiber array rafts 391A-391B with adhesive 395 provides consistent dimensions for receiving and positioning the alignment pins 392A, 392B.

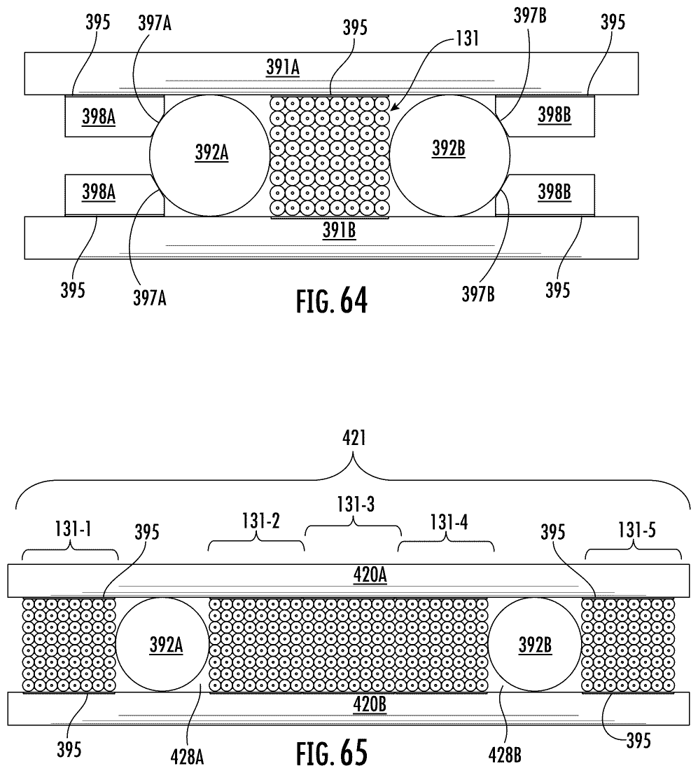

FIG. 64 is a cross-sectional view of an adhered 2D (8×8) fiber array 131 of stripped optical fibers, coupled with adhesive 395 between first and second fiber array rafts 391A-391B that extend beyond peripheral sides of the array, with paired vertically discontinuous glass spacer blocks 398A, 398B being laterally offset from the array and separately adhered between the fiber array rafts 391A-391B. The paired vertically discontinuous glass spacer blocks 391A-391B have medially arranged curved recesses 397A, 397B configured to receive portions of first and second alignment pins 392A, 392B that also contacting peripheral optical fibers of the 2D fiber array 131, such that the alignment pins 392A, 392B are arranged between the fiber array rafts 391A-391B as well as the between the spacer blocks 398A-398B and the 2D fiber array 131. If the alignment pins 392A, 392B are the same size as or slightly larger than the 2D fiber array 131, then the alignment pins 392A, 392B may exert a vertical separating force between the fiber array rafts 391A-391B, and depending on the lateral spacing between the 2D fiber array 131 and the spacer blocks 398A-398B, the alignment pins 392A, 392B may also exert a lateral separating force between the 2D fiber array 131 and the spacer blocks 398A-398B that would also exert a bending moment tending to vertically separate the fiber array rafts 391A-391B. Various parameters such as dimensions, material type, and adhesive strength may be selected to provide consistent and repeatable dimensioning between the alignment pins 392A, 392B and the 2D fiber array 131.

In certain embodiments, multiple 2D fiber subarray subunits may be utilized in a single assembly, whether in a continuous (e.g., contacting) or discontinuous (e.g., non-contacting) to define fiber-free areas for receiving one or more alignment structures. Examples of such arrangements are provided in FIGS. 65-68B.

FIG. 65 is a cross-sectional view of first and second fiber array rafts 420A, 420B adhered to, and extending beyond, a 2D composite array 421 of stripped optical fibers formed from five (8×8) 2D fiber array subunits 131-1 to 131-5, including two outer 2D array subunits 131-1, 131-5 being separated (and discontinuous) from three centrally arranged, contacting 2D array subunits 131-2 to 131-4. Discontinuities between the outer array subunits 131-1, 131-5 and the three centrally arranged 2D fiber array subunits 131-2 to 131-4 provides two fiber-free areas 428A, 428B configured to receive alignment pins 392A, 392B, which are also arranged between the first and second fiber array rafts 420A, 420B.

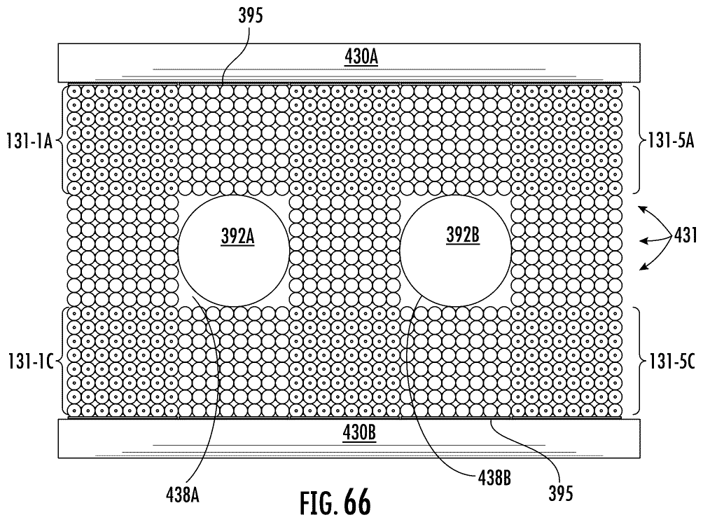

FIG. 66 is a cross-sectional view of first and second fiber array rafts 430A, 430B adhered to, and extending beyond, a 2D composite array 431 of stripped optical fibers formed from thirteen contacting (8×8) 2D array subunits (spanning from uppermost subunits 131-1A to 131-5A to lowermost subunits 131-1C to 131-5C), with fiber-free-areas 438A, 438B provided in an interior of the composite array 431. First and second alignment pins 392, 392B are received in the fiber-free areas 438A, 438B. The various array subunits (from uppermost subunits 131-1A to 131-5A to lowermost subunits 131-1C to 131-5C) may be adhered to one another, and further adhered to the fiber array rafts 430A, 430B, with adhesive 395. (Although selected 2D array subunits are illustrated as lacking fiber cores to promote visual differentiation, it is to be appreciated that all 2D array subunits are intended to include fiber cores configured for carrying optical data signals.)

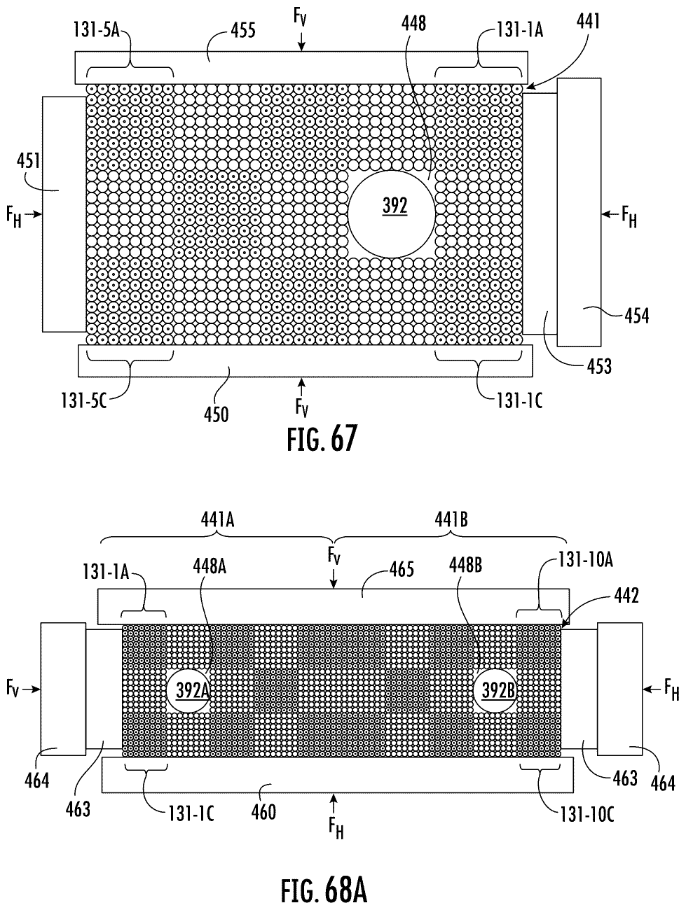

FIG. 67 is a cross-sectional view of one array portion 441 including fourteen contacting 2D (8×8) array subunits of stripped optical fibers (spanning from uppermost subunits 131-1A to 131-5A to lowermost subunits 131-1C to 131-5C) with a first alignment pin 392 arranged in a fiber-free area 448 in an interior of the first array portion 441. The first alignment pin 392 is surrounded by contacting array subunits. As illustrated, the array portion 441 is received between top and bottom plates 455, 450 as well as a left alignment block 451 and a right side pad 453 having an associated side pusher 454 (all as part of a joining fixture). Upon application of a vertical force Fv to exert compressive pressure between the upper and lower plates 455, 450, and application of a horizontal force FH to exert compressive pressure between the side pusher 454 and the left alignment block 451 to compress the right side pad 453, the 2D array subunits are squeezed in multiple direction, thereby displacing excess adhesive material between array subunits. Thereafter, an adhered array portion 441 may be removed from the joining fixture of FIG. 67 and subjected to further processing and/or use.

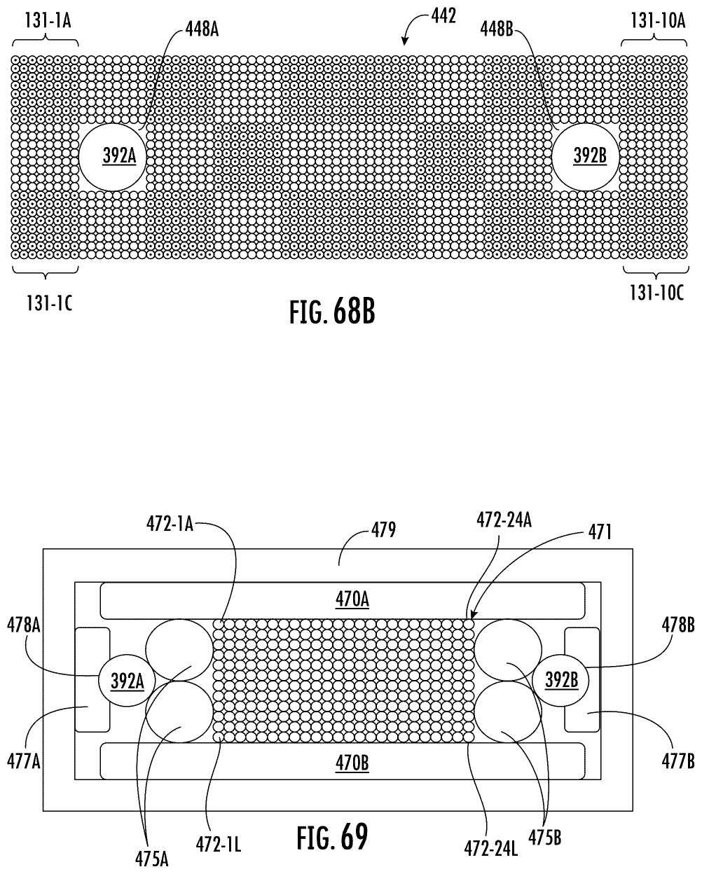

FIG. 68A is a cross-sectional view of laterally abutting first and second 2D optical fiber array portions 441A, 441B, each having an alignment pin 392A, 392B in a fiber-free area 448A, 448B thereof, and each including features according to the array portion 441 of FIG. 67. The array portions 441A, 441B are arranged between opposing upper and lower 465, 460 plates as well as a left side pad 463 having an associated left side pusher 464 and a right side pad 463 having an associated right side pusher 464 as part of a joining fixture, to permit the first and second array portions 441A, 441B to be adhered to one another with adhesive material to form an adhered 2D optical fiber array 442. Upon application of a vertical force Fv to exert compressive pressure between the upper and lower plates 465, 460, and application of a horizontal force FH to exert compressive pressure between the side pushers 464 (and associated pads 463), the 2D array subunits are squeezed in multiple direction, thereby displacing excess adhesive material between array subunits. Thereafter, an adhered array portion 441 may be removed from the joining fixture of FIG. 68A and subjected to further processing and/or use. The resulting 2D optical fiber array 442 (also shown in FIG. 68B) includes twenty-eight 2D fiber array subunits (spanning from uppermost subunits 131-1A to 131-10E to lowermost subunits 131-1C to 131-10C), with two alignment pins 392A, 392B in fiber-free areas 448A, 448B. The alignment pins 392A, 392B may extend in a lengthwise direction past optical fiber end faces of the 2D fiber array 442 to engage corresponding surfaces of another 2D fiber array (not shown).

In certain embodiments, one or more compliant members may be configured to bias or press alignment structures toward one another (e.g., against a 2D fiber array or against one or more spacer structures arranged between the alignment structures and a 2D fiber array) to ensure precise dimensions are maintained between alignment structures and optical fibers. In certain embodiments, compliant members may include a compressible polymeric and/or elastomeric material. Shape, dimensions, and material properties (e.g., degree of stiffness or resistance to compression) of the compressible polymeric and/or elastomeric material may be selected to provide a desired biasing force to be applied to one or more alignment structures. In certain embodiments, one or more compliant members may be arranged between a housing (e.g., a fiber optic connector housing) and one or more alignment structures. In certain embodiments, a portion or an entirety of a housing embody one or more compliant members, including the possibility that a unitary housing may consist of compliant material. In certain embodiments, a compliant member may comprise a compressible polymeric and/or elastomeric material with uniform properties throughout its volume, or a compliant member may comprise one or more compressible polymeric and/or elastomeric materials with properties that are non-uniform with respect to position. For example, multiple different compressible polymeric and/or elastomeric materials may be provided in different areas or portions a of single compliant member.

FIG. 69 is a cross-sectional view of an adhered 2D (12×24) fiber array 471 of stripped optical fibers (spanning from uppermost stripped fibers 472-1A to 472-24 to lowermost stripped fibers 472-1L to 472-24L) arranged between opposing upper and lower glass plates 470A, 470B (e.g., precision flatness drawn glass plates), with first and second alignment pins 392A, 392B and pairs of glass rods 475A, 475B arranged proximate to opposing first and second peripheral sides of the 2D fiber array 471, respectively. As shown, one pair of glass rods 475A, 475B (serving as spacers) is arranged between each alignment pin 392A, 392B and peripheral optical fibers (e.g., leftmost optical fibers 472-1A to 472-1L, or rightmost optical fibers 472-24A to 472-24L) of the 2D fiber array 471, with first and second compliant members 477A, 477B having arcuate recesses 478A, 478B arranged to bias the alignment pins 475A, 475B toward the glass rods 475A, 475B, wherein a housing 479 surrounds the foregoing items and is in contact with the glass plates 470A, 470B and the compliant members 477A, 477B. When compressed, the compliant members 477A, 477B exert a biasing force tending to press the alignment pins 392A, 392B toward one another, pushing the alignment pins 392A, 392B into contact with the glass rods 475A, 475B, and in turn pushing the glass rods 475A, 475B into contact with peripheral sides of the 2D fiber array 471. The alignment pins 392A, 392B may extend in a lengthwise direction past optical fiber end faces of the 2D fiber array 471 to engage corresponding surfaces of another 2D fiber array (not shown).

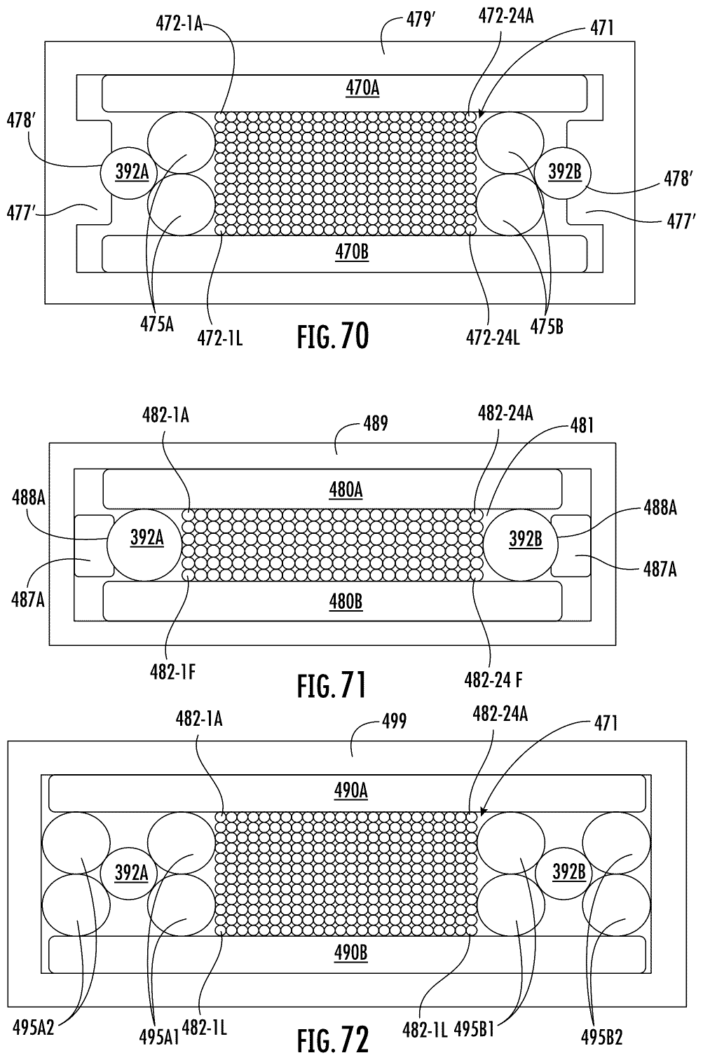

FIG. 70 is a cross-sectional view of an adhered 2D (12×24) fiber array 471 of stripped optical fibers (spanning from uppermost stripped fibers 472-1A to 472-24 to lowermost stripped fibers 472-1L to 472-24L) arranged between opposing upper and lower glass plates 470A, 470B (e.g., precision flatness drawn glass plates), with first and second alignment pins 392A, 392B and pairs of glass rods 475A, 475B arranged proximate to opposing first and second peripheral sides of the 2D fiber array 471, respectively. One pair of glass rods 475A, 475B (serving as spacers) is arranged between each alignment pin and 392A, 392B and peripheral optical fibers (e.g., leftmost optical fibers 472-1A to 472-1L, or rightmost optical fibers 472-24A to 472-24L) of the 2D fiber array 471. In this embodiment, an entirety of a housing 479′ is fabricated of a compliant material, with the housing 479′ including protrusions 477′ defining arcuate recesses 478′ arranged to bias the pairs of alignment pins 475A, 475B toward the glass rods 475A, 475B. In this regard, the protrusions 477′ are part of a unitary compliant member, while serving the same function as the compliant members 477A, 477B of FIG. 69. The housing 479′ is in contact with the glass plates 470A, 470B and further surrounds the alignment pins 392A, 392B, the pairs of glass rods 475A, 475B, and the 2D fiber array 471. When the protrusions 477′ are compressed, they exert a biasing force tending to press the alignment pins 392A, 392B toward one another, pushing the alignment pins 392A, 392B into contact with the glass rods 475A, 475B, and in turn pushing the glass rods 475A, 475B into contact with peripheral sides of the 2D fiber array 471. The alignment pins 392A, 392B may extend in a lengthwise direction past optical fiber end faces of the 2D fiber array 471 to engage corresponding surfaces of another 2D fiber array (not shown).

In certain embodiments, one or more compliant members may be in direct contact with one or more alignment structures. For example, FIG. 71 is a cross-sectional view of an adhered 2D (6×24) fiber array 481 of stripped optical fibers (spanning from uppermost stripped fibers 482-1A to 482-24 to lowermost stripped fibers 482-1F to 482-24F) arranged between opposing upper and lower glass plates 480A, 480B (e.g., precision flatness drawn glass plates), with first and second alignment pins 392A, 392B contacting opposing first and second peripheral sides (e.g., leftmost optical fibers 482-1A to 482-1F, or rightmost optical fibers 482-24A to 482-24F) of the 2D fiber array 481. First and second compliant members 487A, 487B having arcuate recesses 488A, 488B are arranged to bias the alignment pins 485A, 485B toward the 2D fiber array 481, wherein a housing 489 surrounds the foregoing items and is in contact with the glass plates 480A, 480B as well as the compliant members 487A, 487B. When compressed, the compliant members 487A, 487B exert a biasing force tending to press the alignment pins 392A, 392B toward one another, pushing them into contact with peripheral sides of the 2D fiber array 481. The alignment pins 392A, 392B may extend in a lengthwise direction past optical fiber end faces of the 2D fiber array 481 to engage corresponding surfaces of another 2D fiber array (not shown).

In certain embodiments, a housing (whether formed of compliant or non-compliant material) may directly contact one or more alignment structures or spacer structures, without requiring discrete compliant members or compliant protruding housing portions.

FIG. 72 is a cross-sectional view of an adhered 2D (12×24) fiber array 491 of stripped optical fibers (spanning from uppermost stripped fibers 472-1A to 472-24 to lowermost stripped fibers 472-1F to 472-24F) arranged between opposing upper and lower glass plates 490A, 490B, with first and second alignment pins 392A, 392B arranged between two pairs (e.g., a quartet) of glass rods 495A1, 495A2, 495B1, 495B2 at first and second sides of the 2D fiber array 471, respectively. A housing 499 surrounds the foregoing items and is in contact with the glass plates 490A, 490B as well as outermost pairs of glass rods 495A2, 495B2. The alignment pins 392A, 392B may extend in a lengthwise direction past optical fiber end faces of the 2D fiber array 471 to engage corresponding surfaces of another 2D fiber array (not shown).

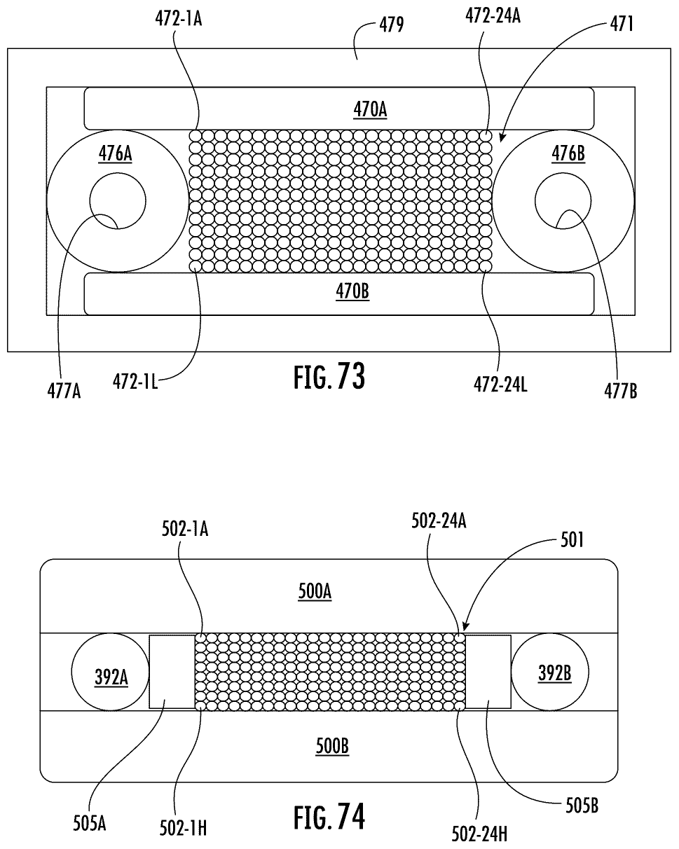

FIG. 73 is a cross-sectional view of an adhered 2D (12×24) fiber array 501 of stripped optical fibers (spanning from uppermost stripped fibers 472-1A to 472-24A to lowermost stripped fibers 472-1F to 472-24F) arranged between opposing upper and lower glass plates 470A, 470B, with first and second glass tubes 476A, 476B (having bores 477A, 477B) serving as alignment structures arranged the glass plates 470A, 470B and also contacting peripheral sides of the 2D fiber array 471. A housing 479 surrounds the foregoing items and is in contact with the glass plates 470A, 470B as well as the glass tubes 476A, 476B. The glass tubes 476A, 476B extend in a lengthwise direction past optical fiber end faces of the 2D fiber array 471 to engage corresponding surfaces of another 2D fiber array (not shown), or the glass tubes 476A, 476B may be configured to receive alignment pins, whether associated with the fiber array 501 or associated with another 2D fiber array (not shown).

FIG. 74 is a cross-sectional view of an adhered 2D (8×24) fiber array 501 of stripped optical fibers (spanning from uppermost stripped fibers 502-1A to 502-24A to lowermost stripped fibers 502-1H to 502-24H) arranged between opposing upper and lower glass plates 500A, 500B, with first and second glass spacers 505A, 505B abutting peripheral sides of the 2D fiber array 501, respectively. First and second alignment pins 392A, 392B are further provided between the glass plates 500A, 500B and in contact with the glass spacers 505A, 505B, such that the glass spacers 505A, 505B separate the alignment pins 392A, 392B from the 2D fiber array 501. When the 2D fiber array 501 and alignment pins 392A, 392B are integrated into a fiber optic connector or the like, a biasing force may be applied (e.g., via a sleeve, housing, compliant member, or other member, not shown) to press the alignment pins 392A-392B into contact with the glass spacers 505A, 505B and thereby press the glass spacers 505A, 505B into contact with peripheral sides of the 2D fiber array 501.

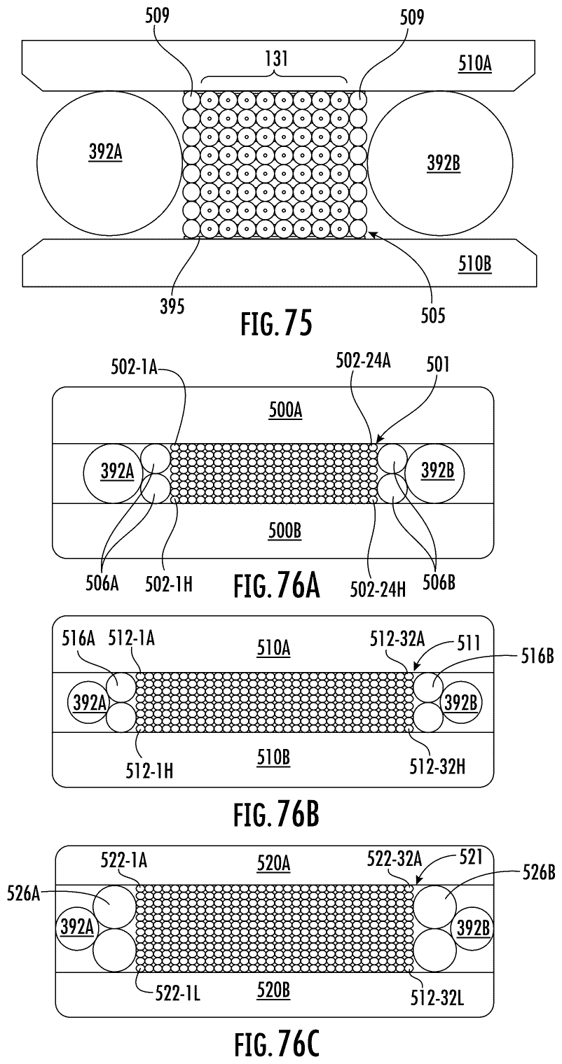

FIG. 75 is a cross-sectional view of an adhered 2D (8×8) fiber array 131 of stripped optical fibers having columns of peripheral fibers 509 each having an enhanced hardness outer surface, all arranged between opposing upper and lower glass plates 510A, 501B, with first and second alignment pins 392A, 392B contacting the columns of peripheral fibers 509. In certain embodiments, the alignment pins 392A, 392B may extend in a lengthwise direction past optical fiber end faces of the 2D fiber array 131 to engage corresponding surfaces of another 2D fiber array (not shown). When foregoing items are integrated into a fiber optic connector or the like, a biasing force may be applied (e.g., via a sleeve, housing, compliant member, or other member, not shown) to press the alignment pins 392A-392B into contact with the peripheral fibers 509.

FIGS. 76A-76C show that very high density adhered 2D fiber arrays (e.g., 8×24, 8×32, or 12×32 fiber arrays) may be integrated into a frontal area no greater than a conventional MPO connector. The configurations shown in FIGS. 76A-76C provide fiber density increases of 8 times, 10.7 times, and 16 times, respectively, relative to conventional MPO connectors including 1×12 fiber arrays.

FIG. 76A is a cross-sectional view of an adhered 2D (8×24) fiber array 501 of stripped optical fibers (spanning from uppermost stripped fibers 502-1A to 502-24A to lowermost stripped fibers 502-1H to 502-24H) arranged between opposing upper and lower glass plates 500A, 500B, with first and second pairs of glass rods 506A, 506B (serving as spacers) abutting peripheral sides of the 2D fiber array 501, respectively. First and second alignment pins 392A, 392B are further provided between the glass plates 500A, 500B and in contact with the pairs of glass rods 506A, 506B, such that the pairs of glass rods 506A, 506B separate the alignment pins 392A, 392B from the 2D fiber array 501. When foregoing items are integrated into a fiber optic connector or the like, a biasing force may be applied (e.g., via a sleeve, housing, compliant member, or other member, not shown) to press the alignment pins 392A-392B into contact with the pairs of glass rods 506A, 506B, which in turn are pressed into contact with peripheral sides of the 2D fiber array 501. In certain embodiments, the alignment pins 392A, 392B may extend in a lengthwise direction past optical fiber end faces of the 2D fiber array 501 to engage corresponding surfaces of another 2D fiber array (not shown). In certain embodiments, each glass plate 500A, 500B has a thickness of 725 μm, each alignment pin 392A, 392B has a diameter of 1 mm, and each glass rod 506A, 506B has a diameter of 0.5 mm.

FIG. 76B is a cross-sectional view of an adhered 2D (8×32) fiber array 511 of stripped optical fibers (spanning from uppermost stripped fibers 512-1A to 512-32A to lowermost stripped fibers 512-1H to 512-32H) arranged between opposing upper and lower glass plates 510A, 510B, with first and second pairs of glass rods 516A, 516B (serving as spacers) abutting peripheral sides of the 2D fiber array 511, respectively. First and second alignment pins 392A, 392B are further provided between the glass plates 510A, 510B and in contact with the pairs of glass rods 516A, 516B, such that the pairs of glass rods 516A, 516B separate the alignment pins 392A, 392B from the 2D fiber array 511. When foregoing items are integrated into a fiber optic connector or the like, a biasing force may be applied (e.g., via a sleeve, housing, compliant member, or other member, not shown) to press the alignment pins 392A-392B into contact with the pairs of glass rods 516A, 516B, which in turn are pressed into contact with peripheral sides of the 2D fiber array 511. In certain embodiments, the alignment pins 392A, 392B may extend in a lengthwise direction past optical fiber end faces of the 2D fiber array 511 to engage corresponding surfaces of another 2D fiber array (not shown). In certain embodiments, each glass plate 510A, 510B has a thickness of 725 μm, each alignment pin 392A, 392B has a diameter of 0.7 mm, and each glass rod 516A, 516B has a diameter of 0.5 mm.

FIG. 76C is a cross-sectional view of an adhered 2D (12×32) fiber array 521 of stripped optical fibers (spanning from uppermost stripped fibers 522-1A to 522-32A to lowermost stripped fibers 522-1L to 522-32L) arranged between opposing upper and lower glass plates 520A, 520B, with first and second pairs of glass rods 526A, 526B (serving as spacers) abutting peripheral sides of the 2D fiber array 521, respectively. First and second alignment pins 392A, 392B are further provided between the glass plates 520A, 520B and in contact with the pairs of glass rods 526A, 526B, such that the pairs of glass rods 526A, 526B separate the alignment pins 392A, 392B from the 2D fiber array 521. When foregoing items are integrated into a fiber optic connector or the like, a biasing force may be applied (e.g., via a sleeve, housing, compliant member, or other member, not shown) to press the alignment pins 392A-392B into contact with the pairs of glass rods 526A, 526B, which in turn are pressed into contact with peripheral sides of the 2D fiber array 521. In certain embodiments, the alignment pins 392A, 392B may extend in a lengthwise direction past optical fiber end faces of the 2D fiber array 521 to engage corresponding surfaces of another 2D fiber array (not shown). In certain embodiments, each glass plate 520A, 520B has a thickness of 475 μm, each alignment pin 392A, 392B has a diameter of 0.7 mm, and each glass rod 526A, 526B has a diameter of 0.75 mm.

FIG. 77 is a perspective view of a fiber optic cable assembly 541 including three discontinuous, individually adhered 2D (8×8) fiber arrays 131A-131C of stripped optical fibers arranged between opposing upper and lower glass plates 530A, 530B with fiber-free regions 538A, 538B between adjacent 2D fiber arrays 131A-131C. One or more alignment structures (not shown) may be provided in the fiber-free regions 538A, 538B. The glass plates 530A, 530B extend forwardly to a position substantially flush with optical fiber end faces of the 2D fiber arrays 131A-131C. In combination, the three discontinuous 2D fiber arrays 131A-131C may be considered a composite array 531. Each 2D fiber array 131A-131C includes stripped optical fiber segments (or regions) 542A-542C that extend continuously to unstripped segments (or regions) contained in multiple optical fiber ribbons 543A-543C. Protruding tabs 532A, 532B extend upward and laterally outward from rear portions of the glass plates 530A, 530B, with the unstripped segments contained in the multiple optical fiber ribbons 543A-543C extending rearwardly behind the stripped optical fiber segments 542A-542C that are provided between the glass plates 530A, 530B and protruding tabs 532A, 532B. In combination, the glass plates 530A, 530B, protruding tabs 532A, 532B, and 2D fiber arrays 131A-131C of stripped optical fiber segments 542A-542C may embody a fiber optic connector 541 suitable for fiber-to-fiber mating.

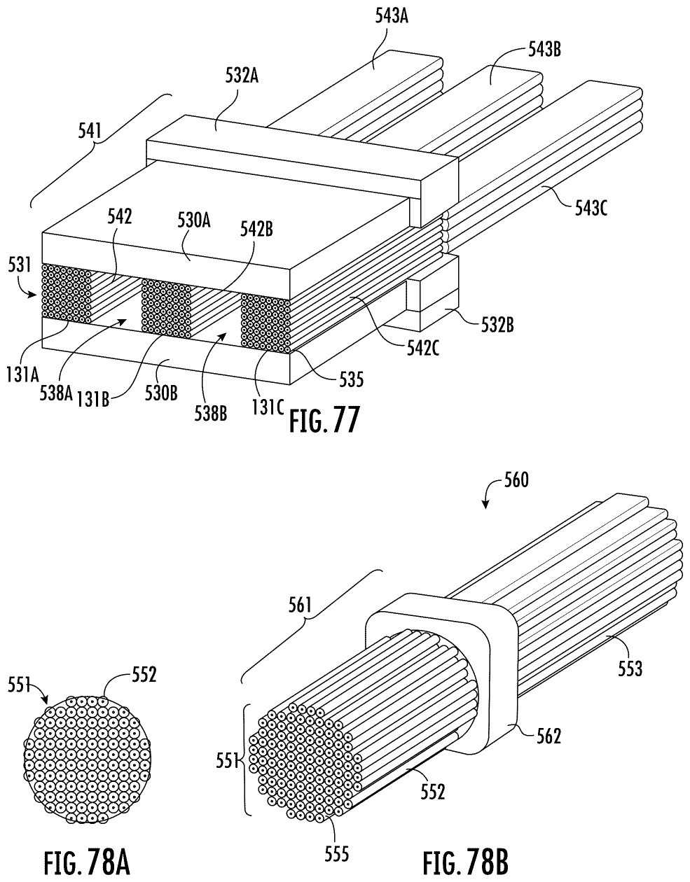

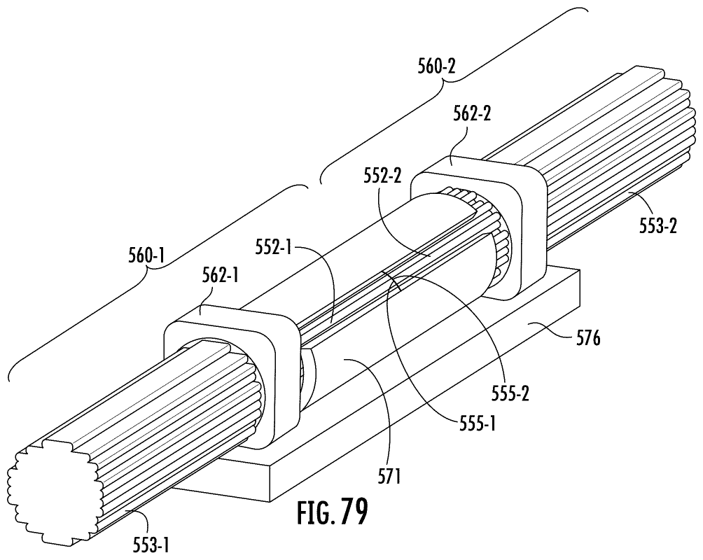

In certain embodiments, a 2D array of stripped optical fibers may be arranged in a cross-sectional shape that is rounded or curved. For example, FIG. 78 is a front elevational view of an adhered 2D fiber array 551 of stripped optical fibers 552 having a generally circular arrangement. FIG. 78B is a perspective view of a fiber optic cable assembly 560 including the adhered 2D fiber array 551 of stripped optical fibers 552 of FIG. 78A extending forward from a square-shaped shoulder member 562 and terminated at optical fiber end faces 555, with the stripped optical fibers 552 extending continuously to unstripped fiber segments or regions contained in multiple optical fiber ribbons 553 extending rearwardly from the 2D fiber array of stripped optical fibers 552 and behind of the shoulder member 562. In combination, the adhered 2D fiber array 551 of stripped optical fibers 552 and the shoulder member 562 may embody a fiber optic connector 561 suitable for fiber-to-fiber mating. FIG. 79 shows two fiber optic cable assemblies 560-1, 560-2 in a mating relationship with abutting end faces 555-1, 555-2, with adhered 2D fiber arrays 552-1, 552-2 received within a removable sleeve 571 having a generally tubular shape. Shoulder members 562-1, 562-2 are arranged on (and optionally mechanically engaged to) a flat support member 576, with optical fiber ribbons 553-1, 553-2 of the respective fiber optic cable assemblies 560-1, 560-2 extending in opposing directions away from the removable sleeve 571 and the flat support member 576.

It will be apparent to those skilled in the art that various modifications and variations can be made without departing from the spirit or scope of the invention.

It will also be apparent to those skilled in the art that unless otherwise expressly stated, it is in no way intended that any method in this disclosure be construed as requiring that its steps be performed in a specific order. Accordingly, where a method claim below does not actually recite an order to be followed by its steps or it is not otherwise specifically stated in the claims or descriptions that the steps are to be limited to a specific order, it is no way intended that any particular order be inferred.

What is claimed is:

1. A fiber optic cable assembly comprising:
a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array in which the end portion of each optical fiber is in lateral contact with end portions of multiple other optical fibers of the plurality of optical fibers;
a first alignment structure in lateral contact with end portions of a first subgroup of optical fibers of the plurality of optical fibers; and
a second alignment structure in lateral contact with end portions of a second subgroup of optical fibers of the plurality of optical fibers;
wherein the first alignment structure and the second alignment structure are configured to permit alignment of end faces of the plurality of optical fibers with end faces of a second plurality of optical fibers of another fiber optic cable assembly.

2. The fiber optic cable assembly of claim 1, wherein the first alignment structure comprises a first alignment pin, and the second alignment structure comprises a second alignment pin.

3. The fiber optic cable assembly of claim 2, wherein the first alignment structure comprises a first glass sheet, a first glass tube, or a first plurality of glass rods arranged between the first alignment pin and the end portions of the first subgroup of optical fibers, and the second alignment structure comprises a second glass sheet, a second glass tube, or a second plurality of glass rods arranged between the second alignment pin and the end portions of the second subgroup of optical fibers.

4. The fiber optic cable assembly of claim 2, wherein the first alignment structure comprises a first glass tube arranged between the first alignment pin and the end portions of the first subgroup of optical fibers, and the second alignment structure comprises a second glass tube arranged between the second alignment pin and the end portions of the second subgroup of optical fibers.

5. The fiber optic cable assembly of claim 2, wherein the first alignment structure comprises a first glass sheet arranged between the first alignment pin and the end portions of the first subgroup of optical fibers, and the second alignment structure comprises a second glass sheet arranged between the second alignment pin and the end portions of the second subgroup of optical fibers.

6. The fiber optic cable assembly of claim 1, wherein the first alignment structure comprises a first glass tube, and the second alignment structure comprises a second glass tube.

7. The fiber optic cable assembly of claim 1, wherein the first alignment structure comprises a first glass sheet or a first fiber array raft, and the second alignment structure comprises a second glass sheet or a second fiber array raft.

8. The fiber optic cable assembly of claim 1, wherein the first alignment structure comprises a first V-block, and the second alignment structure comprises a second V-block.

9. The fiber optic cable assembly of claim 1, wherein, for at least some optical fibers of the plurality of optical fibers, the end portions thereof comprise glass cladding material and with an increased hardness external surface relative to a remaining interior portion of the glass cladding material.

10. The fiber optic cable assembly of claim 9, wherein the increased hardness external surface comprises a deposited material layer arranged in contact with the glass cladding material.

11. The fiber optic cable assembly of claim 1, wherein:
the two-dimensional array comprises a first peripheral involution bounded by optical fibers of the first subgroup of optical fibers, with the first peripheral involution being configured to receive at least a portion of the first alignment structure; and
the two-dimensional array comprises a second peripheral involution bounded by optical fibers of the second subgroup of optical fibers, with the second peripheral involution being configured to receive at least a portion of the second alignment structure.

12. The fiber optic cable assembly of claim 1, wherein the first alignment structure is adhered to the first subgroup of optical fibers, and the second alignment structure is adhered to the second subgroup of optical fibers.

13. The fiber optic cable assembly of claim 1, further comprising a removable sleeve configured to contact the first alignment structure and the second alignment structure, and to fit around at least a portion of the plurality of optical fibers.

14. The fiber optic cable assembly of claim 1, being devoid of a ferrule contacting the plurality of optical fibers.

15. The fiber optic cable assembly of claim 1, wherein each optical fiber of the plurality of optical fiber comprises a single-mode optical fiber.

16. The fiber optic cable assembly of claim 1, wherein each optical fiber of the plurality of optical fibers comprises a glass core and is configured to carry optical signals in a wavelength range of 850 nm to 1550 nm.

17. A fiber optic cable assembly comprising:
a plurality of optical fibers comprising glass and being configured to carry optical signals, wherein each optical fiber of the plurality of optical fibers comprises a stripped region and an unstripped region, each stripped region is terminated at an end face, each stripped region includes an end portion proximate to the first end face, and at least the end portion of each optical fiber of the plurality of optical fibers is arranged in a two-dimensional array, wherein the two-dimensional array is devoid of optical fibers in an interior of the two-dimensional array to provide first and second fiber-free areas in the interior of the two-dimensional array;
a first alignment structure at least partially received within the first fiber-free area; and
a second alignment structure at least partially received within the second fiber-free area;
wherein the first alignment structure and the second alignment structure are configured to permit alignment of end faces of the plurality of optical fibers with end faces of a plurality of optical fibers of another fiber optic cable assembly.

18. The fiber optic cable assembly of claim 17, wherein the first alignment structure comprises a first alignment pin, and the second alignment structure comprises a second alignment pin.

19. The fiber optic cable assembly of claim 17, wherein the first alignment structure comprises a first glass rod or glass tube, and the second alignment structure comprises a second glass rod or glass tube.

20. The fiber optic cable assembly of claim 17, wherein the two-dimensional array is continuous, and each of the first fiber-free area and the second fiber-free area is surrounded by optical fibers of the plurality of optical fibers.

21. The fiber optic cable assembly of claim 17, wherein the two-dimensional array is discontinuous, including first, second, and third two-dimensional array portions, wherein the first fiber-free area is arranged between the first and second two-dimensional array portions, and the second fiber-free area is arranged between the second and third two-dimensional array portions.

22. The fiber optic cable assembly of claim 17, further comprising at least one pair of opposing glass sheets, wherein the two-dimensional array is arranged between at least one pair of opposing glass sheets.

23. The fiber optic cable assembly of claim 17, further comprising a sleeve surrounding the two-dimensional array of optical fibers.

24. The fiber optic cable assembly of claim 23, wherein the sleeve is substantially rigid and is removable from a remainder of the fiber optic cable assembly.

25. The fiber optic cable assembly of claim 23, wherein the sleeve comprises metal.

26. The fiber optic cable assembly of claim 17, being devoid of a ferrule contacting the plurality of optical fibers.

27. The fiber optic cable assembly of claim 17, wherein each optical fiber of the plurality of optical fibers comprises a single-mode optical fiber.

28. The fiber optic cable assembly of claim 17, wherein for at least some optical fibers of the plurality of optical fibers, the end portions thereof comprise glass cladding material and an enhanced hardness outer surface having a hardness greater than a remaining internal portion of the glass cladding material.

29. The fiber optic cable assembly of claim 17, wherein each optical fiber of the plurality of optical fibers comprises a glass core and is configured to carry optical signals in a wavelength range of 850 nm to 1550 nm.
